(19) United States
(12) Patent Application Publication
(10) Pub. No.: US 2015/0278697 A1
(43) Pub. Date: Oct. 1, 2015

(54) METHOD OF FINDING A PROBLEM IN PROPERTIES OF A SET OF RULES USED FOR AUTOMATED MONITORING OF A TECHNICAL SYSTEM AND DEVICE FOR PERFORMING THE METHOD

(71) Applicant: SIEMENS AKTIENGESELLSCHAFT, München (DE)

(72) Inventors: Hans-Gerd Brummel, Berlin (DE); Omar Enrique Perez Ratmiroff, Duesseldorf (DE); Mikhail Roshchin, Feldkirchen (DE); Ronald De Haan, Wien (AT)

(21) Appl. No.: 14/438,533

(22) PCT Filed: Oct. 21, 2013
(86) PCT No.: PCT/EP2013/071938

§ 371 Date: Apr. 24, 2015

(30) Foreign Application Priority Data
Oct. 25, 2012 (EP) 12189865.4

(51) Int. Cl. G06N 5/04

(52) U.S. Cl. CPC G06N 5/046

(57) ABSTRACT

Disclosed is a method of reviewing a set of rules used for automated monitoring of a technical system for the presence of a problem. The method includes the steps of: selecting a problem in view of which the set of rules is to be reviewed; translating the rules to be reviewed to a knowledge base of formal logical statements; translating the problem to a formal logical problem statement; applying a computer algorithm for checking whether the knowledge base of logical statements together with the logical problem statement is satisfiable; labeling the problems as not being present if the knowledge base of logical statements together with the logical problem statement is satisfiable.

The present invention relates to a method of reviewing a set of rules used for automated monitoring of a technical system for the presence of a problem, to a use of said method and to a device for reviewing a set of rules used for automated monitoring of a technical system for the presence of a problem.

Systems based on large sets of temporal rules (as Rulebase of E S SF) are used to monitor technical systems, like e.g. gas turbines, based on sensor data. These rule bases are so large, and the interaction between such many rules is so complex, that it is difficult to debug or maintain these systems. As a result, automated reasoning support is needed in the process of maintaining and debugging the system. Concretely, the following three problems can be identified:

(1) Often combinations of rules are created that (accidentally) can never lead to any sensible output. Automatic detection of such inconsistent rules is required, to repair such faults in the system.

(2) Often a rule is created to solve a particular problem, while there already exists another rule that serves this purpose. Detecting such equivalent rules automatically is needed, to help keep the system clear from duplicates, and therefore more efficiently maintainable.

(3) In many cases, rules are created for a specific purpose while another (more general) already existing rule can be used for this purpose. Automatically detecting such subsumption relations between rules also helps keep the system clear from redundant rules.

Up to now, these problems have been solved by means of human (expert) experience. Engineers that have worked with the rule bases for years use their experience with the particular rules to find inconsistent, subsuming and equivalent rules, which is very time consuming. No automated support has been developed to solve these problems.

It is an objective of the present invention to provide a method of reviewing a set of rules used for automated monitoring of a technical system for the presence of a problem, which can be automated. It is a further of the present invention to provide a device that allows for automatically reviewing a set of rules used for automated monitoring of a technical system for the presence of a problem.

The first objective is achieved by a method of reviewing a set of rules used for automated monitoring of a technical system for the presence of a problem, as claimed in claim 1, and the further objective is achieved by a device for reviewing a set of rules used for automated monitoring of a technical system for the presence of a problem, as claimed in claim 10. The depending claims contain further developments of the invention.

The inventive method of reviewing a set of rules used for automated monitoring of a technical system, in particular where the monitoring is based on sensor data, for the presence of a problem comprises the steps of:
selecting a certain problem in view of which the set of rules is to be reviewed;
translating the rules to be reviewed to a knowledge base of formal logical statements;
translating the problem to a formal logical problem statement;
applying a computer algorithm for checking whether the knowledge base of logical statements together with the logical problem statement is satisfiable;
labeling the problem as not being present if the knowledge base of logical statements together with the logical problem statement is satisfiable.

The inventive method may, in particular, be used for debugging the set of rules.

Rules used for automated monitoring of a technical systems can be considered as imperative programs, i.e. as programs formed by a series of commands which determine which tasks are executed by a computer and in which order the computer executes the tasks. The rules of such programs can, e.g., be represented as plain text files in which each line of text represents a rule. In the inventive method, such text files can then be automatically translated to a knowledge base of formal logical statements by use of software executing formal translation rules. Likewise, the problem in view of which the set of rules is to be reviewed can be automatically translated to a formal logical statement, also called logical problem statement in this specification. After translating the set of rules to be reviewed and the problem in view of which the set of rules is to be reviewed to the knowledge base of formal logical statements and the logical problem statement, respectively, an computer algorithm for solving satisfiability problems can be applied to set formed by the knowledge base of formal logical statements and the logical problem statement. If the result of executing the algorithm is that the knowledge base of formal logical statements together with the logical problem statement is satisfiable then the problem is not present in the properties of the original set of rules.

In the inventive method, the translation of the set of rules to be reviewed and the problem in view of which the set of rules is to be reviewed to the knowledge base of formal logical statements and the logical problem statement, respectively, allows for applying already existing computer implemented algorithms for solving satisfiability problems. Since also the translation can be performed by a computer, on which a computer program runs which contains commands implementing the translation rules, the inventive method can be fully automated and, hence, allows for automatically reviewing properties of a set of rules used for automated monitoring of a technical system for the presence of a problem.

Problems that may be selected to be reviewed for their presence in a set of rules used for automated monitoring of a technical system by the inventive method are, for example, the existence of an inconsistency between two or more rules in the set of rules, the existence of at least two equivalent rules in the set of rules, and the existence of at least one specific rule which solves a purpose that is already solved by a more general rule.

As formal logic, a description logic, e.g. ALC(D), may be used. However, in case of loop-free fragments of imperative programming languages it is not necessary to use the expressivity of a description logic. In this case, it is sufficient to provide the formal logical statements of the knowledge base and the logical problem statement in a Satisfiability Modulo Theory-format, for example in form of an extension Boolean logic with concrete (numerical) domains.

An inventive device for reviewing a set of rules used for automated monitoring of a technical system, in particular where the monitoring is based on sensor data, for the presence of a problem comprises:
an input for inputting the set of rules to be reviewed and a certain problem in view of which the set of rules is to be reviewed, and for generating input signals representing the set of rules to be reviewed and the certain problem;
an encoder connected to the input for receiving the input signals and for generating, from the input signals, encoded signals which represent a translation of the rules to be reviewed to a knowledge base of formal logical statements and a translation of the problem to a formal logical problem statement;
a computing device connected to the encoder for receiving the encoded signals and designed for running an algorithm for checking whether the knowledge base of logical statements together with the logical problem statement is satisfiable and for generating an output variable the value of which states whether or not the knowledge base of logical statements together with the logical problem statement is satisfiable;
a signal generator connected to the computing device for receiving the output variable and designed for generating, based on the value of the output variable, an output signal describing the problem as not being present if the value of the output variable indicates that the knowledge base of logical statements together with the logical problem statement is satisfiable; and
an output connected to the signal generator for outputting the output signal.

The inventive devise is adapted to execute the inventive method and, hence, allows for achieving the same objectives as the inventive method.

The main technical feature of the invention to solve the problems, is the translation from rules in their original format to a formal logic language. This translation allows existing implemented and optimized algorithms to solve the problems automatically.

### Concretely:

The invention takes as input the rules in their original format.
It translates these rules to a knowledge base of logic statements, e.g. in Satisfiability Modulo Theories (SMT) format. SMT is a logical formalism that can express both (abstract) logical relations and concrete numerical constraints. There are many algorithms available to check whether an SMT knowledge base is satisfiable.
Together with the choice of the task (finding inconsistence, equivalence or subsumption of rules), the entire task is then as SMT satisfiability problems. Each of the three problems (1), (2) and (3) is encoded by additional logic statements, that together with the translation of the rules constitutes an SMT satisfiability problem.
The translation is such, that the solution of the SMT satisfiability problem directly gives a solution to the problem being encoded. For instance, in the case of equivalence, the SMT knowledge base is satisfiable if and only if the two rules being checked are not equivalent.
Then, by using existing implementations of algorithms to solve the SMT satisfiability problems, the invention automatically solves the problems (1), (2) and (3) identified in Question 1. In other words, the automated reasoning support is provided by means of the SMT satisfiability algorithms.

The inventive step lies, i.a., in the exact nature of the translation from the original rules into the SMT logic statements. This translation is performed in such a way that the solution to the problems (1), (2) and (3) can be found by finding the solution to the corresponding resulting SMT satisfiability problem.

Further features, properties and advantages of the present invention will become clear from the following description of embodiments in conjunction with the accompanying drawings.

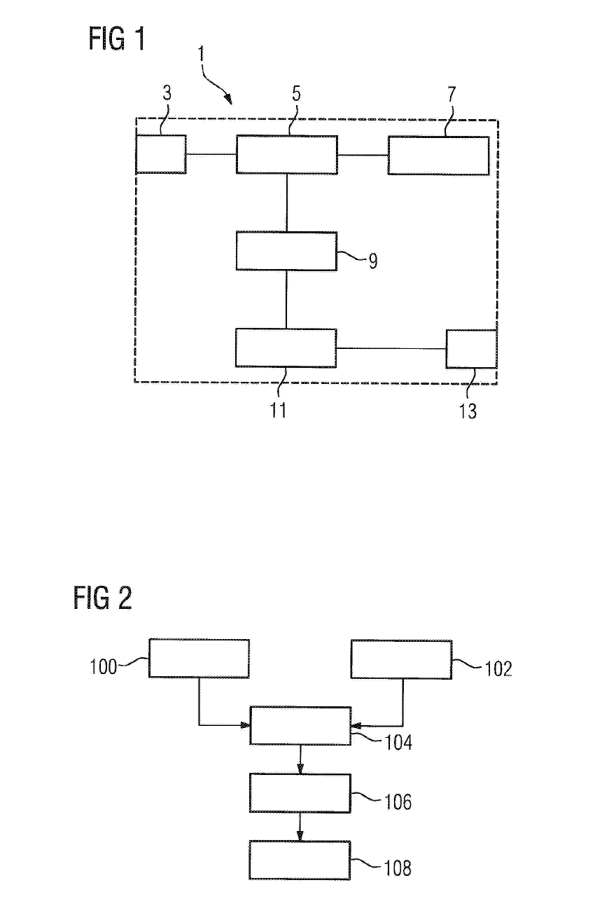

FIG. 1 schematically shows a device for reviewing a set of rules used for automated monitoring of a technical system for the presence of a problem.

FIG. 2 shows a diagram representing the inventive method of reviewing a set of rules used for automated monitoring of a technical system for the presence of a problem.

A device for reviewing a set of rules used for automated monitoring of a technical system for the presence of a problem will now be described with respect to FIG. 1, where the Figure schematically shows the device in form of a block diagram. The device 1 comprises an input 3 for inputting a set of rules to be reviewed and a definition of a certain problem in view of which the set of rules is to be reviewed. In addition, the input 3 generates input signals representing the set of rules to be reviewed and the certain problem.

An encoder 5 is connected to the input 5 for receiving the input signals. In addition, a storage device 7 is connected to the encoder 5. The storage device 7 stores a set of translation rules which define how the signals representing the set of rules to be reviewed and the certain problem are to be transformed into encoded signals which represent a translation of the rules to be reviewed to a knowledge base of formal logical statements and a translation of the problem to a formal logical problem statement. Based on the translation rules received from the storage 7, the encoder 5 generates, from the input signals, encoded signals which represent a translation of the rules to be reviewed to a knowledge base of formal logical statements. In addition, it generates a translation of the problem in view of which the set of rules is to be reviewed to a formal logical problem statement.

The encoded signals are delivered to a computing device 9 that is connected to the encoder 5. The computing device 9 runs an algorithm on the encoded signals for checking whether the knowledge base of logical statements together with the logical problem statement which are encoded in the encoded signals is satisfiable. Based on the result of the algorithm, the computing device 9 generates an output variable the value of which states whether or not the knowledge base of logical statements together with the logical problem statement represented by the encoded signals is satisfiable.

The output variable is delivered to a signal generator 11 connected to the computing device 9. The signal generator 11 generates, based on the value of the output variable, an output signal labeling the problem as not being present if the value of the output variable indicates that the knowledge base of logical statements together with the logical problem statement are satisfiable. An output 13 connected to signal generator 11 outputs the output signal from the device 1.

The inventive method, which can be executed by means of the inventive device 1, will now be described with reference to FIG. 2. In a first step 100 of the method, a set of rules used for automated monitoring of a technical system is input to the device 1 through the input 3. In step 102, a definition of a certain problem in view of which the set of rules is to be reviewed is input through the input 3 of the device 1. Inputting the set of rules and the definition of the problem can be done in parallel, as it is indicated by FIG. 2. However, it is also possible to input the definition of the problem after the set of rules has been input, or vice versa. In the present embodiment, the input format of the set of rules is a plain text file in which each line of text represents a rule of the set. Likewise, the definition of the problem is input as a plain text file. From these text files, the input 3 generates signals which represent set of rules and the definition of the problem.

Both, the set of rules as well as the definition of the problem in view of which the set of rules is to be reviewed are translated to a knowledge base of formal logical statements and a formal logical problem statement, respectively, in step 104. More specifically, in step 104, the signals which represent set of rules and the definition of the problem are encoded by the encoder 5 to form encoded signals which represent the translation of the rules to be reviewed to the knowledge base of formal logical statements and the translation of the problem to the formal logical problem statement.

In step 106, an algorithm for checking whether the knowledge base of logical statements together with the logical problem statement is satisfiable is applied to the knowledge base and the problem statement. In practice, this is done by running a computer implemented version of the algorithm on the encoded signals by means of the computing device 9. The computer implemented algorithm generates an output variable the value of which indicates whether or not the outcome of the algorithm is that the knowledge base of logical statements together with the logical problem statement are satisfiable. This output variable is converted to an output signal that can be output, e.g. to a monitor, a printer, a speech generator, etc. and which contains a label whether or not the problem is present in the reviewed set of rules. In other words, the output signal indicates that the problem is not present in the reviewed set of rules if the knowledge base of logical statements together with the logical problem statement are satisfiable. Otherwise, it indicates the presence of the problem in view of which the set of rules was reviewed. The output signal is generated and output in step 108.

In the following, details of the translation of the set of rules to be reviewed and the problem in view of which the set of rules is to be reviewed are described. In particular, the input and the encoding of the rules to be reviewed are described in detail by means of examples.

### Input Format

The rules are given as input to the software in plain text files, in which each line of text represents a rule. A rule consists of seven tab-separated strings s1, . . . , s7, where:
s1 is a rule name (an arbitrary string);
s7 is a variable name (a string starting with ‘v’, or with ‘t’ or with ‘c’); and
s2, . . . , share terms of the following form:
   T, BAD;
   a floating-point number, such as 0.95 or 100;
   (+t1 t2), (−t1 t2), (*t1 t2), or (/t1 t2), where t1 and t2 are terms too;
   (<t1 t2), (>t1 t2), where t1 and t2 are terms too;
   (&& t1 t2), (//t1 t2), where t1 and t2 are terms too;
   (! t1), where t1 is a term too;
   a variable name, which is a string starting with v,
   (tvar var num), (tmin var num), (tmax var num), (tsum var num); where var is a variable name, and num either is a variable name or a positive integer;
   (dead_band_break var), where var is a variable name;
   FREEZE,
   (bad_status t1), where t1 is a term too (t1 could be any term).

### Additional Lines in Input

The input files contain additional lines of text, besides the specification of the rules. Some of these lines start with #, but not all of them. There seems to be no strict structure to the files (see also the example file RuleFile1.txt). Before and after the specification of the rules, there are unstructured text lines.

The simplest solution to parsing such files seems to be the following. When parsing input files, any lines that lead to parse errors should be ignored, and only lines that are parsed correctly should be used in the translation. In the GUI, there should be a button that when pressed shows a message with all lines that were ignored.

### Input Preprocessing

A simple preprocessing step is needed on the input. For every occurrence of a subterm (tempop var1 var2) (where tempop is one of the operators tval, tmax, tmin, tsum, and var1 and var2 are variable names) we do the following.
If there is another rule of the form rname T num 1 1 0 var2 (where var2 is the same as in the subterm, and num is a positive integer), replace (tempop var1 var2) by (tempop var1 num).
If there is no such rule, then exit the whole process with a failure message.

### Example

If we have rules:

rvar1 T 5 1 10 van
rvar2 var3 6 1 1 (tval var4 var1) var2
then they should be processed to:
rvar1 T 5 1 1 0 var1
rvar2 var3 6 1 1 (tval var4 5) var2

### Handling Temporal Operators

We support the temporal operators tval, tmax, tmin and tsum. Since these operators refer to values of different time points, we need to add different time points also in the conversion to Z3. Therefore, we will replace variables t_val and t_def (for terms t) with a number of copies t_val_{—}1, t_def_{—}1, t_val_{—}2, t_def_{—}2, etc. and modify the conversion of the rules accordingly. This means that we replace the conversion for the non-temporal relations (the ones specified before) by copies for each single time point, and that we add conversions for the temporal relations, that specify relations between variables at different time points.

In order to be able to handle temporal operators, we need to consider the values of terms at different time points. We will use indices to handle this. For instance, if we have (Z3) terms t1_def and t1_val, and we are considering 3 time points, we will have t1_def_{—}1, t1_val_{—}1, t1_def_{—}2, t1_val_{—}2, t1_def_{—}3 and t1_val_{—}3.

For some temporal operators (tmin, tmax, tsum), we need to introduce additional (internal) indices, to be able to create Z3 rules that determine the values of the variables. We will add extra rules that link the Z3 variable names with extra indices to Z3 variable names with only one index (these rules will basically choose one value of the extra index to use as version with only one index).

### Computing Number of Time Points

When reading the input files, after preprocessing, we need to determine the maximum number m of time points needed in our translation. We do this as follows.

We save the maximum number n for each variable var, such that a subterm (tempop var n) occurs somewhere in the input rules (where tempop is one of the operators tval, tmax, tmin, tsum). If for a variable var, no such term occurs, we set the maximum for this var to 0. Then, we let the global maximum m be the sum of all maxima n for each variable var. Then, each Z3-rule in the translation needs to be copied m+1 times: one for each number from 1 to m+1. In each copy, for a number i; all the variable names var are suffixed with _i.

### Encoding

We create a SMT-LIB specification (in the form of a string consisting of multiple lines) given the input rules and the input reasoning problem. This string consists of the following lines.

For each variable name v occurring anywhere in the rules, a variable with name v should be created, for each i from 1 to m+1, using the line:
(declare-fun v_i ( ) Real)

For each (sub)term t occurring as one of the terms in any rule (including variables), two variables t_def and t_val should be created, for each i from 1 to m+1, using the lines:
(declare-fun t_def_i ( ) Bool)
(declare-fun t_val_i ( ) Real)

For each such subterm t, we add the following rules, by case distinction.

If t is a numerical constant c, we add the lines, for each i from 1 to m+1:
(assert t_def_i)
(assert (=t_val_i 1))

If t is of the form BAD, we add the line, for i from 1 to m+1:
(assert (not t_def_i))

If t is of the form T, we add the lines, for i from 1 to m+1:
(assert t_def_i)
(assert (=t_val_i 1))

If t is of the form (+t1 t2), for some subterms t1 and t2, we add the lines, for each i from 1 to m+1:
(assert (implies (not t1_def_i) (not t_def_i))
(assert (implies (not t2_def_i) (not t_def_i))
(assert (implies (and t1_def_i t2_def_i) t_def_i))
(assert (implies t_def_i (=(+t1_val_i t2_val_i) t_val_i)))

Similarly for −, * and / (replacing + in the substring and in the lines by −, * and / respectively).

If t is of the form (>t1 t2), for some subterms t1 and t2, we add the lines, for each i from 1 to m+1:
(assert (implies (not t1_def_i) (not t_def_i)))
(assert (implies (not t2_def_i) (not t_def_i)))
(assert (implies (and t1_def_i t2_def_i) t_def_i))
(assert (implies (and t_def_i (>t1_val_i t2_val_i)) (=t_val_i 1)))
(assert (implies (and t_def_i (<=t1_val_i t2_val_i)) (=t_val_i−1)))

If t is of the form (<t1 t2), for some subterms t1 and t2, we add the lines, for each i from 1 to m+1:
(assert (implies (not t1_def_i) (not t_def_i)))
(assert (implies (not t2_def_i) (not t_def_i)))
(assert (implies (and t1_def_i t2_def_i) t_def_i))
(assert (implies (and t_def_i (<t_val_i t2_val_i)) (=t_val_i 1)))
(assert (implies (and t_def_i (>=t_val_i t2_val_i)) (=t_val_i−1)))

If t is of the form (>=t1 t2), for some subterms t1 and t2, we add the lines, for each i from 1 to m+1:
(assert (implies (not t1_def_i) (not t_def_i)))
(assert (implies (not t2_def_i) (not t_def_i)))
(assert (implies (and t1_def_i t2_def_i) t_def_i))
(assert (implies (and t_def_i (>=t_val_i t2_val_i)) (=t_val_i 1)))
(assert (implies (and t_def_i (<t1_val_i t2_val_i)) (=t_val_i−1)))

If t is of the form (<=t1 t2), for some subterms t1 and t2, we add the lines, for each i from 1 to m+1:
(assert (implies (not t1_def_i) (not t_def_i)))
(assert (implies (not t2_def_i) (not t_def_i)))
(assert (implies (and t1_def_i t2_def_i) t_def_i))
(assert (implies (and t_def_i (<=t1_val_i t2_val_i)) (=t_val_i 1)))
(assert (implies (and t_def_i (>t1_val_i t2_val_i)) (=t_val_i−1)))

If t is of the form (&& t1 t2), for some subterms t1 and t2, we add the lines, for each i from 1 to m+1:
(assert (implies (not t1_def_i) (not t_def_i)))
(assert (implies (not t2_def_i) (not t_def_i)))
(assert (implies (and t1_def_i t2_def_i) t_def_i))
(assert (implies (and t_def_i (and (>=t_val_i 0) (>=t2_val_i 0))) (=t_val_i 1)))
(assert (implies (and t_def_i (or (<t_val_i 0) (<t2_val_i 0))) (=t_val_i−1)))

If t is of the form (//t1 t2), for some subterms t1 and t2, we add the lines, for each i from 1 to m+1:
(assert (implies (not t1_def_i) (not t_def_i)))
(assert (implies (not t2_def_i) (not t_def_i)))
(assert (implies (and t1_def_i t2_def_i) t_def_i))
(assert (implies (and t_def_i (or (>=t_val_i 0) (>=t2_val_i 0))) (=t_val_i 1)))
(assert (implies (and t_def_i (and (<t_val_i 0) (<t2_val_i 0))) (=t_val_i−1)))

For subterms t of the form (tval t1 int) the following lines should be added.
For each i from 1 to m+1:
   if i-int≦0, then add the line:
   (assert (not t_def_i))
   if i-int≧1, then let j=i-int, and add the lines:
   (assert (implies t1_def_j (and t_def_i (=t1_val_j t_val_i))))
   (assert (implies (not t1_def_j) (not t_def_i)))
For subterms t of the form (tsum t1 int) the following lines should be added.
   For each i from 1 to m+1, and for each k from 1 to int, then add the lines:
      (declare-fun t_def_k_i ( ) Bool)
      (declare-fun t_val_k_i ( ) Real)
   For each i from 1 to m+1, and for each k from 1 to int:
      if i-int≦0, then add the line:
         (assert (not t_def_k_i))
      if i-int≧1, then let j=i-int, then:
      if k=1, then add the lines:
         (assert t_def_k_i)
         (assert (implies t1_def_j (=t_val_k_i t1_val_j)))
         (assert (implies (not t1_def_j) (=t_val_k_i 0)))
      * if 1<k<=int, then let l=j+k−1, and add the lines:
         (assert t_def_k_i)
         (assert (implies t1_def_l (=t_val_k_i (+t_val_l t_val_k−1_i)))
         (assert (implies (not t1_def_l) (=t_val_k_i t_val_k−1_i)))
In this case there are two indices. One of them is only auxiliary. In order to work with only one index, we do the following. For each i from 1 to m+1, add the lines:
   (assert (=t_def_int_i t_def_i))
   (assert (=t_val_int_i t_val_i))

For subterms t of the form (tmin t1 int) the following lines should be added.
For each i from 1 to m+1, and for each k from 1 to int, then add the lines:
   (declare-fun t_def_k_i ( ) Bool)
   (declare-fun t_val_k_i ( ) Real)
For each i from 1 to m+1, and for each k from 1 to int.
   0. if i-int-≦0, then add the line:
      (assert (not t_def_k_i))
   0. if i-int≧1, then let j=i-int, then:
      if k=1, then add the lines:
         (assert (implies t1_def_j t_def_k_i))
         (assert (implies (not t1_def_j) (not t_def_k_i))
         (assert (implies t1_def_j (=t_val_k_i t1_val_j)))
      if 1<k<=int, then let l=j+k−1, and add the lines:
         (assert (implies (and (not t_def_k−1_i) (not t1_def_l)) (not t_def_k_i)))
         (assert (implies (and (not t_def_k−1_i) t1_def_i)
         (and t_def_k_i (=t_val_k_i t1_val_l))))
         (assert (implies (and t_def_k−1_i (not t1_def_l))
         (and t_def_k_i (=t_val_k_i t_val_k−1_i))))
         (assert (implies (and (and t_def_k−1_i t1_def_l)
         (<t1_val_l t_val_k−1_i)) (and t_def_k_i (=t_val_k_i t1_val_l))))
         (assert (implies (and (and t_def_k−1_i t1_def_l)
         (>=t1_val_l t_val_k−1_i))
         (and t_def_k_i (t_val_k_i t_val_k−1_i))))
0. In this case there are two indices. One of them is only auxiliary. In order to work with only one index, we do the following. For each i from 1 to m+1, add the lines:
   (assert (=t_def_int_i t_def_i))
   (assert (=t_val_int_i t_val_i))

For subterms t of the form (tmax t1 int) the following lines should be added.
0. For each i from 1 to m+1, and for each k from 1 to int.
   0. if i-int≦0, then add the line:
      (assert (not t_def_k_i))
   1. if i-int≧1, then let j=i-int, then:
      if k=1, then add the lines:
         (assert (implies t1_def_j t_def_k_i)
         (assert (implies (not t1_def_j) (not t_def_k_i))
         (assert (implies t1_def_j (=t_val_k_i t1_val_j)))
      If 1<k<=int, then let l=j+k−1, and add the lines:
         (assert (implies (and (not t_def_k−1_i) (not t1_def_l)) (not t_def_k_i)))
         (assert (implies (and (not t_def_k−1_i) t1_def_l)
         (and t_def_k_i (=t_val_k_i t1_val_l))))
         (assert (implies (and t_def_k−1_i (not t1_def_l)
         (and t_def_k_i (=t_val_k_i t_val_k−1_i))))
         (assert (implies (and (and t_def_k−1_i t1_def_l)
         (>t1_val_l t_val_k−1_i)) (and t_def_k_i (=t_val_k_i t1_val_l))
         (assert (implies (and (and t_def_k−1_i t1_def_l)
         (<=t_val_l t_val_k−1_i)) (and t_def_k_i (=t_val_k_i t_val_k−1_i))))
0. In this case there are two indices. One of them is only auxiliary. In order to work with only one index, we do the following. For each i from 1 to m+1, add the lines:
   (assert (=t_def_int_i t_def_i))
   (assert (=t_val_int_i t_val_i))

Note that in the above, wherever is written k−1 inside a string and k has a value (say for example 5), then this k−1 should be interpreted as the value of k minus 1 (so in the example 4).

For subterms t of the form (dead_band_break var) the following lines should be added. (The internal working of such terms is so complex that it is unclear how to handle them in the translation, so we take a conservative estimate and only declare variables without putting extra constraints on them.)
For each i from 1 to m+1, add the lines:
   (declare-fun t_def_i ( ) Bool)
   (declare-fun t_val_i ( ) Real)

For subterms t of the form FREEZE the following lines should be added. (The internal working of such terms is so complex that it is unclear how to handle them in the translation, so we take a conservative estimate and only declare variables without putting extra constraints on them.)
For each i from 1 to m+1, add the lines:
   (declare-fun t_def_i ( ) Bool)
   (declare-fun t_val_i ( ) Real)

For subterms t of the form (bad_status t1) the following lines should be added.
0. For each i from 1 to m+1, add the lines:
   (declare-fun t_def_i ( ) Bool)
   (declare-fun t_val_i ( ) Real)
1. For each i from 1 to m+1, add the lines:
   (assert t_def_i)
   (assert (implies (not t1_def_i) (=t_val_i 1)))
   (assert (implies t1_def_i (=t_val_i 0)))

### Reasoning Problems

The reasoning problem of rule subsumption given by the user by a subsumer variable s1 and a subsumed variable s2, is encoded with the following lines.
(assert (or (and s1_def_m+1 (not s2_def_m+1)) (and (and s1_def_m+1 s2_def_m+1)(not (=s1_val_m+1 s2_val_m+1)))))

The reasoning problem of rule equivalence given by the user by a one variable s1 and another variable s2, is encoded with the following lines.
(assert (or (and s1_def_m+1 (not s2_def_m+1)) (and s2_def_m+1 (not s1_def_m+1))
   (and (and s1_def_m+1 s2_def_m+1) (not (=s1_val_m+1 s2 val_m+1)))))

The reasoning problem of rule satisfiability given by the user by a variable s, is encoded with the following lines.
(assert s_def_m+1)

### EXAMPLES

The invention works as specified above. Here, we describe a few examples of where the invention can concretely be used to detect inconsistencies, equivalences and subsumptions.

### Inconsistent Rules

### Example Rules:

| | | | | | | |
|---|---|---|---|---|---|---|
| rvar5 | T | (tmin var3 2) | 1 | 1 | 0 | var5 |
| rvar6 | T | (tmax var3 2) | 1 | 1 | 0 | var6 |

| | | | | | | |
|---|---|---|---|---|---|---|
| rvar7 | (>var6 var5) 2 | 1 | 1 | 1 | BAD | var7 |

| | | | | | | |
|---|---|---|---|---|---|---|
| rvar8 | T | (tsum var3 2) | 1 | 1 | 0 | var8 |
| rvar9 | T | (tsum var3 3) | 1 | 1 | 0 | var9 |
| rvar10 | T | (tval var3 3) | 1 | 1 | 0 | var10 |

| | | | | | | |
|---|---|---|---|---|---|---|
| rvar11 | (>(+var8 var10) var9) | 2 | 1 | 1 | BAD | var11 |

In the above example, the variables ‘var7’ and ‘var11’ are inconsistent (i.e., for no variable assignment, they get a defined value).

The encoding of the above example into SMT-LIB format (without the encoding of any of the inconsistency problems):
(declare-fun t88_def_{—}1( ) Bool)
(declare-fun t88_val_{—}1( ) Real)
(assert t88_def_{—}1)
(assert (=t88_val_{—}1 1.0))
(declare-fun t88_def_{—}2( ) Bool)
(declare-fun t88_val_{—}2( ) Real)
(assert t88_def_{—}2)
(assert (=t88_val_{—}2 1.0))
(declare-fun t88_def_{—}3( ) Bool)
(declare-fun t88_val_{—}3( ) Real)
(assert t88_def_{—}3)
(assert (=t88_val_{—}3 1.0))
(declare-fun t88_def_{—}4( ) Bool)
(declare-fun t88_val_{—}4( ) Real)
(assert t88_def_{—}4)
(assert (=t88_val_{—}4 1.0))
(declare-fun t89_def_{—}1( ) Bool)
(declare-fun t89_val_{—}1( ) Real)
(declare-fun var3_{—}1( ) Real)
(assert (=var3_{—}1 t89_val_{—}1))
(declare-fun t89_def_{—}2( ) Bool)
(declare-fun t89_val_{—}2( ) Real)
(declare-fun var3_{—}2( ) Real)
(assert (=var3_{—}2 t89_val_{—}2))
(declare-fun t89_def_{—}3( ) Bool)
(declare-fun t89_val_{—}3( ) Real)
(declare-fun var3_{—}3( ) Real)
(assert (=var3_{—}3 t89_val_{—}3))
(declare-fun t89_def_{—}4( ) Bool)
(declare-fun t89_val_{—}4( ) Real)
(declare-fun var3_{—}4( ) Real)
(assert (=var3_{—}4 t89_val_{—}4))
(declare-fun t90_def_{—}1_{—}1( ) Bool)
(declare-fun t90_val_{—}1_{—}1( ) Real)
(declare-fun t90_def_{—}2_{—}1( ) Bool)
(declare-fun t90_val_{—}2_{—}1( ) Real)
(declare-fun t90_def_{—}1_{—}2( ) Bool)
(declare-fun t90_val_{—}1_{—}2( ) Real)
(declare-fun t90_def_{—}2_{—}2( ) Bool)
(declare-fun t90_val_{—}2_{—}2( ) Real)
(declare-fun t90_def_{—}1_{—}3( ) Bool)
(declare-fun t90_val_{—}1_{—}3( ) Real)
(declare-fun t90_def_{—}2_{—}3( ) Bool)
(declare-fun t90_val_{—}2_{—}3( ) Real)
(declare-fun t90_def_{—}1_{—}4( ) Bool)
(declare-fun t90_val_{—}1_{—}4( ) Real)
(declare-fun t90_def_{—}2_{—}4( ) Bool)
(declare-fun t90_val_{—}2_{—}4( ) Real)
(assert (not t90_def_{—}1_{—}1))
(assert (not t90_def_{—}2_{—}1))
(assert (not t90_def_{—}1_{—}2))
(assert (not t90_def_{—}2_{—}2))
(assert (implies t89_def_{—}1 t90_def_{—}1_{—}3))
(assert (implies (not t89_def_{—}1) (not t90_def_{—}1_{—}3)))
(assert (implies t89_def_{—}1 (=t90_val_{—}1_{—}3 t89_val_{—}1)))
(assert (implies (and (not t90_def_{—}1_{—}3) (not t89_def_{—}2)) (not t90_def_{—}2_{—}3)))
(assert (implies (and (not t90_def_{—}1_{—}3) t89_def_{—}2) (and t90_def_{—}2_{—}3 (=t90_val_{—}2_{—}3 t89_val_{—}2))))
(assert (implies (and t90_def_{—}1_{—}3 (not t89_def_{—}2)) (and t90_def_{—}2_{—}3 (=t90_val_{—}2_{—}3 t90_val_{—}1_{—}3))))
(assert (implies (and (and t90_def_{—}1_{—}3 t89_def_{—}2) (<t89_val_{—}2 t90_val_{—}1_{—}3)) (and t90_def_{—}2_{—}3 (=t90_val_{—}2_{—}3 t89_val_{—}2))))
(assert (implies (and (and t90_def_{—}1_{—}3 t89_def_{—}2) (>=t89_val_{—}2 t90_val_{—}1_{—}3)) (and t90_def_{—}2_{—}3 (=t90_val_{—}2_{—}3 t90_val_{—}1_{—}3))))
(assert (implies t89_def_{—}2 t90_def_{—}1_{—}4))
(assert (implies (not t89_def_{—}2) (not t90_def_{—}1_{—}4)))
(assert (implies t89_def_{—}2 (=t90_val_{—}1_{—}4 t89_val_{—}2)))
(assert (implies (and (not t90_def_{—}1_{—}4) (not t89_def_{—}3)) (not t90_def_{—}2_{—}4)))
(assert (implies (and (not t90_def_{—}1_{—}4) t89_def_{—}3) (and t90_def_{—}2_{—}4 (=t90_val_{—}2_{—}4 t89_val_{—}3))))
(assert (implies (and t90_def_{—}1_{—}4 (not t89_def_{—}3)) (and t90_def_{—}2_{—}4 (=t90_val_{—}2_{—}4 t90_val_{—}1_{—}4))))
(assert (implies (and (and t90_def_{—}1_{—}4 t89_def_{—}3) (<t89_val_{—}3 t90_val_{—}1_{—}4)) (and t90_def_{—}2_{—}4 (=t90_val_{—}2_{—}4 t89_val_{—}3))))
(assert (implies (and (and t90_def_{—}1_{—}4 t89_def_{—}3) (>=t89_val_{—}3 t90_val_{—}1_{—}4)) (and t90_def_{—}2_{—}4 (=t90_val_{—}2_{—}4 t90_val_{—}1_{—}4))))
(declare-fun t90_def_{—}1( ) Bool)
(declare-fun t90_val_{—}1( ) Real)
(assert (=t90_def_{—}2_{—}1 t90_def_{—}1))
(assert (=t90_val_{—}2_{—}1 t90_val_{—}1))
(declare-fun t90_def_{—}2( ) Bool)
(declare-fun t90_val_{—}2( ) Real)
(assert (=t90_def_{—}2_{—}2 t90 def_{—}2))
(assert (=t90_val_{—}2_{—}2 t90_val_{—}2))
(declare-fun t90_def_{—}3( ) Bool)
(declare-fun t90_val_{—}3( ) Real)
(assert (=t90_def_{—}2_{—}3 t90 def_{—}3))
(assert (=t90_val_{—}2_{—}3 t90_val_{—}3))
(declare-fun t90_def_{—}4( ) Bool)
(declare-fun t90_val_{—}4( ) Real)
(assert (=t90_def_{—}2_{—}4 t90 def_{—}4))
(assert (=t90_val_{—}2_{—}4 t90_val_{—}4))
(declare-fun t91_def_{—}1( ) Bool)
(declare-fun t91_val_{—}1( ) Real)
(assert t91_def_{—}1)
(assert (=t91_val_{—}1 1.0))
(declare-fun t91_def_{—}2( ) Bool)
(declare-fun t91_val_{—}2( ) Real)
(assert t91_def_{—}2)
(assert (=t91_val_{—}2 1.0))
(declare-fun t91_def_{—}3( ) Bool)
(declare-fun t91_val_{—}3( ) Real)
(assert t91_def_{—}3)
(assert (=t91_val_{—}3 1.0))
(declare-fun t91_def_{—}4( ) Bool)
(declare-fun t91_val_{—}4( ) Real)
(assert t91_def_{—}4)
(assert (=t91_val_{—}4 1.0))
(declare-fun t92_def_{—}1( ) Bool)
(declare-fun t92_val_{—}1( ) Real)
(assert t92_def_{—}1)
(assert (=t92_val_{—}1 1.0))
(declare-fun t92_def_{—}2( ) Bool)
(declare-fun t92_val_{—}2( ) Real)
(assert t92_def_{—}2)
(assert (=t92_val_{—}2 1.0))
(declare-fun t92_def_{—}3( ) Bool)
(declare-fun t92_val_{—}3( ) Real)
(assert t92_def_{—}3)
(assert (=t92_val_{—}3 1.0))
(declare-fun t92_def_{—}4( ) Bool)
(declare-fun t92_val_{—}4( ) Real)
(assert t92_def_{—}4)
(assert (=t92_val_{—}4 1.0))
(declare-fun t93_def_{—}1( ) Bool)
(declare-fun t93_val_{—}1( ) Real)
(assert t93_def_{—}1)
(assert (=t93_val_{—}1 0.0))
(declare-fun t93_def_{—}2( ) Bool)
(declare-fun t93_val_{—}2( ) Real)
(assert t93_def_{—}2)
(assert (=t93_val_{—}2 0.0))
(declare-fun t93_def_{—}3( ) Bool)
(declare-fun t93_val_{—}3( ) Real)
(assert t93_def_{—}3)
(assert (=t93_val_{—}3 0.0))
(declare-fun t93_def_{—}4( ) Bool)
(declare-fun t93_val_{—}4( ) Real)
(assert t93_def_{—}4)
(assert (=t93_val_{—}4 0.0))
(declare-fun t94_def_{—}1( ) Bool)
(declare-fun t94_val_{—}1( ) Real)
(declare-fun var5_{—}1( ) Real)
(assert (=var5_{—}1 t94_val_{—}1))
(declare-fun t94_def_{—}2( ) Bool)
(declare-fun t94_val_{—}2( ) Real)
(declare-fun var5_{—}2( ) Real)
(assert (=var5_{—}2 t94_val_{—}2))
(declare-fun t94_def_{—}3( ) Bool)
(declare-fun t94_val_{—}3( ) Real)
(declare-fun var5_{—}3( ) Real)
(assert (=var5_{—}3 t94_val_{—}3))
(declare-fun t94_def_{—}4( ) Bool)
(declare-fun t94_val_{—}4( ) Real)
(declare-fun var5_{—}4) Real)
(assert (=var5_{—}4 t94_val_{—}4))
(assert (implies (and (and t88_def_{—}1 (>=t88_val_{—}1 0.0)) (not t90_def_{—}1))(not t94_def_{—}1)))
(assert (implies (and (and (and (>=t88_val_{—}1 0.0) t88_def_{—}1)(and (>=t90_val_{—}1 0.0) t90_def_{—}1)) t91_def_{—}1) (and t94_def_{—}1 (=t94_val_{—}1 (*t90_val_{—}1 t91_val_{—}1)))))
(assert (implies (and (and (and (>=t88_val_{—}1 0.0) t88_def_{—}1)(and (>=t90_val_{—}1 0.0) t90_def_{—}1)) (not t91_def_{—}1)) (not t94_def_{—}1)))
(assert (implies (and (and (and (>=t88_val_{—}1 0.0) t88_def_{—}1)(and (<t90_val_{—}1 0.0) t90_def_{—}1)) t92_def_{—}1) (and t94_def_{—}1 (=t94_val_{—}1 (*t90_val_{—}1 t92_val_{—}1)))))
(assert (implies (and (and (and (>=t88_val_{—}1 0.0) t88_def_{—}1)(and (<t90_val_{—}1 0.0) t90_def_{—}1)) (not t92_def_{—}1)) (not t94_def_{—}1)))
(assert (implies (and (and (>=t88_val_{—}1 0.0) t88_def_{—}1) (not t90_def_{—}1))(not t94_def_{—}1)))
(assert (implies (and (and (<t88_val_{—}1 0.0) t88_def_{—}1) t93_def_{—}1)(and t94_def_{—}1 (=t94_val_{—}1 t93_val_{—}1))))
(assert (implies (and (and (<t88_val_{—}1 0.0) t88_def_{—}1) (not t93_def_{—}1))(not t94_def_{—}1)))
(assert (implies (not t88_def_{—}1) (not t94_def_{—}1)))
(assert (implies (and (and t88_def_{—}2 (>=t88_val_{—}2 0.0)) (not t90_def_{—}2))(not t94_def_{—}2)))
(assert (implies (and (and (and (>=t88_val_{—}2 0.0) t88_def_{—}2)(and (>=t90_val_{—}2 0.0) t90_def_{—}2)) t91_def_{—}2) (and t94_def_{—}2 (=t94_val_{—}2 (*t90_val_{—}2 t91_val_{—}2)))))
(assert (implies (and (and (and (>=t88_val_{—}2 0.0) t88_def_{—}2)(and (>=t90_val_{—}2 0.0) t90_def_{—}2)) (not t91_def_{—}2)) (not t94_def_{—}2)))
(assert (implies (and (and (and (>=t88_val_{—}2 0.0) t88_def_{—}2)(and (<t90_val_{—}2 0.0) t90_def_{—}2)) t92_def_{—}2) (and t94_def_{—}2 (=t94_val_{—}2 (*t90_val_{—}2 t92_val_{—}2)))))
(assert (implies (and (and (and (>=t88_val_{—}2 0.0) t88_def_{—}2)(and (<t90_val_{—}2 0.0) t90_def_{—}2)) (not t92_def_{—}2)) (not t94_def_{—}2)))
(assert (implies (and (and (>=t88_val_{—}2 0.0) t88_def_{—}2) (not t90_def_{—}2))(not t94_def_{—}2)))
(assert (implies (and (and (<t88_val_{—}2 0.0) t88_def_{—}2) t93_def_{—}2)(and t94_def_{—}2 (=t94_val_{—}2 t93_val_{—}2))))
(assert (implies (and (and (<t88_val_{—}2 0.0) t88_def_{—}2) (not t93_def_{—}2))(not t94_def_{—}2)))
(assert (implies (not t88_def_{—}2) (not t94_def_{—}2)))
(assert (implies (and (and t88_def_{—}3 (>=t88_val_{—}3 0.0)) (not t90_def_{—}3))(not t94_def_{—}3)))
(assert (implies (and (and (and (>=t88_val_{—}3 0.0) t88_def_{—}3)(and (>=t90_val_{—}3 0.0) t90_def_{—}3)) t91_def_{—}3) (and t94_def_{—}3 (=t94_val_{—}3 (*t90_val_{—}3 t91_val_{—}3)))))
(assert (implies (and (and (and (>=t88_val_{—}3 0.0) t88_def_{—}3)(and (>=t90_val_{—}3 0.0) t90_def_{—}3)) (not t91_def_{—}3)) (not t94_def_{—}3)))
(assert (implies (and (and (and (>=t88_val_{—}3 0.0) t88_def_{—}3)(and (<t90_val_{—}3 0.0) t90_def_{—}3)) t92_def_{—}3) (and t94_def_{—}3 (=t94_val_{—}3 (*t90_val_{—}3 t92_val_{—}3)))))
(assert (implies (and (and (and (>=t88_val_{—}3 0.0) t88_def_{—}3)(and (<t90_val_{—}3 0.0) t90_def_{—}3)) (not t92_def_{—}3)) (not t94_def_{—}3)))
(assert (implies (and (and (>=t88_val_{—}3 0.0) t88_def_{—}3) (not t90_def_{—}3))(not t94_def_{—}3)))
(assert (implies (and (and (<t88_val_{—}3 0.0) t88_def_{—}3) t93_def_{—}3)(and t94_def_{—}3 (=t94_val_{—}3 t93_val_{—}3))))
(assert (implies (and (and (<t88_val_{—}3 0.0) t88_def_{—}3) (not t93_def_{—}3))(not t94_def_{—}3)))
(assert (implies (not t88_def_{—}3) (not t94_def_{—}3)))
(assert (implies (and (and t88_def_{—}4 (>=t88_val_{—}4 0.0)) (not t90_def_{—}4))(not t94_def_{—}4)))
(assert (implies (and (and (and (>=t88_val_{—}4 0.0) t88_def_{—}4)(and (>=t90_val_{—}4 0.0) t90_def_{—}4)) t91_def_{—}4) (and t94_def_{—}4 (=t94_val_{—}4 (*t90_val_{—}4 t91_val_{—}4)))))
(assert (implies (and (and (and (>=t88_val_{—}4 0.0) t88_def_{—}4)(and (>=t90_val_{—}4 0.0) t90_def_{—}4)) (not t91_def_{—}4)) (not t94_def_{—}4)))
(assert (implies (and (and (and (>=t88_val_{—}4 0.0) t88_def_{—}4)(and (<t90_val_{—}4 0.0) t90_def_{—}4)) t92_def_{—}4) (and t94_def_{—}4 (=t94_val_{—}4 (*t90_val_{—}4 t92_val_{—}4)))))
(assert (implies (and (and (and (>=t88_val_{—}4 0.0) t88_def_{—}4)(and (<t90_val_{—}4 0.0) t90_def_{—}4)) (not t92_def_{—}4)) (not t94_def_{—}4)))
(assert (implies (and (and (>=t88_val_{—}4 0.0) t88_def_{—}4) (not t90_def_{—}4))(not t94_def_{—}4)))
(assert (implies (and (and (<t88_val_{—}4 0.0) t88_def_{—}4) t93_def_{—}4)(and t94_def_{—}4 (=t94_val_{—}4 t93_val_{—}4))))
(assert (implies (and (and (<t88_val_{—}4 0.0) t88_def_{—}4) (not t93_def_{—}4))(not t94_def_{—}4)))
(assert (implies (not t88_def_{—}4) (not t94_def_{—}4)))
(declare-fun t95_def_{—}1( ) Bool)
(declare-fun t95_val_{—}1( ) Real)
(assert t95_def_{—}1)
(assert (=t95_val_{—}1 1.0))
(declare-fun t95_def_{—}2( ) Bool)
(declare-fun t95_val_{—}2( ) Real)
(assert t95_def_{—}2)
(assert (=t95_val_{—}2 1.0))
(declare-fun t95_def_{—}3( ) Bool)
(declare-fun t95_val_{—}3( ) Real)
(assert t95_def_{—}3)
(assert (=t95_val_{—}3 1.0))
(declare-fun t95_def_{—}4( ) Bool)
(declare-fun t95_val_{—}4( ) Real)
(assert t95_def_{—}4)
(assert (=t95_val_{—}4 1.0))
(declare-fun t96_def_{—}1_{—}1( ) Bool)
(declare-fun t96_val_{—}1_{—}1( ) Real)
(declare-fun t96_def_{—}2_{—}1( ) Bool)
(declare-fun t96_val_{—}2_{—}1( ) Real)
(declare-fun t96_def_{—}1_{—}2( ) Bool)
(declare-fun t96_val_{—}1_{—}2( ) Real)
(declare-fun t96_def_{—}2_{—}2( ) Bool)
(declare-fun t96_val_{—}2_{—}2( ) Real)
(declare-fun t96_def_{—}1_{—}3( ) Bool)
(declare-fun t96_val_{—}1_{—}3( ) Real)
(declare-fun t96_def_{—}2_{—}3( ) Bool)
(declare-fun t96_val_{—}2_{—}3( ) Real)
(declare-fun t96_def_{—}1_{—}4( ) Bool)
(declare-fun t96_val_{—}1_{—}4( ) Real)
(declare-fun t96_def_{—}2_{—}4( ) Bool)
(declare-fun t96_val_{—}2_{—}4( ) Real)
(assert (not t96_def_{—}1_{—}1))
(assert (not t96_def_{—}2_{—}1))
(assert (not t96_def_{—}1_{—}2))
(assert (not t96_def_{—}2_{—}2))
(assert (implies t89_def_{—}1 t96_def_{—}1_{—}3))
(assert (implies (not t89_def_{—}1) (not t96_def_{—}1_{—}3)))
(assert (implies t89_def_{—}1 (=t96_val_{—}1_{—}3 t89_val_{—}1)))
(assert (implies (and (not t96_def_{—}1_{—}3) (not t89_def_{—}2)) (not t96_def_{—}2_{—}3)))
(assert (implies (and (not t96_def_{—}1_{—}3) t89_def_{—}2) (and t96_def_{—}2_{—}3 (=t96_val_{—}2_{—}3 t89_val_{—}2))))
(assert (implies (and t96_def_{—}1_{—}3 (not t89_def_{—}2)) (and t96_def_{—}2_{—}3 (=t96_val_{—}2_{—}3 t96_val_{—}1_{—}3))))
(assert (implies (and (and t96_def_{—}1_{—}3 t89_def_{—}2) (>t89_val_{—}2 t96_val_{—}1_{—}3)) (and t96_def_{—}2_{—}3 (=t96_val_{—}2_{—}3 t89_val_{—}2))))
(assert (implies (and (and t96_def_{—}1_{—}3 t89_def_{—}2) (<=t89_val_{—}2 t96_val_{—}1_{—}3)) (and t96_def_{—}2_{—}3 (=t96_val_{—}2_{—}3 t96_val_{—}1_{—}3))))
(assert (implies t89_def_{—}2 t96_def_{—}1_{—}4))
(assert (implies (not t89_def_{—}2) (not t96_def_{—}1_{—}4)))
(assert (implies t89_def_{—}2 (=t96_val_{—}1_{—}4 t89_val_{—}2)))
(assert (implies (and (not t96_def_{—}1_{—}4) (not t89_def_{—}3)) (not t96_def_{—}2_{—}4)))
(assert (implies (and (not t96_def_{—}1_{—}4) t89_def_{—}3) (and t96_def_{—}2_{—}4 (=t96_val_{—}2_{—}4 t89_val_{—}3))))
(assert (implies (and t96_def_{—}1_{—}4 (not t89_def_{—}3)) (and t96_def_{—}2_{—}4 (=t96_val_{—}2_{—}4 t96_val_{—}1_{—}4))))
(assert (implies (and (and t96_def_{—}1_{—}4 t89_def_{—}3) (>t89_val_{—}3 t96_val_{—}1_{—}4)) (and t96_def_{—}2_{—}4 (=t96_val_{—}2_{—}4 t89_val_{—}3))))
(assert (implies (and (and t96_def_{—}1_{—}4 t89_def_{—}3) (<=t89_val_{—}3 t96_val_{—}1_{—}4)) (and t96_def_{—}2_{—}4 (=t96_val_{—}2_{—}4 t96_val_{—}1_{—}4))))
(declare-fun t96_def_{—}1( ) Bool)
(declare-fun t96_val_{—}1( ) Real)
(assert (=t96_def_{—}2_{—}1 t96_def_{—}1))
(assert (=t96_val_{—}2_{—}1 t96_val_{—}1))
(declare-fun t96_def_{—}2( ) Bool)
(declare-fun t96_val_{—}2( ) Real)
(assert (=t96_def_{—}2_{—}2 t96 def_{—}2))
(assert (=t96_val_{—}2_{—}2 t96_val_{—}2))
(declare-fun t96_def_{—}3( ) Bool)
(declare-fun t96_val_{—}3( ) Real)
(assert (=t96_def_{—}2_{—}3 t96 def_{—}3))
(assert (=t96_val_{—}2_{—}3 t96_val_{—}3))
(declare-fun t96_def_{—}4( ) Bool)
(declare-fun t96_val_{—}4( ) Real)
(assert (=t96_def_{—}2_{—}4 t96 def_{—}4))
(assert (=t96_val_{—}2_{—}4 t96_val_{—}4))
(declare-fun t97_def_{—}1( ) Bool)
(declare-fun t97_val_{—}1( ) Real)
(assert t97_def_{—}1)
(assert (=t97_val_{—}1 1.0))
(declare-fun t97_def_{—}2( ) Bool)
(declare-fun t97_val_{—}2( ) Real)
(assert t97_def_{—}2)
(assert (=t97_val_{—}2 1.0))
(declare-fun t97_def_{—}3( ) Bool)
(declare-fun t97_val_{—}3( ) Real)
(assert t97_def_{—}3)
(assert (=t97_val_{—}3 1.0))
(declare-fun t97_def_{—}4( ) Bool)
(declare-fun t97_val_{—}4( ) Real)
(assert t97_def_{—}4)
(assert (=t97_val_{—}4 1.0))
(declare-fun t98_def_{—}1( ) Bool)
(declare-fun t98_val_{—}1( ) Real)
(assert t98_def_{—}1)
(assert (=t98_val_{—}1 1.0))
(declare-fun t98_def_{—}2( ) Bool)
(declare-fun t98_val_{—}2( ) Real)
(assert t98_def_{—}2)
(assert (=t98_val_{—}2 1.0))
(declare-fun t98_def_{—}3( ) Bool)
(declare-fun t98_val_{—}3( ) Real)
(assert t98_def_{—}3)
(assert (=t98_val_{—}3 1.0))
(declare-fun t98_def_{—}4( ) Bool)
(declare-fun t98_val_{—}4( ) Real)
(assert t98_def_{—}4)
(assert (=t98_val_{—}4 1.0))
(declare-fun t99_def_{—}1( ) Bool)
(declare-fun t99_val_{—}1( ) Real)
(assert t99_def_{—}1)
(assert (=t99_val_{—}1 0.0))
(declare-fun t99_def_{—}2( ) Bool)
(declare-fun t99_val_{—}2( ) Real)
(assert t99_def_{—}2)
(assert (=t99_val_{—}2 0.0))
(declare-fun t99_def_{—}3( ) Bool)
(declare-fun t99_val_{—}3( ) Real)
(assert t99_def_{—}3)
(assert (=t99_val_{—}3 0.0))
(declare-fun t99_def_{—}4( ) Bool)
(declare-fun t99_val_{—}4( ) Real)
(assert t99_def_{—}4)
(assert (=t99_val_{—}4 0.0))
(declare-fun t100_def_{—}1( ) Bool)
(declare-fun t100_val_{—}1( ) Real)
(declare-fun var6_{—}1( ) Real)
(assert (=var6_{—}1 t100_val_{—}1))
(declare-fun t100_def_{—}2( ) Bool)
(declare-fun t100_val_{—}2( ) Real)
(declare-fun var6_{—}2( ) Real)
(assert (=var6_{—}2 t100_val_{—}2))
(declare-fun t100_def_{—}3( ) Bool)
(declare-fun t100_val_{—}3( ) Real)
(declare-fun var6_{—}3( ) Real)
(assert (=var6_{—}3 t100_val_{—}3))
(declare-fun t100_def_{—}4( ) Bool)
(declare-fun t100_val_{—}4) Real)
(declare-fun var6_{—}4) Real)
(assert (=var6_{—}4 t100_val_{—}4))
(assert (implies (and (and t95_def_{—}1 (>=t95_val_{—}1 0.0)) (not t96_def_{—}1))(not t100_def_{—}1)))
(assert (implies (and (and (and (>=t95_val_{—}1 0.0) t95_def_{—}1)(and (>=t96_val_{—}1 0.0) t96_def_{—}1)) t97_def_{—}1) (and t100_def_{—}1 (=t100_val_{—}1 (*t96_val_{—}1 t97_val_{—}1)))))
(assert (implies (and (and (and (>=t95_val_{—}1 0.0) t95_def_{—}1)(and (>=t96_val_{—}1 0.0) t96_def_{—}1)) (not t97_def_{—}1)) (not t100_def_{—}1)))
(assert (implies (and (and (and (>=t95_val_{—}1 0.0) t95_def_{—}1)(and (<t96_val_{—}1 0.0) t96_def_{—}1)) t98_def_{—}1) (and t100_def_{—}1 (=t100_val_{—}1 (*t96_val_{—}1 t98_val_{—}1)))))
(assert (implies (and (and (and (>=t95_val_{—}1 0.0) t95_def_{—}1)(and (<t96_val_{—}1 0.0) t96_def_{—}1)) (not t98_def_{—}1)) (not t100_def_{—}1)))
(assert (implies (and (and (>=t95_val_{—}1 0.0) t95_def_{—}1) (not t96_def_{—}1))(not t100_def_{—}1)))
(assert (implies (and (and (<t95_val_{—}1 0.0) t95_def_{—}1) t99_def_{—}1)(and t100_def_{—}1 (=t100_val_{—}1 t99_val_{—}1))))
(assert (implies (and (and (<t95_val_{—}1 0.0) t95_def_{—}1) (not t99_def_{—}1))(not t100_def_{—}1)))
(assert (implies (not t95_def_{—}1) (not t100_def_{—}1)))
(assert (implies (and (and t95_def_{—}2 (>=t95_val_{—}2 0.0)) (not t96_def_{—}2))(not t100_def_{—}2)))
(assert (implies (and (and (and (>=t95_val_{—}2 0.0) t95_def_{—}2)(and (>=t96_val_{—}2 0.0) t96_def_{—}2)) t97_def_{—}2) (and t100_def_{—}2 (=t100_val_{—}2 (*t96_val_{—}2 t97_val_{—}2)))))
(assert (implies (and (and (and (>=t95_val_{—}2 0.0) t95_def_{—}2)(and (>=t96_val_{—}2 0.0) t96_def_{—}2)) (not t97_def_{—}2)) (not t100_def_{—}2)))
(assert (implies (and (and (and (>=t95_val_{—}2 0.0) t95_def_{—}2)(and (<t96_val_{—}2 0.0) t96_def_{—}2)) t98_def_{—}2) (and t100_def_{—}2 (=t100_val_{—}2 (*t96_val_{—}2 t98_val_{—}2)))))
(assert (implies (and (and (and (>=t95_val_{—}2 0.0) t95_def_{—}2)(and (<t96_val_{—}2 0.0) t96_def_{—}2)) (not t98_def_{—}2)) (not t100_def_{—}2)))
(assert (implies (and (and (>=t95_val_{—}2 0.0) t95_def_{—}2) (not t96_def_{—}2))(not t100_def_{—}2)))
(assert (implies (and (and (<t95_val_{—}2 0.0) t95_def_{—}2) t99_def_{—}2)(and t100_def_{—}2 (=t100_val_{—}2 t99_val_{—}2))))
(assert (implies (and (and (<t95_val_{—}2 0.0) t95_def_{—}2) (not t99_def_{—}2))(not t100_def_{—}2)))
(assert (implies (not t95_def_{—}2) (not t100_def_{—}2)))
(assert (implies (and (and t95_def_{—}3 (>=t95_val_{—}3 0.0)) (not t96_def_{—}3))(not t100_def_{—}3)))
(assert (implies (and (and (and (>=t95_val_{—}3 0.0) t95_def_{—}3)(and (>=t96_val_{—}3 0.0) t96_def_{—}3)) t97_def_{—}3) (and t100_def_{—}3 (=t100_val_{—}3 (*t96_val_{—}3 t97_val_{—}3)))))
(assert (implies (and (and (and (>=t95_val_{—}3 0.0) t95_def_{—}3)(and (>=t96_val_{—}3 0.0) t96_def_{—}3)) (not t97_def_{—}3)) (not t100_def_{—}3)))
(assert (implies (and (and (and (>=t95_val_{—}3 0.0) t95_def_{—}3)(and (<t96_val_{—}3 0.0) t96_def_{—}3)) t98_def_{—}3) (and t100_def_{—}3 (=t100_val_{—}3 (*t96_val_{—}3 t98_val_{—}3)))))
(assert (implies (and (and (and (>=t95_val_{—}3 0.0) t95_def_{—}3)(and (<t96_val_{—}3 0.0) t96_def_{—}3)) (not t98_def_{—}3)) (not t100_def_{—}3)))
(assert (implies (and (and (>=t95_val_{—}3 0.0) t95_def_{—}3) (not t96_def_{—}3))(not t100_def_{—}3)))
(assert (implies (and (and (<t95_val_{—}3 0.0) t95_def_{—}3) t99_def_{—}3)(and t100_def_{—}3 (=t100_val_{—}3 t99_val_{—}3))))
(assert (implies (and (and (<t95_val_{—}3 0.0) t95_def_{—}3) (not t99_def_{—}3))(not t100_def_{—}3)))
(assert (implies (not t95_def_{—}3) (not t100_def_{—}3)))
(assert (implies (and (and t95_def_{—}4 (>=t95_val_{—}4 0.0)) (not t96_def_{—}4))(not t100_def_{—}4)))
(assert (implies (and (and (and (>=t95_val_{—}4 0.0) t95_def_{—}4)(and (>=t96_val_{—}4 0.0) t96_def_{—}4)) t97_def_{—}4) (and t100_def_{—}4 (=t100_val_{—}4 (*t96_val_{—}4 t97_val_{—}4)))))
(assert (implies (and (and (and (>=t95_val_{—}4 0.0) t95_def_{—}4)(and (>=t96_val_{—}4 0.0) t96_def_{—}4)) (not t97_def_{—}4)) (not t100_def_{—}4)))
(assert (implies (and (and (and (>=t95_val_{—}4 0.0) t95_def_{—}4)(and (<t96_val_{—}4 0.0) t96_def_{—}4)) t98_def_{—}4) (and t100_def_{—}4 (=t100_val_{—}4 (*t96_val_{—}4 t98_val_{—}4)))))
(assert (implies (and (and (and (>=t95_val_{—}4 0.0) t95_def_{—}4)(and (<t96_val_{—}4 0.0) t96_def_{—}4)) (not t98_def_{—}4)) (not t100_def_{—}4)))
(assert (implies (and (and (>=t95_val_{—}4 0.0) t95_def_{—}4) (not t96_def_{—}4))(not t100_def_{—}4)))
(assert (implies (and (and (<t95_val_{—}4 0.0) t95_def_{—}4) t99_def_{—}4)(and t100_def_{—}4 (=t100_val_{—}4 t99_val_{—}4))))
(assert (implies (and (and (<t95_val_{—}4 0.0) t95_def_{—}4) (not t99_def_{—}4))(not t100_def_{—}4)))
(assert (implies (not t95_def_{—}4) (not t100_def_{—}4)))
(declare-fun t101_def_{—}1( ) Bool)
(declare-fun t101_val_{—}1( ) Real)
(assert (implies (not t94_def_{—}1) (not t101_def_{—}1)))
(assert (implies (not t100_def_{—}1) (not t101_def_{—}1)))
(assert (implies (and t94_def_{—}1 t100_def_{—}1) t101_def_{—}1))
(assert (implies (and t101_def_{—}1 (>t94_val_{—}1 t100_val_{—}1)) (=t101_val_{—}1 1.0)))
(assert (implies (and t101_def_{—}1 (<=t94_val_{—}1 t100_val_{—}1)) (=t101_val_{—}1 (−1.0))))
(declare-fun t101_def_{—}2( ) Bool)
(declare-fun t101_val_{—}2( ) Real)
(assert (implies (not t94_def_{—}2) (not t101_def_{—}2)))
(assert (implies (not t100_def_{—}2) (not t101_def_{—}2)))
(assert (implies (and t94_def_{—}2 t100_def_{—}2) t101_def_{—}2))
(assert (implies (and t101_def_{—}2 (>t94_val_{—}2 t100_val_{—}2)) (=t101_val_{—}2 1.0)))
(assert (implies (and t101_def_{—}2 (<=t94_val_{—}2 t100_val_{—}2)) (=t101_val_{—}2 (−1.0))))
(declare-fun t101_def_{—}3( ) Bool)
(declare-fun t101_val_{—}3( ) Real)
(assert (implies (not t94_def_{—}3) (not t101_def_{—}3)))
(assert (implies (not t100_def_{—}3) (not t101_def_{—}3)))
(assert (implies (and t94_def_{—}3 t100_def_{—}3) t101_def_{—}3))
(assert (implies (and t101_def_{—}3 (>t94_val_{—}3 t100_val_{—}3)) (=t101_val_{—}3 1.0)))
(assert (implies (and t101_def_{—}3 (<=t94_val_{—}3 t100_val_{—}3)) (=t101_val_{—}3 (−1.0))))
(declare-fun t101_def_{—}4( ) Bool)
(declare-fun t101_val_{—}4( ) Real)
(assert (implies (not t94_def_{—}4) (not t101_def_{—}4)))
(assert (implies (not t100_def_{—}4) (not t101_def_{—}4)))
(assert (implies (and t94_def_{—}4 t100_def_{—}4) t101_def_{—}4))
(assert (implies (and t101_def_{—}4 (>t94_val_{—}4 t100_val_{—}4)) (=t101_val_{—}4 1.0)))
(assert (implies (and t101_def_{—}4 (<=t94_val_{—}4 t100_val_{—}4)) (=t101_val_{—}4 (−1.0))))
(declare-fun t102_def_{—}1( ) Bool)
(declare-fun t102_val_{—}1( ) Real)
(assert t102_def_{—}1)
(assert (=t102_val_{—}1 2.0))
(declare-fun t102_def_{—}2( ) Bool)
(declare-fun t102_val_{—}2( ) Real)
(assert t102_def_{—}2)
(assert (=t102_val_{—}2 2.0))
(declare-fun t102_def_{—}3( ) Bool)
(declare-fun t102_val_{—}3( ) Real)
(assert t102_def_{—}3)
(assert (=t102_val_{—}3 2.0))
(declare-fun t102_def_{—}4( ) Bool)
(declare-fun t102_val_{—}4( ) Real)
(assert t102_def_{—}4)
(assert (=t102_val_{—}4 2.0))
(declare-fun t103_def_{—}1( ) Bool)
(declare-fun t103_val_{—}1( ) Real)
(assert t103_def_{—}1)
(assert (=t103_val_{—}1 1.0))
(declare-fun t103_def_{—}2( ) Bool)
(declare-fun t103_val_{—}2( ) Real)
(assert t103_def_{—}2)
(assert (=t103_val_{—}2 1.0))
(declare-fun t103_def_{—}3( ) Bool)
(declare-fun t103_val_{—}3( ) Real)
(assert t103_def_{—}3)
(assert (=t103_val_{—}3 1.0))
(declare-fun t103_def_{—}4( ) Bool)
(declare-fun t103_val_{—}4( ) Real)
(assert t103_def_{—}4)
(assert (=t103_val_{—}4 1.0))
(declare-fun t104_def_{—}1( ) Bool)
(declare-fun t104_val_{—}1( ) Real)
(assert t104_def_{—}1)
(assert (=t104_val_{—}1 1.0))
(declare-fun t104_def_{—}2( ) Bool)
(declare-fun t104_val_{—}2( ) Real)
(assert t104_def_{—}2)
(assert (=t104_val_{—}2 1.0))
(declare-fun t104_def_{—}3( ) Bool)
(declare-fun t104_val_{—}3( ) Real)
(assert t104_def_{—}3)
(assert (=t104_val_{—}3 1.0))
(declare-fun t104_def_{—}4( ) Bool)
(declare-fun t104_val_{—}4( ) Real)
(assert t104_def_{—}4)
(assert (=t104_val_{—}4 1.0))
(declare-fun t105_def_{—}1( ) Bool)
(declare-fun t105_val_{—}1( ) Real)
(assert (not t105_def_{—}1))
(declare-fun t105_def_{—}2( ) Bool)
(declare-fun t105_val_{—}2( ) Real)
(assert (not t105_def_{—}2))
(declare-fun t105_def_{—}3( ) Bool)
(declare-fun t105_val_{—}3( ) Real)
(assert (not t105_def_{—}3))
(declare-fun t105_def_{—}4( ) Bool)
(declare-fun t105_val_{—}4( ) Real)
(assert (not t105_def_{—}4))
(declare-fun t106_def_{—}1( ) Bool)
(declare-fun t106_val_{—}1( ) Real)
(declare-fun var7_{—}1( ) Real)
(assert (=var7_{—}1 t106_val_{—}1))
(declare-fun t106_def_{—}2( ) Bool)
(declare-fun t106_val_{—}2( ) Real)
(declare-fun var7_{—}2( ) Real)
(assert (=var7_{—}2 t106_val_{—}2))
(declare-fun t106_def_{—}3( ) Bool)
(declare-fun t106_val_{—}3( ) Real)
(declare-fun var7_{—}3( ) Real)
(assert (=var7_{—}3 t106_val_{—}3))
(declare-fun t106_def_{—}4( ) Bool)
(declare-fun t106_val_{—}4( ) Real)
(declare-fun var7_{—}4) Real)
(assert (=var7_{—}4 t106_val_{—}4))
(assert (implies (and (and t101_def_{—}1 (>=t101_val_{—}1 0.0)) (not t102_def_{—}1))(not t106_def_{—}1)))
(assert (implies (and (and (and (>=t101_val_{—}1 0.0) t101_def_{—}1)(and (>=t102_val_{—}1 0.0) t102_def_{—}1)) t103_def_{—}1) (and t106_def_{—}1 (=t106_val_(*t102_val_t103_val_{—}1)))))
(assert (implies (and (and (and (>=t101_val_{—}1 0.0) t101_def_{—}1)(and (>=t102_val_{—}1 0.0) t102_def_{—}1)) (not t103_def_{—}1)) (not t106_def_{—}1)))
(assert (implies (and (and (and (>=t101_val_{—}1 0.0) t101_def_{—}1)(and (<t102_val_{—}1 0.0) t102_def_{—}1)) t104_def_{—}1) (and t106_def_{—}1 (=t106_val_{—}1 (*t102_val_t104_val_{—}1)))))
(assert (implies (and (and (and (>=t101_val_{—}1 0.0) t101_def_{—}1)(and (<t102_val_{—}1 0.0) t102_def_{—}1)) (not t104_def_{—}1)) (not t106_def_{—}1)))
(assert (implies (and (and (>=t101_val_{—}1 0.0) t101_def_{—}1) (not t102_def_{—}1))(not t106_def_{—}1)))
(assert (implies (and (and (<t101_val_{—}1 0.0) t101_def_{—}1) t105_def_{—}1)(and t106_def_{—}1 (=t106_val_{—}1 t105_val_{—}1))))
(assert (implies (and (and (<t101_val_{—}1 0.0) t101_def_{—}1) (not t105_def_{—}1))(not t106_def_{—}1)))
(assert (implies (not t101_def_{—}1) (not t106_def_{—}1)))
(assert (implies (and (and t101_def_{—}2 (>=t101_val_{—}2 0.0)) (not t102_def_{—}2))(not t106_def_{—}2)))
(assert (implies (and (and (and (>=t101_val_{—}2 0.0) t101_def_{—}2)(and (>=t102_val_{—}2 0.0) t102_def_{—}2)) t103_def_{—}2) (and t106_def_{—}2 (=t106_val_{—}2 (*t102_val_{—}2 t103_val_{—}2)))))
(assert (implies (and (and (and (>=t101_val_{—}2 0.0) t101_def_{—}2)(and (>=t102_val_{—}2 0.0) t102_def_{—}2)) (not t103_def_{—}2)) (not t106_def_{—}2)))
(assert (implies (and (and (and (>=t101_val_{—}2 0.0) t101_def_{—}2)(and (<t102_val_{—}2 0.0) t102_def_{—}2)) t104_def_{—}2) (and t106_def_{—}2 (=t106_val_{—}2 (*t102_val_{—}2 t104_val_{—}2)))))
(assert (implies (and (and (and (>=t101_val_{—}2 0.0) t101_def_{—}2)(and (<t102_val_{—}2 0.0) t102_def_{—}2)) (not t104_def_{—}2)) (not t106_def_{—}2)))
(assert (implies (and (and (>=t101_val_{—}2 0.0) t101_def_{—}2) (not t102_def_{—}2))(not t106_def_{—}2)))
(assert (implies (and (and (<t101_val_{—}2 0.0) t101_def_{—}2) t105_def_{—}2)(and t106_def_{—}2 (=t106_val_{—}2 t105_val_{—}2))))
(assert (implies (and (and (<t101_val_{—}2 0.0) t101_def_{—}2) (not t105_def_{—}2))(not t106_def_{—}2)))
(assert (implies (not t101_def_{—}2) (not t106_def_{—}2)))
(assert (implies (and (and t101_def_{—}3 (>=t101_val_{—}3 0.0)) (not t102_def_{—}3))(not t106_def_{—}3)))
(assert (implies (and (and (and (>=t101_val_{—}3 0.0) t101_def_{—}3)(and (>=t102_val_{—}3 0.0) t102_def_{—}3)) t103_def_{—}3) (and t106_def_{—}3 (=t106_val_{—}3 (*t102_val_{—}3 t103_val_{—}3)))))
(assert (implies (and (and (and (>=t101_val_{—}3 0.0) t101_def_{—}3)(and (>=t102_val_{—}3 0.0) t102_def_{—}3)) (not t103_def_{—}3)) (not t106_def_{—}3)))
(assert (implies (and (and (and (>=t101_val_{—}3 0.0) t101_def_{—}3)(and (<t102_val_{—}3 0.0) t102_def_{—}3)) t104_def_{—}3) (and t106_def_{—}3 (=t106_val_{—}3 (*t102_val_{—}3 t104_val_{—}3)))))
(assert (implies (and (and (and (>=t101_val_{—}3 0.0) t101_def_{—}3)(and (<t102_val_{—}3 0.0) t102_def_{—}3)) (not t104_def_{—}3)) (not t106_def_{—}3)))
(assert (implies (and (and (>=t101_val_{—}3 0.0) t101_def_{—}3) (not t102_def_{—}3))(not t106_def_{—}3)))
(assert (implies (and (and (<t101_val_{—}3 0.0) t101_def_{—}3) t105_def_{—}3)(and t106_def_{—}3 (=t106_val_{—}3 t105_val_{—}3))))
(assert (implies (and (and (<t101_val_{—}3 0.0) t101_def_{—}3) (not t105_def_{—}3))(not t106_def_{—}3)))
(assert (implies (not t101_def_{—}3) (not t106_def_{—}3)))
(assert (implies (and (and t101_def_{—}4 (>=t101_val_{—}4 0.0)) (not t102_def_{—}4))(not t106_def_{—}4)))
(assert (implies (and (and (and (>=t101_val_{—}4 0.0) t101_def_{—}4)(and (>=t102_val_{—}4 0.0) t102_def_{—}4)) t103_def_{—}4) (and t106_def_{—}4 (=t106_val_{—}4 (*t102_val_{—}4 t103_val_{—}4)))))
(assert (implies (and (and (and (>=t101_val_{—}4 0.0) t101_def_{—}4)(and (>=t102_val_{—}4 0.0) t102_def_{—}4)) (not t103_def_{—}4)) (not t106_def_{—}4)))
(assert (implies (and (and (and (>=t101_val_{—}4 0.0) t101_def_{—}4)(and (<t102_val_{—}4 0.0) t102_def_{—}4)) t104_def_{—}4) (and t106_def_{—}4 (=t106_val_{—}4 (*t102_val_{—}4 t104_val_{—}4)))))
(assert (implies (and (and (and (>=t101_val_{—}4 0.0) t101_def_{—}4)(and (<t102_val_{—}4 0.0) t102_def_{—}4)) (not t104_def_{—}4)) (not t106_def_{—}4)))
(assert (implies (and (and (>=t101_val_{—}4 0.0) t101_def_{—}4) (not t102_def_{—}4))(not t106_def_{—}4)))
(assert (implies (and (and (<t101_val_{—}4 0.0) t101_def_{—}4) t105_def_{—}4)(and t106_def_{—}4 (=t106_val_{—}4 t105_val_{—}4))))
(assert (implies (and (and (<t101_val_{—}4 0.0) t101_def_{—}4) (not t105_def_{—}4))(not t106_def_{—}4)))
(assert (implies (not t101_def_{—}4) (not t106_def_{—}4)))
(declare-fun t107_def_{—}1( ) Bool)
(declare-fun t107_val_{—}1( ) Real)
(assert t107_def_{—}1)
(assert (=t107_val_{—}1 1.0))
(declare-fun t107_def_{—}2( ) Bool)
(declare-fun t107_val_{—}2( ) Real)
(assert t107_def_{—}2)
(assert (=t107_val_{—}2 1.0))
(declare-fun t107_def_{—}3( ) Bool)
(declare-fun t107_val_{—}3( ) Real)
(assert t107_def_{—}3)
(assert (=t107_val_{—}3 1.0))
(declare-fun t107_def_{—}4( ) Bool)
(declare-fun t107_val_{—}4) Real)
(assert t107_def_{—}4)
(assert (=t107_val_{—}4 1.0))
(declare-fun t108_def_{—}1_{—}1( ) Bool)
(declare-fun t108_val_{—}1_{—}1( ) Real)
(declare-fun t108_def_{—}2_{—}1( ) Bool)
(declare-fun t108_val_{—}2_{—}1( ) Real)
(declare-fun t108_def_{—}1_{—}2( ) Bool)
(declare-fun t108_val_{—}1_{—}2( ) Real)
(declare-fun t108_def_{—}2_{—}2( ) Bool)
(declare-fun t108_val_{—}2_{—}2( ) Real)
(declare-fun t108_def_{—}1_{—}3( ) Bool)
(declare-fun t108_val_{—}1_{—}3( ) Real)
(declare-fun t108_def_{—}2_{—}3( ) Bool)
(declare-fun t108_val_{—}2_{—}3( ) Real)
(declare-fun t108_def_{—}1_{—}4( ) Bool)
(declare-fun t108_val_{—}1_{—}4) Real)
(declare-fun t108_def_{—}2_{—}4( ) Bool)
(declare-fun t108_val_{—}2_{—}4( ) Real)
(assert (not t108_def_{—}1_{—}1))
(assert (not t108_def_{—}2_{—}1))
(assert (not t108_def_{—}1_{—}2))
(assert (not t108_def_{—}2_{—}2))
(assert t108_def_{—}1_{—}3)
(assert (implies t89_def_{—}1 (=t108_val_{—}1_{—}3 t89_val_{—}1)))
(assert (implies (not t89_def_{—}1) (=t108_val_{—}1_{—}3 0.0)))
(assert t108_def_{—}2_{—}3)
(assert (implies t89_def_{—}2 (=t108_val_{—}2_{—}3 (+t89_val_{—}2 t108_val_{—}1_{—}3))))
(assert (implies (not t89_def_{—}2) (=t108_val_{—}2_{—}3 t108_val_{—}1_{—}3)))
(assert t108_def_{—}1_{—}4)
(assert (implies t89_def_{—}2 (=t108_val_{—}1_{—}4 t89_val_{—}2)))
(assert (implies (not t89_def_{—}2) (=t108_val_{—}1_{—}4 0.0)))
(assert t108_def_{—}2_{—}4)
(assert (implies t89_def_{—}3 (=t108_val_{—}2_{—}4 (+t89_val_{—}3 t108_val_{—}1_{—}4))))
(assert (implies (not t89_def_{—}3) (=t108_val_{—}2_{—}4 t108_val_{—}1_{—}4)))
(declare-fun t108_def_{—}1( ) Bool)
(declare-fun t108_val_{—}1( ) Real)
(assert (=t108_def_{—}2_{—}1 t108_def_{—}1))
(assert (=t108_val_{—}2_{—}1 t108 val_{—}1))
(declare-fun t108_def_{—}2( ) Bool)
(declare-fun t108_val_{—}2( ) Real)
(assert (=t108_def_{—}2_{—}2 t108_def_{—}2))
(assert (=t108_val_{—}2_{—}2 t108_val_{—}2))
(declare-fun t108_def_{—}3( ) Bool)
(declare-fun t108_val_{—}3( ) Real)
(assert (=t108_def_{—}2_{—}3 t108_def_{—}3))
(assert (=t108_val_{—}2_{—}3 t108_val_{—}3))
(declare-fun t108_def_{—}4( ) Bool)
(declare-fun t108_val_{—}4( ) Real)
(assert (=t108_def_{—}2_{—}4 t108_def_{—}4))
(assert (=t108_val_{—}2_{—}4 t108_val_{—}4))
(declare-fun t109_def_{—}1( ) Bool)
(declare-fun t109_val_{—}1( ) Real)
(assert t109_def_{—}1)
(assert (=t109_val_{—}1 1.0))
(declare-fun t109_def_{—}2( ) Bool)
(declare-fun t109_val_{—}2( ) Real)
(assert t109_def_{—}2)
(assert (=t109_val_{—}2 1.0))
(declare-fun t109_def_{—}3( ) Bool)
(declare-fun t109_val_{—}3( ) Real)
(assert t109_def_{—}3)
(assert (=t109_val_{—}3 1.0))
(declare-fun t109_def_{—}4( ) Bool)
(declare-fun t109_val_{—}4( ) Real)
(assert t109_def_{—}4)
(assert (=t109_val_{—}4 1.0))
(declare-fun t110_def_{—}1( ) Bool)
(declare-fun t110_val_{—}1( ) Real)
(assert t110_def_{—}1)
(assert (=t110_val_{—}1 1.0))
(declare-fun t110_def_{—}2( ) Bool)
(declare-fun t110_val_{—}2( ) Real)
(assert t110_def_{—}2)
(assert (=t110_val_{—}2 1.0))
(declare-fun t110_def_{—}3( ) Bool)
(declare-fun t110_val_{—}3( ) Real)
(assert t110_def_{—}3)
(assert (=t110_val_{—}3 1.0))
(declare-fun t110_def_{—}4( ) Bool)
(declare-fun t110_val_{—}4( ) Real)
(assert t110_def_{—}4)
(assert (=t110_val_{—}4 1.0))
(declare-fun t111_def_{—}1( ) Bool)
(declare-fun t111_val_{—}1( ) Real)
(assert t111_def_{—}1)
(assert (=t111_val_{—}1 0.0))
(declare-fun t111_def_{—}2( ) Bool)
(declare-fun t111_val_{—}2( ) Real)
(assert t111_def_{—}2)
(assert (=t111_val_{—}2 0.0))
(declare-fun t111_def_{—}3( ) Bool)
(declare-fun t111_val_{—}3( ) Real)
(assert t111_def_{—}3)
(assert (=t111_val_{—}3 0.0))
(declare-fun t111_def_{—}4( ) Bool)
(declare-fun t111_val_{—}4( ) Real)
(assert t111_def_{—}4)
(assert (=t111_val_{—}4 0.0))
(declare-fun t112_def_{—}1( ) Bool)
(declare-fun t112_val_{—}1( ) Real)
(declare-fun var8_{—}1( ) Real)
(assert (=var8_{—}1 t112_val_{—}1))
(declare-fun t112_def_{—}2( ) Bool)
(declare-fun t112_val_{—}2( ) Real)
(declare-fun var8_{—}2( ) Real)
(assert (=var8_{—}2 t112_val_{—}2))
(declare-fun t112_def_{—}3( ) Bool)
(declare-fun t112_val_{—}3( ) Real)
(declare-fun var8_{—}3( ) Real)
(assert (=var8_{—}3 t112_val_{—}3))
(declare-fun t112_def_{—}4( ) Bool)
(declare-fun t112_val_{—}4( ) Real)
(declare-fun var8_{—}4) Real)
(assert (=var8_{—}4 t112_val_{—}4))
(assert (implies (and (and t107_def_{—}1 (>=t107_val_{—}1 0.0)) (not t108_def_{—}1))(not t112_def_{—}1)))
(assert (implies (and (and (and (>t107_val_{—}1 0.0) t107_def_{—}1)(and (>=t108_val_{—}1 0.0) t108_def_{—}1)) t109_def_{—}1) (and t112_def_{—}1 (=t112_val_{—}1 (*t108_val_t109_val_{—}1)))))
(assert (implies (and (and (and (>=t107_val_{—}1 0.0) t107_def_{—}1)(and (>=t108_val_{—}1 0.0) t108_def_{—}1)) (not t109_def_{—}1)) (not t112_def_{—}1)))
(assert (implies (and (and (and (>=t107_val_{—}1 0.0) t107_def_{—}1)(and (<t108_val_{—}1 0.0) t108_def_{—}1)) t110_def_{—}1) (and t112_def_{—}1 (=t112_val_{—}1 (*t108_val_t110_val_{—}1)))))
(assert (implies (and (and (and (>=t107_val_{—}1 0.0) t107_def_{—}1)(and (<t108_val_{—}1 0.0) t108_def_{—}1)) (not t110_def_{—}1)) (not t112_def_{—}1)))
(assert (implies (and (and (>=t107_val_{—}1 0.0) t107_def_{—}1) (not t108_def_{—}1))(not t112_def_{—}1)))
(assert (implies (and (and (<t107_val_{—}1 0.0) t107_def_{—}1) t111_def_{—}1)(and t112_def_{—}1 (=t112_val_{—}1 t111_val_{—}1))))
(assert (implies (and (and (<t107_val_{—}1 0.0) t107_def_{—}1) (not t111_def_{—}1))(not t112_def_{—}1)))
(assert (implies (not t107_def_{—}1) (not t112_def_{—}1)))
(assert (implies (and (and t107_def_{—}2 (>=t107_val_{—}2 0.0)) (not t108_def_{—}2))(not t112_def_{—}2)))
(assert (implies (and (and (and (>=t107_val_{—}2 0.0) t107_def_{—}2)(and (>=t108_val_{—}2 0.0) t108_def_{—}2)) t109_def_{—}2) (and t112_def_{—}2 (=t112_val_{—}2 (*t108_val_{—}2 t109_val_{—}2)))))
(assert (implies (and (and (and (>=t107_val_{—}2 0.0) t107_def_{—}2)(and (>=t108_val_{—}2 0.0) t108_def_{—}2)) (not t109_def_{—}2)) (not t112_def_{—}2)))
(assert (implies (and (and (and (>=t107_val_{—}2 0.0) t107_def_{—}2)(and (<t108_val_{—}2 0.0) t108_def_{—}2)) t110_def_{—}2) (and t112_def_{—}2 (=t112_val_{—}2 (*t108_val_{—}2 t110_val_{—}2)))))
(assert (implies (and (and (and (>=t107_val_{—}2 0.0) t107_def_{—}2)(and (<t108_val_{—}2 0.0) t108_def_{—}2)) (not t110_def_{—}2)) (not t112_def_{—}2)))
(assert (implies (and (and (>=t107_val_{—}2 0.0) t107_def_{—}2) (not t108_def_{—}2))(not t112_def_{—}2)))
(assert (implies (and (and (<t107_val_{—}2 0.0) t107_def_{—}2) t111_def_{—}2)(and t112_def_{—}2 (=t112_val_{—}2 t111_val_{—}2))))
(assert (implies (and (and (<t107_val_{—}2 0.0) t107_def_{—}2) (not t111_def_{—}2))(not t112_def_{—}2)))
(assert (implies (not t107_def_{—}2) (not t112_def_{—}2)))
(assert (implies (and (and t107_def_{—}3 (>=t107_val_{—}3 0.0)) (not t108_def_{—}3))(not t112_def_{—}3)))
(assert (implies (and (and (and (>=t107_val_{—}3 0.0) t107_def_{—}3)(and (>=t108_val_{—}3 0.0) t108_def_{—}3)) t109_def_{—}3) (and t112_def_{—}3 (=t112_val_{—}3 (*t108_val_{—}3 t109_val_{—}3)))))
(assert (implies (and (and (and (>=t107_val_{—}3 0.0) t107_def_{—}3)(and (>=t108_val_{—}3 0.0) t108_def_{—}3)) (not t109_def_{—}3)) (not t112_def_{—}3)))
(assert (implies (and (and (and (>=t107_val_{—}3 0.0) t107_def_{—}3)(and (<t108_val_{—}3 0.0) t108_def_{—}3)) t110_def_{—}3) (and t112_def_{—}3 (=t112_val_{—}3 (*t108_val_{—}3 t110_val_{—}3)))))
(assert (implies (and (and (and (>=t107_val_{—}3 0.0) t107_def_{—}3)(and (<t108_val_{—}3 0.0) t108_def_{—}3)) (not t110_def_{—}3)) (not t112_def_{—}3)))
(assert (implies (and (and (>=t107_val_{—}3 0.0) t107_def_{—}3) (not t108_def_{—}3))(not t112_def_{—}3)))
(assert (implies (and (and (<t107_val_{—}3 0.0) t107_def_{—}3) t111_def_{—}3)(and t112_def_{—}3 (=t112_val_{—}3 t111_val_{—}3))))
(assert (implies (and (and (<t107_val_{—}3 0.0) t107_def_{—}3) (not t111_def_{—}3))(not t112_def_{—}3)))
(assert (implies (not t107_def_{—}3) (not t112_def_{—}3)))
(assert (implies (and (and t107_def_{—}4 (>=t107_val_{—}4 0.0)) (not t108_def_{—}4))(not t112_def_{—}4)))
(assert (implies (and (and (and (>=t107_val_{—}4 0.0) t107_def_{—}4)(and (>=t108_val_{—}4 0.0) t108_def_{—}4)) t109_def_{—}4) (and t112_def_{—}4 (=t112_val_{—}4 (*t108_val_{—}4 t109_val_{—}4)))))
(assert (implies (and (and (and (>=t107_val_{—}4 0.0) t107_def_{—}4)(and (>=t108_val_{—}4 0.0) t108_def_{—}4)) (not t109_def_{—}4)) (not t112_def_{—}4)))
(assert (implies (and (and (and (>=t107_val_{—}4 0.0) t107_def_{—}4)(and (<t108_val_{—}4 0.0) t108_def_{—}4)) t110_def_{—}4) (and t112_def_{—}4 (=t112_val_{—}4 (*t108_val_{—}4 t110_val_{—}4)))))
(assert (implies (and (and (and (>=t107_val_{—}4 0.0) t107_def_{—}4)(and (<t108_val_{—}4 0.0) t108_def_{—}4)) (not t110_def_{—}4)) (not t112_def_{—}4)))
(assert (implies (and (and (>=t107_val_{—}4 0.0) t107_def_{—}4) (not t108_def_{—}4))(not t112_def_{—}4)))
(assert (implies (and (and (<t107_val_{—}4 0.0) t107_def_{—}4) t111_def_{—}4)(and t112_def_{—}4 (=t112_val_{—}4 t111_val_{—}4))))
(assert (implies (and (and (<t107_val_{—}4 0.0) t107_def_{—}4) (not t111_def_{—}4))(not t112_def_{—}4)))
(assert (implies (not t107_def_{—}4) (not t112_def_{—}4)))
(declare-fun t113_def_{—}1( ) Bool)
(declare-fun t113_val_{—}1( ) Real)
(assert t113_def_{—}1)
(assert (=t113_val_{—}1 1.0))
(declare-fun t113_def_{—}2( ) Bool)
(declare-fun t113_val_{—}2( ) Real)
(assert t113_def_{—}2)
(assert (=t113_val_{—}2 1.0))
(declare-fun t113_def_{—}3( ) Bool)
(declare-fun t113_val_{—}3( ) Real)
(assert t113_def_{—}3)
(assert (=t113_val_{—}3 1.0))
(declare-fun t113_def_{—}4( ) Bool)
(declare-fun t113_val_{—}4( ) Real)
(assert t113_def_{—}4)
(assert (=t113_val_{—}4 1.0))
(declare-fun t114_def_{—}1_{—}1( ) Bool)
(declare-fun t114_val_{—}1_{—}1( ) Real)
(declare-fun t114_def_{—}2_{—}1( ) Bool)
(declare-fun t114_val_{—}2_{—}1( ) Real)
(declare-fun t114_def_{—}3_{—}1( ) Bool)
(declare-fun t114_val_{—}3_{—}1( ) Real)
(declare-fun t114_def_{—}1_{—}2( ) Bool)
(declare-fun t114_val_{—}1_{—}2( ) Real)
(declare-fun t114_def_{—}2_{—}2( ) Bool)
(declare-fun t114_val_{—}2_{—}2( ) Real)
(declare-fun t114_def_{—}3_{—}2( ) Bool)
(declare-fun t114_val_{—}3_{—}2( ) Real)
(declare-fun t114_def_{—}1_{—}3( ) Bool)
(declare-fun t114_val_{—}1_{—}3( ) Real)
(declare-fun t114_def_{—}2_{—}3( ) Bool)
(declare-fun t114_val_{—}2_{—}3( ) Real)
(declare-fun t114_def_{—}3_{—}3( ) Bool)
(declare-fun t114_val_{—}3_{—}3( ) Real)
(declare-fun t114_def_{—}1_{—}4( ) Bool)
(declare-fun t114_val_{—}1_{—}4( ) Real)
(declare-fun t114_def_{—}2_{—}4( ) Bool)
(declare-fun t114_val_{—}2_{—}4( ) Real)
(declare-fun t114_def_{—}3_{—}4( ) Bool)
(declare-fun t114_val_{—}3_{—}4( ) Real)
(assert (not t114_def_{—}1_{—}1))
(assert (not t114_def_{—}2_{—}1))
(assert (not t114_def_{—}3_{—}1))
(assert (not t114_def_{—}1_{—}2))
(assert (not t114_def_{—}2_{—}2))
(assert (not t114_def_{—}3_{—}2))
(assert (not t114_def_{—}1_{—}3))
(assert (not t114_def_{—}2_{—}3))
(assert (not t114_def_{—}3_{—}3))
(assert t114_def_{—}1_{—}4)
(assert (implies t89_def_{—}1 (=t114_val_{—}1_{—}4 t89_val 1)))
(assert (implies (not t89_def_{—}1) (=t114_val_{—}1_{—}4 0.0)))
(assert t114_def_{—}2_{—}4)
(assert (implies t89_def_{—}2 (=t114_val_{—}2_{—}4 (+t89_val_{—}2 t114_val_{—}1_{—}4))))
(assert (implies (not t89_def_{—}2) (=t114_val_{—}2_{—}4 t114_val_{—}1_{—}4)))
(assert t114_def_{—}3_{—}4)
(assert (implies t89_def_{—}3 (=t114_val_{—}3_{—}4 (+t89_val_{—}3 t114_val_{—}2_{—}4))))
(assert (implies (not t89_def_{—}3) (=t114_val_{—}3_{—}4 t114_val_{—}2_{—}4)))
(declare-fun t114_def_{—}1( ) Bool)
(declare-fun t114_val_{—}1( ) Real)
(assert (=t114_def_{—}3_{—}1 t114_def_{—}1))
(assert (=t114_val_{—}3_{—}1 t114_val_{—}1))
(declare-fun t114_def_{—}2( ) Bool)
(declare-fun t114_val_{—}2( ) Real)
(assert (=t114_def_{—}3_{—}2 t114_def_{—}2))
(assert (=t114_val_{—}3_{—}2 t114_val_{—}2))
(declare-fun t114_def_{—}3( ) Bool)
(declare-fun t114_val_{—}3( ) Real)
(assert (=t114_def_{—}3_{—}3 t114_def_{—}3))
(assert (=t114_val_{—}3_{—}3 t114_val_{—}3))
(declare-fun t114_def_{—}4( ) Bool)
(declare-fun t114_val_{—}4( ) Real)
(assert (=t114_def_{—}3_{—}4 t114_def_{—}4))
(assert (=t114_val_{—}3_{—}4 t114_val_{—}4))
(declare-fun t115_def_{—}1( ) Bool)
(declare-fun t115_val_{—}1( ) Real)
(assert t115_def_{—}1)
(assert (=t115_val_{—}1 1.0))
(declare-fun t115_def_{—}2( ) Bool)
(declare-fun t115_val_{—}2( ) Real)
(assert t115_def_{—}2)
(assert (=t115_val_{—}2 1.0))
(declare-fun t115_def_{—}3( ) Bool)
(declare-fun t115_val_{—}3( ) Real)
(assert t115_def_{—}3)
(assert (=t115_val_{—}3 1.0))
(declare-fun t115_def_{—}4( ) Bool)
(declare-fun t115_val_{—}4( ) Real)
(assert t115_def_{—}4)
(assert (=t115_val_{—}4 1.0))
(declare-fun t116_def_{—}1( ) Bool)
(declare-fun t116_val_{—}1( ) Real)
(assert t116_def_{—}1)
(assert (=t116_val_{—}1 1.0))
(declare-fun t116_def_{—}2( ) Bool)
(declare-fun t116_val_{—}2( ) Real)
(assert t116_def_{—}2)
(assert (=t116_val_{—}2 1.0))
(declare-fun t116_def_{—}3( ) Bool)
(declare-fun t116_val_{—}3( ) Real)
(assert t116_def_{—}3)
(assert (=t116_val_{—}3 1.0))
(declare-fun t116_def_{—}4( ) Bool)
(declare-fun t116_val_{—}4( ) Real)
(assert t116_def_{—}4)
(assert (=t116_val_{—}4 1.0))
(declare-fun t117_def_{—}1( ) Bool)
(declare-fun t117_val_{—}1( ) Real)
(assert t117_def_{—}1)
(assert (=t117_val_{—}1 0.0))
(declare-fun t117_def_{—}2( ) Bool)
(declare-fun t117_val_{—}2( ) Real)
(assert t117_def_{—}2)
(assert (=t117_val_{—}2 0.0))
(declare-fun t117_def_{—}3( ) Bool)
(declare-fun t117_val_{—}3( ) Real)
(assert t117_def_{—}3)
(assert (=t117_val_{—}3 0.0))
(declare-fun t117_def_{—}4( ) Bool)
(declare-fun t117_val_{—}4( ) Real)
(assert t117_def_{—}4)
(assert (=t117_val_{—}4 0.0))
(declare-fun t118_def_{—}1( ) Bool)
(declare-fun t118_val_{—}1( ) Real)
(declare-fun var9_{—}1( ) Real)
(assert (=var9_{—}1 t118_val_{—}1))
(declare-fun t118_def_{—}2( ) Bool)
(declare-fun t118_val_{—}2( ) Real)
(declare-fun var9_{—}2( ) Real)
(assert (=var9_{—}2 t118_val_{—}2))
(declare-fun t118_def_{—}3( ) Bool)
(declare-fun t118_val_{—}3( ) Real)
(declare-fun var9_{—}3( ) Real)
(assert (=var9_{—}3 t118_val_{—}3))
(declare-fun t118_def_{—}4( ) Bool)
(declare-fun t118_val_{—}4( ) Real)
(declare-fun var9_{—}4) Real)
(assert (=var9_{—}4 t118_val_{—}4))
(assert (implies (and (and t113_def_{—}1 (>=t113_val_{—}1 0.0)) (not t114_def_{—}1))(not t118 def_{—}1)))
(assert (implies (and (and (and (>=t113_val_{—}1 0.0) t113_def_{—}1)(and (>=t114_val_{—}1 0.0) t114_def_{—}1)) t115_def_{—}1) (and t118_def_{—}1 (=t118_val_{—}1 (*t114_val_{—}1 t115_val_{—}1)))))
(assert (implies (and (and (and (>=t113_val_{—}1 0.0) t113_def_{—}1)(and (>=t114_val_{—}1 0.0) t114_def_{—}1)) (not t115_def_{—}1)) (not t118_def_{—}1)))
(assert (implies (and (and (and (>=t113_val_{—}1 0.0) t113_def_{—}1)(and (<t114_val_{—}1 0.0) t114_def_{—}1)) t116_def_{—}1) (and t118 def_{—}1 (=t118_val_{—}1 (*t114_val_{—}1 t116_val_{—}1)))))
(assert (implies (and (and (and (>=t113_val_{—}1 0.0) t113_def_{—}1)(and (<t114_val_{—}1 0.0) t114_def_{—}1)) (not t116_def_{—}1)) (not t118_def_{—}1)))
(assert (implies (and (and (>=t113_val_{—}1 0.0) t113_def_{—}1) (not t114_def_{—}1))(not t118_def_{—}1)))
(assert (implies (and (and (<t113_val_{—}1 0.0) t113_def_{—}1) t117_def_{—}1)(and t118_def_{—}1 (=t118_val_{—}1 t117_val_{—}1))))
(assert (implies (and (and (<t113_val_{—}1 0.0) t113_def_{—}1) (not t117_def_{—}1))(not t118_def_{—}1)))
(assert (implies (not t113_def_{—}1) (not t118_def_{—}1)))
(assert (implies (and (and t113_def_{—}2 (>=t113_val_{—}2 0.0)) (not t114_def_{—}2))(not t118_def_{—}2)))
(assert (implies (and (and (and (>=t113_val_{—}2 0.0) t113_def_{—}2)(and (>=t114_val_{—}2 0.0) t114_def_{—}2)) t115_def_{—}2) (and t118_def_{—}2 (=t118_val_{—}2 (*t114_val_{—}2 t115_val_{—}2)))))
(assert (implies (and (and (and (>=t113_val_{—}2 0.0) t113_def_{—}2)(and (>=t114_val_{—}2 0.0) t114_def_{—}2)) (not t115_def_{—}2)) (not t118_def_{—}2)))
(assert (implies (and (and (and (>=t113_val_{—}2 0.0) t113_def_{—}2)(and (<t114_val_{—}2 0.0) t114_def_{—}2)) t116_def_{—}2) (and t118_def_{—}2 (=t118_val_{—}2 (*t114_val_{—}2 t116_val_{—}2)))))
(assert (implies (and (and (and (>=t113_val_{—}2 0.0) t113_def_{—}2)(and (<t114_val_{—}2 0.0) t114_def_{—}2)) (not t116_def_{—}2)) (not t118_def_{—}2)))
(assert (implies (and (and (>=t113_val_{—}2 0.0) t113_def_{—}2) (not t114_def_{—}2))(not t118_def_{—}2)))
(assert (implies (and (and (<t113_val_{—}2 0.0) t113_def_{—}2) t117_def_{—}2)(and t118_def_{—}2 (=t118_val_{—}2 t117_val_{—}2))))
(assert (implies (and (and (<t113_val_{—}2 0.0) t113_def_{—}2) (not t117_def_{—}2))(not t118_def_{—}2)))
(assert (implies (not t113_def_{—}2) (not t118_def_{—}2)))
(assert (implies (and (and t113_def_{—}3 (>=t113_val_{—}3 0.0)) (not t114_def_{—}3))(not t118_def_{—}3)))
(assert (implies (and (and (and (>=t113_val_{—}30.0) t113_def_{—}3)(and (>=t114_val_{—}3 0.0) t114_def_{—}3)) t115_def_{—}3) (and t118_def_{—}3 (=t118_val_{—}3 (*t114_val_{—}3 t115_val_{—}3)))))
(assert (implies (and (and (and (>=t113_val_{—}3 0.0) t113_def_{—}3)(and (>=t114_val_{—}3 0.0) t114_def_{—}3)) (not t115_def_{—}3)) (not t118_def_{—}3)))
(assert (implies (and (and (and (>t113_val_{—}3 0.0) t113_def_{—}3)(and (<t114_val_{—}3 0.0) t114_def_{—}3)) t116_def_{—}3) (and t118_def_{—}3 (=t118_val_{—}3 (*t114_val_{—}3 t116_val_{—}3)))))
(assert (implies (and (and (and (>=t113_val_{—}3 0.0) t113_def_{—}3)(and (<t114_val_{—}3 0.0) t114_def_{—}3)) (not t116_def_{—}3)) (not t118_def_{—}3)))
(assert (implies (and (and (>=t113_val_{—}3 0.0) t113_def_{—}3) (not t114_def_{—}3))(not t118_def_{—}3)))
(assert (implies (and (and (<t113_val_{—}3 0.0) t113_def_{—}3) t117_def_{—}3)(and t118_def_{—}3 (=t118_val_{—}3 t117_val_{—}3))))
(assert (implies (and (and (<t113_val_{—}3 0.0) t113_def_{—}3) (not t117_def_{—}3))(not t118_def_{—}3)))
(assert (implies (not t113_def_{—}3) (not t118_def_{—}3)))
(assert (implies (and (and t113_def_{—}4 (>=t113_val_{—}4 0.0)) (not t114_def_{—}4))(not t118_def_{—}4)))
(assert (implies (and (and (and (>=t113_val_{—}4 0.0) t113_def_{—}4)(and (>=t114_val_{—}4 0.0) t114_def_{—}4)) t115_def_{—}4) (and t118_def_{—}4 (=t118_val_{—}4 (*t114_val_{—}4 t115_val_{—}4)))))
(assert (implies (and (and (and (>=t113_val_{—}4 0.0) t113_def_{—}4)(and (>=t114_val_{—}4 0.0) t114_def_{—}4)) (not t115_def_{—}4)) (not t118_def_{—}4)))
(assert (implies (and (and (and (>=t113_val_{—}4 0.0) t113_def_{—}4)(and (<t114_val_{—}4 0.0) t114_def_{—}4)) t116_def_{—}4) (and t118_def_{—}4 (=t118_val_{—}4 (*t114_val_{—}4 t116_val_{—}4)))))
(assert (implies (and (and (and (>=t113_val_{—}4 0.0) t113_def_{—}4)(and (<t114_val_{—}4 0.0) t114_def_{—}4)) (not t116_def_{—}4)) (not t118_def_{—}4)))
(assert (implies (and (and (>=t113_val_{—}4 0.0) t113_def_{—}4) (not t114_def_{—}4))(not t118_def_{—}4)))
(assert (implies (and (and (<t113_val_{—}4 0.0) t113_def_{—}4) t117_def_{—}4)(and t118_def_{—}4 (=t118_val_{—}4 t117_val_{—}4))))
(assert (implies (and (and (<t113_val_{—}4 0.0) t113_def_{—}4) (not t117_def_{—}4))(not t118_def_{—}4)))
(assert (implies (not t113_def_{—}4) (not t118_def_{—}4)))
(declare-fun t119_def_{—}1( ) Bool)
(declare-fun t119_val_{—}1( ) Real)
(assert t119_def_{—}1)
(assert (=t119_val_{—}1 1.0))
(declare-fun t119_def_{—}2( ) Bool)
(declare-fun t119_val_{—}2( ) Real)
(assert t119_def_{—}2)
(assert (=t119_val_{—}2 1.0))
(declare-fun t119_def_{—}3( ) Bool)
(declare-fun t119_val_{—}3( ) Real)
(assert t119_def_{—}3)
(assert (=t119_val_{—}3 1.0))
(declare-fun t119_def_{—}4( ) Bool)
(declare-fun t119_val_{—}4( ) Real)
(assert t119_def_{—}4)
(assert (=t119_val_{—}4 1.0))
(declare-fun t120_def_{—}1( ) Bool)
(declare-fun t120_val_{—}1( ) Real)
(declare-fun t120_def_{—}2( ) Bool)
(declare-fun t120_val_{—}2( ) Real)
(declare-fun t120_def_{—}3( ) Bool)
(declare-fun t120_val_{—}3( ) Real)
(declare-fun t120_def_{—}4( ) Bool)
(declare-fun t120_val_{—}4) Real)
(assert (not t120_def_{—}1))
(assert (not t120_def_{—}2))
(assert (not t120_def_{—}3))
(assert (implies t89_def_{—}1 (and t120_def_{—}4 (=t89_val_{—}1 t120_val_{—}4))))
(assert (implies (not t89_def_{—}1) (not t120_def_{—}4)))
(declare-fun t121_def_{—}1( ) Bool)
(declare-fun t121_val_{—}1( ) Real)
(assert t121_def_{—}1)
(assert (=t121_val_{—}1 1.0))
(declare-fun t121_def_{—}2( ) Bool)
(declare-fun t121_val_{—}2( ) Real)
(assert t121_def_{—}2)
(assert (=t121_val_{—}2 1.0))
(declare-fun t121_def_{—}3( ) Bool)
(declare-fun t121_val_{—}3( ) Real)
(assert t121_def_{—}3)
(assert (=t121_val_{—}3 1.0))
(declare-fun t121_def_{—}4( ) Bool)
(declare-fun t121_val_{—}4( ) Real)
(assert t121_def_{—}4)
(assert (=t121_val_{—}4 1.0))
(declare-fun t122_def_{—}1( ) Bool)
(declare-fun t122_val_{—}1( ) Real)
(assert t122_def_{—}1)
(assert (=t122_val_{—}1 1.0))
(declare-fun t122_def_{—}2( ) Bool)
(declare-fun t122_val_{—}2( ) Real)
(assert t122_def_{—}2)
(assert (=t122_val_{—}2 1.0))
(declare-fun t122_def_{—}3( ) Bool)
(declare-fun t122_val_{—}3( ) Real)
(assert t122_def_{—}3)
(assert (=t122_val_{—}3 1.0))
(declare-fun t122_def_{—}4( ) Bool)
(declare-fun t122_val_{—}4( ) Real)
(assert t122_def_{—}4)
(assert (=t122_val_{—}4 1.0))
(declare-fun t123_def_{—}1( ) Bool)
(declare-fun t123_val_{—}1( ) Real)
(assert t123_def_{—}1)
(assert (=t123_val_{—}1 0.0))
(declare-fun t123_def_{—}2( ) Bool)
(declare-fun t123_val_{—}2( ) Real)
(assert t123_def_{—}2)
(assert (=t123_val_{—}2 0.0))
(declare-fun t123_def_{—}3( ) Bool)
(declare-fun t123_val_{—}3( ) Real)
(assert t123_def_{—}3)
(assert (=t123_val_{—}3 0.0))
(declare-fun t123_def_{—}4( ) Bool)
(declare-fun t123_val_{—}4( ) Real)
(assert t123_def_{—}4)
(assert (=t123_val_{—}4 0.0))
(declare-fun t124_def_{—}1( ) Bool)
(declare-fun t124_val_{—}1( ) Real)
(declare-fun var10_{—}1( ) Real)
(assert (=var10_t124_val_{—}1))
(declare-fun t124_def_{—}2( ) Bool)
(declare-fun t124_val_{—}2( ) Real)
(declare-fun var10_{—}2( ) Real)
(assert (=var10_{—}2 t124_val_{—}2))
(declare-fun t124_def_{—}3( ) Bool)
(declare-fun t124_val_{—}3( ) Real)
(declare-fun var10_{—}3( ) Real)
(assert (=var10_{—}3 t124_val_{—}3))
(declare-fun t124_def_{—}4( ) Bool)
(declare-fun t124_val_{—}4( ) Real)
(declare-fun var10_{—}4( ) Real)
(assert (=var10_{—}4 t124_val_{—}4))
(assert (implies (and (and t119_def_{—}1 (>=t119_val_{—}1 0.0)) (not t120_def_{—}1))(not t124_def_{—}1)))
(assert (implies (and (and (and (>=t119_val_{—}1 0.0) t119_def_{—}1)(and (>=t120_val_{—}1 0.0) t120_def_{—}1)) t121_def_{—}1) (and t124_def_{—}1 (=t124_val_{—}1 (*t120_val_{—}1 t121_val_{—}1)))))
(assert (implies (and (and (and (>=t119_val_{—}1 0.0) t119_def_{—}1)(and (>=t120_val_{—}1 0.0) t120_def_{—}1)) (not t121_def_{—}1)) (not t124_def_{—}1)))
(assert (implies (and (and (and (>=t119_val_{—}1 0.0) t119_def_{—}1)(and (<t120_val_{—}1 0.0) t120_def_{—}1)) t122_def_{—}1) (and t124_def_{—}1 (=t124_val_{—}1 (*t120_val_{—}1 t122_val_{—}1)))))
(assert (implies (and (and (and (>=t119_val_{—}1 0.0) t119_def_{—}1)(and (<t120_val_{—}1 0.0) t120_def_{—}1)) (not t122_def_{—}1)) (not t124_def_{—}1)))
(assert (implies (and (and (>=t119_val_{—}1 0.0) t119_def_{—}1) (not t120_def_{—}1))(not t124_def_{—}1)))
(assert (implies (and (and (<t119_val_{—}1 0.0) t119_def_{—}1) t123_def_{—}1)(and t124_def_{—}1 (=t124_val_{—}1 t123_val_{—}1))))
(assert (implies (and (and (<t119_val_{—}1 0.0) t119_def_{—}1) (not t123_def_{—}1))(not t124_def_{—}1)))
(assert (implies (not t119_def_{—}1) (not t124_def_{—}1)))
(assert (implies (and (and t119_def_{—}2 (>=t119_val_{—}2 0.0)) (not t120_def_{—}2))(not t124_def_{—}2)))
(assert (implies (and (and (and (>=t119_val_{—}2 0.0) t119_def_{—}2)(and (>=t120_val_{—}2 0.0) t120_def_{—}2)) t121_def_{—}2) (and t124_def_{—}2 (=t124_val_{—}2 (*t120_val_{—}2 t121_val_{—}2)))))
(assert (implies (and (and (and (>=t119_val 2 0.0) t119_def_{—}2)(and (>=t120_val_{—}2 0.0) t120_def_{—}2)) (not t121_def_{—}2)) (not t124_def_{—}2)))
(assert (implies (and (and (and (>=t119_val_{—}2 0.0) t119_def_{—}2)(and (<t120_val_{—}2 0.0) t120_def_{—}2)) t122_def_{—}2) (and t124_def_{—}2 (=t124_val_{—}2 (*t120_val_{—}2 t122_val_{—}2)))))
(assert (implies (and (and (and (>=t119_val_{—}2 0.0) t119_def_{—}2)(and (<t120_val_{—}2 0.0) t120_def_{—}2)) (not t122_def_{—}2)) (not t124_def_{—}2)))
(assert (implies (and (and (>=t119_val_{—}2 0.0) t119_def_{—}2) (not t120_def_{—}2))(not t124_def_{—}2)))
(assert (implies (and (and (<t119_val_{—}2 0.0) t119_def_{—}2) t123_def_{—}2)(and t124_def_{—}2 (=t124_val_{—}2 t123_val_{—}2))))
(assert (implies (and (and (<t119_val_{—}2 0.0) t119_def_{—}2) (not t123_def_{—}2))(not t124_def_{—}2)))
(assert (implies (not t119_def_{—}2) (not t124_def_{—}2)))
(assert (implies (and (and t119_def_{—}3 (>=t119_val_{—}3 0.0)) (not t120_def_{—}3))(not t124_def_{—}3)))
(assert (implies (and (and (and (>=t119_val_{—}3 0.0) t119_def_{—}3)(and (>=t120_val_{—}3 0.0) t120_def_{—}3)) t121_def_{—}3) (and t124_def_{—}3 (=t124_val_{—}3 (*t120_val_{—}3 t121_val_{—}3)))))
(assert (implies (and (and (and (>=t119_val 3 0.0) t119_def_{—}3)(and (>=t120_val_{—}3 0.0) t120_def_{—}3)) (not t121_def_{—}3)) (not t124_def_{—}3)))
(assert (implies (and (and (and (>=t119_val_{—}3 0.0) t119_def_{—}3)(and (<t120_val_{—}3 0.0) t120_def_{—}3)) t122_def_{—}3) (and t124_def_{—}3 (=t124_val_{—}3 (*t120_val_{—}3 t122_val_{—}3)))))
(assert (implies (and (and (and (>=t119_val_{—}3 0.0) t119_def_{—}3)(and (<t120_val_{—}3 0.0) t120_def_{—}3)) (not t122_def_{—}3)) (not t124_def_{—}3)))
(assert (implies (and (and (>=t119_val_{—}3 0.0) t119_def_{—}3) (not t120_def_{—}3))(not t124_def_{—}3)))
(assert (implies (and (and (<t119_val_{—}3 0.0) t119_def_{—}3) t123_def_{—}3)(and t124_def_{—}3 (=t124_val_{—}3 t123_val_{—}3))))
(assert (implies (and (and (<t119 val 3 0.0) t119_def_{—}3) (not t123_def_{—}3))(not t124_def_{—}3)))
(assert (implies (not t119_def_{—}3) (not t124_def_{—}3)))
(assert (implies (and (and t119_def_{—}4 (>=t119_val_{—}4 0.0)) (not t120_def_{—}4))(not t124_def_{—}4)))
(assert (implies (and (and (and (>=t119_val_{—}4 0.0) t119_def_{—}4)(and (>=t120_val_{—}4 0.0) t120_def_{—}4)) t121_def_{—}4) (and t124_def_{—}4 (=t124_val_{—}4 (*t120_val_{—}4 t121_val_{—}4)))))
(assert (implies (and (and (and (>=t119_val_{—}4 0.0) t119_def_{—}4)(and (>=t120_val_{—}4 0.0) t120_def_{—}4)) (not t121_def_{—}4)) (not t124_def_{—}4)))
(assert (implies (and (and (and (>=t119_val_{—}4 0.0) t119_def_{—}4)(and (<t120_val_{—}4 0.0) t120_def_{—}4)) t122_def_{—}4) (and t124_def_{—}4 (=t124_val_{—}4 (*t120_val_{—}4 t122_val_{—}4)))))
(assert (implies (and (and (and (>=t119_val_{—}4 0.0) t119_def_{—}4)(and (<t120_val_{—}4 0.0) t120_def_{—}4)) (not t122_def_{—}4)) (not t124_def_{—}4)))
(assert (implies (and (and (>=t119_val_{—}4 0.0) t119_def_{—}4) (not t120_def_{—}4))(not t124_def_{—}4)))
(assert (implies (and (and (<t119_val_{—}4 0.0) t119_def_{—}4) t123_def_{—}4)(and t124_def_{—}4 (=t124_val_{—}4 t123_val_{—}4))))
(assert (implies (and (and (<t119_val_{—}4 0.0) t119_def_{—}4) (not t123_def_{—}4))(not t124_def_{—}4)))
(assert (implies (not t119_def_{—}4) (not t124_def_{—}4)))
(declare-fun t125_def_{—}1( ) Bool)
(declare-fun t125_val_{—}1( ) Real)
(assert (implies (not t124_def_{—}1) (not t125_def_{—}1)))
(assert (implies (not t112_def_{—}1) (not t125_def_{—}1)))
(assert (implies (and t124_def_{—}1 t112_def_{—}1) t125_def_{—}1))
(assert (implies t125_def_{—}1 (=(+t124_val_{—}1 t112_val_{—}1) t125_val_{—}1)))
(declare-fun t125_def_{—}2( ) Bool)
(declare-fun t125_val_{—}2( ) Real)
(assert (implies (not t124_def_{—}2) (not t125_def_{—}2)))
(assert (implies (not t112_def_{—}2) (not t125_def_{—}2)))
(assert (implies (and t124_def_{—}2 t112_def_{—}2) t125_def_{—}2))
(assert (implies t125_def_{—}2 (=(+t124_val_{—}2 t112_val_{—}2) t125_val_{—}2)))
(declare-fun t125_def_{—}3( ) Bool)
(declare-fun t125_val_{—}3( ) Real)
(assert (implies (not t124_def_{—}3) (not t125_def_{—}3)))
(assert (implies (not t112_def_{—}3) (not t125_def_{—}3)))
(assert (implies (and t124_def_{—}3 t112_def_{—}3) t125_def_{—}3))
(assert (implies t125_def_{—}3 (=(+t124_val_{—}3 t112_val_{—}3) t125_val_{—}3)))
(declare-fun t125_def_{—}4( ) Bool)
(declare-fun t125_val_{—}4( ) Real)
(assert (implies (not t124_def_{—}4) (not t125_def_{—}4)))
(assert (implies (not t112_def_{—}4) (not t125_def_{—}4)))
(assert (implies (and t124_def_{—}4 t112_def_{—}4) t125_def_{—}4))
(assert (implies t125_def_{—}4 (=(+t124_val_{—}4 t112_val_{—}4) t125_val_{—}4)))
(declare-fun t126_def_{—}1( ) Bool)
(declare-fun t126_val_{—}1( ) Real)
(assert (implies (not t118_def_{—}1) (not t126_def_{—}1)))
(assert (implies (not t125_def_{—}1) (not t126_def_{—}1)))
(assert (implies (and t118_def_{—}1 t125_def_{—}1) t126_def_{—}1))
(assert (implies (and t126_def_{—}1 (>t118_val_{—}1 t125_val_{—}1)) (=t126_val_{—}1 1.0)))
(assert (implies (and t126_def_{—}1 (<=t118_val_{—}1 t125_val_{—}1)) (=t126_val_{—}1 (−1.0))))
(declare-fun t126_def_{—}2( ) Bool)
(declare-fun t126_val_{—}2( ) Real)
(assert (implies (not t118_def_{—}2) (not t126_def_{—}2)))
(assert (implies (not t125_def_{—}2) (not t126_def_{—}2)))
(assert (implies (and t118_def_{—}2 t125_def_{—}2) t126_def_{—}2))
(assert (implies (and t126_def_{—}2 (>t118_val_{—}2 t125_val_{—}2)) (=t126_val_{—}2 1.0)))
(assert (implies (and t126_def_{—}2 (<=t118_val_{—}2 t125_val_{—}2)) (=t126_val_{—}2 (−1.0))))
(declare-fun t126_def_{—}3( ) Bool)
(declare-fun t126_val_{—}3( ) Real)
(assert (implies (not t118_def_{—}3) (not t126_def_{—}3)))
(assert (implies (not t125_def_{—}3) (not t126_def_{—}3)))
(assert (implies (and t118_def_{—}3 t125_def_{—}3) t126_def_{—}3))
(assert (implies (and t126_def_{—}3 (>t118_val_{—}3 t125_val_{—}3)) (=t126_val_{—}3 1.0)))
(assert (implies (and t126_def_{—}3 (<=t118_val_{—}3 t125_val_{—}3)) (=t126_val_{—}3 (−1.0))))
(declare-fun t126_def_{—}4( ) Bool)
(declare-fun t126_val_{—}4( ) Real)
(assert (implies (not t118_def_{—}4) (not t126_def_{—}4)))
(assert (implies (not t125_def_{—}4) (not t126_def_{—}4)))
(assert (implies (and t118_def_{—}4 t125_def_{—}4) t126_def_{—}4))
(assert (implies (and t126_def_{—}4 (>t118_val_{—}4 t125_val_{—}4)) (=t126_val_{—}4 1.0)))
(assert (implies (and t126_def_{—}4 (<=t118_val_{—}4 t125_val_{—}4)) (=t126_val_{—}4 (−1.0))))
(declare-fun t127_def_{—}1( ) Bool)
(declare-fun t127_val_{—}1( ) Real)
(assert t127_def_{—}1)
(assert (=t127_val_{—}1 2.0))
(declare-fun t127_def_{—}2( ) Bool)
(declare-fun t127_val_{—}2( ) Real)
(assert t127_def_{—}2)
(assert (=t127_val_{—}2 2.0))
(declare-fun t127_def_{—}3( ) Bool)
(declare-fun t127_val_{—}3( ) Real)
(assert t127_def_{—}3)
(assert (=t127_val_{—}3 2.0))
(declare-fun t127_def_{—}4( ) Bool)
(declare-fun t127_val_{—}4( ) Real)
(assert t127_def_{—}4)
(assert (=t127_val_{—}4 2.0))
(declare-fun t128_def_{—}1( ) Bool)
(declare-fun t128_val_{—}1( ) Real)
(assert t128_def_{—}1)
(assert (=t128_val_{—}1 1.0))
(declare-fun t128_def_{—}2( ) Bool)
(declare-fun t128_val_{—}2( ) Real)
(assert t128_def_{—}2)
(assert (=t128_val_{—}2 1.0))
(declare-fun t128_def_{—}3( ) Bool)
(declare-fun t128_val_{—}3( ) Real)
(assert t128_def_{—}3)
(assert (=t128_val_{—}3 1.0))
(declare-fun t128_def_{—}4( ) Bool)
(declare-fun t128_val_{—}4( ) Real)
(assert t128_def_{—}4)
(assert (=t128_val_{—}4 1.0))
(declare-fun t129_def_{—}1( ) Bool)
(declare-fun t129_val_{—}1( ) Real)
(assert t129_def_{—}1)
(assert (=t129_val_{—}1 1.0))
(declare-fun t129_def_{—}2( ) Bool)
(declare-fun t129_val_{—}2( ) Real)
(assert t129_def_{—}2)
(assert (=t129_val_{—}2 1.0))
(declare-fun t129_def_{—}3( ) Bool)
(declare-fun t129_val_{—}3( ) Real)
(assert t129_def_{—}3)
(assert (=t129_val_{—}3 1.0))
(declare-fun t129_def_{—}4( ) Bool)
(declare-fun t129_val_{—}4( ) Real)
(assert t129_def_{—}4)
(assert (=t129_val_{—}4 1.0))
(declare-fun t130_def_{—}1( ) Bool)
(declare-fun t130_val_{—}1( ) Real)
(assert (not t130_def_{—}1))
(declare-fun t130_def_{—}2( ) Bool)
(declare-fun t130_val_{—}2( ) Real)
(assert (not t130_def_{—}2))
(declare-fun t130_def_{—}3( ) Bool)
(declare-fun t130_val_{—}3( ) Real)
(assert (not t130_def_{—}3))
(declare-fun t130_def_{—}4( ) Bool)
(declare-fun t130_val_{—}4( ) Real)
(assert (not t130_def_{—}4))
(declare-fun t131_def_{—}1( ) Bool)
(declare-fun t131_val_{—}1( ) Real)
(declare-fun var11_{—}1( ) Real)
(assert (=var11_{—}1 t131_val_{—}1))
(declare-fun t131_def_{—}2( ) Bool)
(declare-fun t131_val_{—}2( ) Real)
(declare-fun var11_{—}2( ) Real)
(assert (=var11_{—}2 t131_val_{—}2))
(declare-fun t131_def_{—}3( ) Bool)
(declare-fun t131_val_{—}3( ) Real)
(declare-fun var11_{—}3( ) Real)
(assert (=var11_{—}3 t131_val_{—}3))
(declare-fun t131_def_{—}4( ) Bool)
(declare-fun t131_val_{—}4( ) Real)
(declare-fun var11_{—}4( ) Real)
(assert (=var11_{—}4 t131_val_{—}4))
(assert (implies (and (and t126_def_{—}1 (>=t126_val_{—}1 0.0)) (not t127_def_{—}1))(not t131_def_{—}1)))
(assert (implies (and (and (and (>=t126_val_{—}1 0.0) t126_def_{—}1)(and (>=t127_val_{—}1 0.0) t127_def_{—}1)) t128_def_{—}1) (and t131_def_{—}1 (=t131_val_{—}1 (*t127_val_{—}1 t128_val_{—}1)))))
(assert (implies (and (and (and (>=t126_val_{—}1 0.0) t126_def_{—}1)(and (>=t127_val_{—}1 0.0) t127_def_{—}1)) (not t128_def_{—}1)) (not t131_def_{—}1)))
(assert (implies (and (and (and (>=t126_val_{—}1 0.0) t126_def_{—}1)(and (<t127_val_{—}1 0.0) t127_def_{—}1)) t129_def_{—}1) (and t131_def_{—}1 (=t131_val_{—}1 (*t127_val_{—}1 t129_val_{—}1)))))
(assert (implies (and (and (and (>=t126_val_{—}1 0.0) t126_def_{—}1)(and (<t127_val_{—}1 0.0) t127_def_{—}1)) (not t129_def_{—}1)) (not t131_def_{—}1)))
(assert (implies (and (and (>=t126_val_{—}1 0.0) t126_def_{—}1) (not t127_def_{—}1))(not t131_def_{—}1)))
(assert (implies (and (and (<t126_val_{—}1 0.0) t126_def_{—}1) t130_def_{—}1)(and t131_def_{—}1 (=t131_val_{—}1 t130_val_{—}1))))
(assert (implies (and (and (<t126_val_{—}1 0.0) t126_def_{—}1) (not t130_def_{—}1))(not t131_def_{—}1)))
(assert (implies (not t126_def_{—}1) (not t131_def_{—}1)))
(assert (implies (and (and t126_def_{—}2 (>=t126_val_{—}2 0.0)) (not t127_def_{—}2))(not t131_def_{—}2)))
(assert (implies (and (and (and (>=t126_val_{—}2 0.0) t126_def_{—}2)(and (>=t127_val_{—}2 0.0) t127_def_{—}2)) t128_def_{—}2) (and t131_def_{—}2 (=t131_val_{—}2 (*t127_val_{—}2 t128_val_{—}2)))))
(assert (implies (and (and (and (>=t126_val_{—}2 0.0) t126_def_{—}2)(and (>=t127_val_{—}2 0.0) t127_def_{—}2)) (not t128_def_{—}2)) (not t131_def_{—}2)))
(assert (implies (and (and (and (>=t126_val_{—}2 0.0) t126_def_{—}2)(and (<t127_val_{—}2 0.0) t127_def_{—}2)) t129_def_{—}2) (and t131_def_{—}2 (=t131_val_{—}2 (*t127_val_{—}2 t129_val_{—}2)))))
(assert (implies (and (and (and (>=t126_val_{—}2 0.0) t126_def_{—}2)(and (<t127_val_{—}2 0.0) t127_def_{—}2)) (not t129_def_{—}2)) (not t131_def_{—}2)))
(assert (implies (and (and (>=t126_val_{—}2 0.0) t126_def_{—}2) (not t127_def_{—}2))(not t131_def_{—}2)))
(assert (implies (and (and (<t126_val_{—}2 0.0) t126_def_{—}2) t130_def_{—}2)(and t131_def_{—}2 (=t131_val_{—}2 t130_val_{—}2))))
(assert (implies (and (and (<t126_val_{—}2 0.0) t126_def_{—}2) (not t130_def_{—}2))(not t131_def_{—}2)))
(assert (implies (not t126_def_{—}2) (not t131_def_{—}2)))
(assert (implies (and (and t126_def_{—}3 (>=t126_val_{—}3 0.0)) (not t127_def_{—}3))(not t131_def_{—}3)))
(assert (implies (and (and (and (>=t126_val_{—}3 0.0) t126_def_{—}3)(and (>=t127_val_{—}3 0.0) t127_def_{—}3)) t128_def_{—}3) (and t131_def_{—}3 (=t131_val_{—}3 (*t127_val_{—}3 t128_val_{—}3)))))
(assert (implies (and (and (and (>=t126_val_{—}3 0.0) t126_def_{—}3)(and (>=t127_val_{—}3 0.0) t127_def_{—}3)) (not t128_def_{—}3)) (not t131_def_{—}3)))
(assert (implies (and (and (and (>=t126_val_{—}3 0.0) t126_def_{—}3)(and (<t127_val_{—}3 0.0) t127_def_{—}3)) t129_def_{—}3) (and t131_def_{—}3 (=t131_val_{—}3 (*t127_val_{—}3 t129_val_{—}3)))))
(assert (implies (and (and (and (>=t126_val_{—}3 0.0) t126_def_{—}3)(and (<t127_val_{—}3 0.0) t127_def_{—}3)) (not t129_def_{—}3)) (not t131_def_{—}3)))
(assert (implies (and (and (>=t126_val_{—}3 0.0) t126_def_{—}3) (not t127_def_{—}3))(not t131_def_{—}3)))
(assert (implies (and (and (<t126_val_{—}3 0.0) t126_def_{—}3) t130_def_{—}3)(and t131_def_{—}3 (=t131_val_{—}3 t130_val_{—}3))))
(assert (implies (and (and (<t126_val_{—}3 0.0) t126_def_{—}3) (not t130_def_{—}3))(not t131_def_{—}3)))
(assert (implies (not t126_def_{—}3) (not t131_def_{—}3)))
(assert (implies (and (and t126_def_{—}4 (>=t126_val_{—}4 0.0)) (not t127_def_{—}4))(not t131_def_{—}4)))
(assert (implies (and (and (and (>=t126_val_{—}4 0.0) t126_def_{—}4)(and (>=t127_val_{—}4 0.0) t127_def_{—}4)) t128_def_{—}4) (and t131_def_{—}4 (=t131_val_{—}4 (*t127_val_{—}4 t128_val_{—}4)))))
(assert (implies (and (and (and (>=t126_val_{—}4 0.0) t126_def_{—}4)(and (>=t127_val_{—}4 0.0) t127_def_{—}4)) (not t128_def_{—}4)) (not t131_def_{—}4)))
(assert (implies (and (and (and (>=t126_val_{—}4 0.0) t126_def_{—}4)(and (<t127_val_{—}4 0.0) t127_def_{—}4)) t129_def_{—}4) (and t131_def_{—}4 (=t131_val_{—}4 (*t127_val_{—}4 t129_val_{—}4)))))
(assert (implies (and (and (and (>=t126_val_{—}4 0.0) t126_def_{—}4)(and (<t127_val_{—}4 0.0) t127_def_{—}4)) (not t129_def_{—}4)) (not t131_def_{—}4)))
(assert (implies (and (and (>=t126_val_{—}4 0.0) t126_def_{—}4) (not t127_def_{—}4))(not t131_def_{—}4)))
(assert (implies (and (and (<t126_val_{—}4 0.0) t126_def_{—}4) t130_def_{—}4)(and t131_def_{—}4 (=t131_val_{—}4 t130_val_{—}4))))
(assert (implies (and (and (<t126_val_{—}4 0.0) t126_def_{—}4) (not t130_def_{—}4))(not t131_def_{—}4)))
(assert (implies (not t126_def_{—}4) (not t131_def_{—}4)))

The problem whether ‘var7’ is consistent is encoded into SMT-LIB as:
(assert t106_def_{—}4)

Similarly, the problem whether ‘var11’ is consistent is encoded into SMT-LIB as:
(assert t131_def_{—}4)

### Equivalent Rules

### Example Rules

| | | | | | | |
|---|---|---|---|---|---|---|
| rvar1a | T | (tval var3 2) | 1 | 1 | 0 | var1a |
| rvar2a | T | (tmin var1a 3) | 1 | 1 | 0 | var2a |
| rvar1b | T | (tmin var3 3) | 1 | 1 | 0 | var1b |
| rvar2b | T | (tval var1b 2) | 1 | 1 | 0 | var2b |

In the above example, the variables ‘var2a’ and ‘var2b’ are equivalent (i.e., for all variable assignment, they get the same value).

The encoding of the above example into SMT-LIB format (without the encoding of the equivalence problem):
(declare-fun t132_def_{—}1( ) Bool)
(declare-fun t132_val_{—}1( ) Real)
(assert t132_def_{—}1)
(assert (=t132_val_{—}1 1.0))
(declare-fun t132_def_{—}2( ) Bool)
(declare-fun t132_val_{—}2( ) Real)
(assert t132_def_{—}2)
(assert (=t132_val_{—}2 1.0))
(declare-fun t132_def_{—}3( ) Bool)
(declare-fun t132_val_{—}3( ) Real)
(assert t132_def_{—}3)
(assert (=t132_val_{—}3 1.0))
(declare-fun t132_def_{—}4( ) Bool)
(declare-fun t132_val_{—}4( ) Real)
(assert t132_def_{—}4)
(assert (=t132_val_{—}4 1.0))
(declare-fun t132_def_{—}5( ) Bool)
(declare-fun t132_val_{—}5( ) Real)
(assert t132_def_{—}5)
(assert (=t132_val_{—}5 1.0))
(declare-fun t132_def_{—}6( ) Bool)
(declare-fun t132_val_{—}6( ) Real)
(assert t132_def_{—}6)
(assert (=t132_val_{—}6 1.0))
(declare-fun t132_def_{—}7( ) Bool)
(declare-fun t132_val_{—}7( ) Real)
(assert t132_def_{—}7)
(assert (=t132_val_{—}7 1.0))
(declare-fun t132_def_{—}8( ) Bool)
(declare-fun t132_val_{—}8( ) Real)
(assert t132_def_{—}8)
(assert (=t132_val_{—}8 1.0))
(declare-fun t132_def_{—}9( ) Bool)
(declare-fun t132_val_{—}9( ) Real)
(assert t132_def_{—}9)
(assert (=t132_val_{—}9 1.0))
(declare-fun t133_def_{—}1( ) Bool)
(declare-fun t133_val_{—}1( ) Real)
(declare-fun var3_{—}1( ) Real)
(assert (=var3_{—}1 t133_val_{—}1))
(declare-fun t133_def_{—}2( ) Bool)
(declare-fun t133_val_{—}2( ) Real)
(declare-fun var3_{—}2( ) Real)
(assert (=var3_{—}2 t133_val_{—}2))
(declare-fun t133_def_{—}3( ) Bool)
(declare-fun t133_val_{—}3( ) Real)
(declare-fun var3_{—}3( ) Real)
(assert (=var3_{—}3 t133_val_{—}3))
(declare-fun t133_def_{—}4( ) Bool)
(declare-fun t133_val_{—}4( ) Real)
(declare-fun var3_{—}4) Real)
(assert (=var3_{—}4 t133_val_{—}4))
(declare-fun t133_def_{—}5( ) Bool)
(declare-fun t133_val_{—}5( ) Real)
(declare-fun var3_{—}5( ) Real)
(assert (=var3_{—}5 t133_val_{—}5))
(declare-fun t133_def_{—}6( ) Bool)
(declare-fun t133_val_{—}6( ) Real)
(declare-fun var3_{—}6( ) Real)
(assert (=var3_{—}6 t133_val_{—}6))
(declare-fun t133_def_{—}7( ) Bool)
(declare-fun t133_val_{—}7( ) Real)
(declare-fun var3_{—}7( ) Real)
(assert (=var3_{—}7 t133_val_{—}7))
(declare-fun t133_def_{—}8( ) Bool)
(declare-fun t133_val_{—}8( ) Real)
(declare-fun var3_{—}8( ) Real)
(assert (=var3_{—}8 t133_val_{—}8))
(declare-fun t133_def_{—}9( ) Bool)
(declare-fun t133_val_{—}9( ) Real)
(declare-fun var3_{—}9( ) Real)
(assert (=var3_{—}9 t133_val_{—}9))
(declare-fun t134_def_{—}1( ) Bool)
(declare-fun t134_val_{—}1( ) Real)
(declare-fun t134_def_{—}2( ) Bool)
(declare-fun t134_val_{—}2( ) Real)
(declare-fun t134_def_{—}3( ) Bool)
(declare-fun t134_val_{—}3( ) Real)
(declare-fun t134_def_{—}4( ) Bool)
(declare-fun t134_val_{—}4( ) Real)
(declare-fun t134_def_{—}5( ) Bool)
(declare-fun t134_val_{—}5( ) Real)
(declare-fun t134_def_{—}6( ) Bool)
(declare-fun t134_val_{—}6( ) Real)
(declare-fun t134_def_{—}7( ) Bool)
(declare-fun t134_val_{—}7( ) Real)
(declare-fun t134_def_{—}8( ) Bool)
(declare-fun t134_val_{—}8( ) Real)
(declare-fun t134_def_{—}9( ) Bool)
(declare-fun t134_val_{—}9( ) Real)
(assert (not t134_def_{—}1))
(assert (not t134_def_{—}2))
(assert (implies t133_def_{—}1 (and t134_def_{—}3 (=t133_val_{—}1 t134_val_{—}3))))
(assert (implies (not t133_def_{—}1) (not t134_def_{—}3)))
(assert (implies t133_def_{—}2 (and t134_def_{—}4 (=t133_val_{—}2 t134_val_{—}4))))
(assert (implies (not t133_def_{—}2) (not t134_def_{—}4)))
(assert (implies t133_def_{—}3 (and t134_def_{—}5 (=t133_val_{—}3 t134_val_{—}5))))
(assert (implies (not t133_def_{—}3) (not t134_def_{—}5)))
(assert (implies t133_def_{—}4 (and t134_def_{—}6 (=t133_val_{—}4 t134_val_{—}6))))
(assert (implies (not t133_def_{—}4) (not t134_def_{—}6)))
(assert (implies t133_def_{—}5 (and t134_def_{—}7 (=t133_val_{—}5 t134_val_{—}7))))
(assert (implies (not t133_def_{—}5) (not t134_def_{—}7)))
(assert (implies t133_def_{—}6 (and t134_def_{—}8 (=t133_val_{—}6 t134_val_{—}8))))
(assert (implies (not t133_def_{—}6) (not t134_def_{—}8)))
(assert (implies t133_def_{—}7 (and t134_def_{—}9 (=t133_val_{—}7 t134_val_{—}9))))
(assert (implies (not t133_def_{—}7) (not t134_def_{—}9)))
(declare-fun t135_def_{—}1( ) Bool)
(declare-fun t135_val_{—}1( ) Real)
(assert t135_def_{—}1)
(assert (=t135_val_{—}1 1.0))
(declare-fun t135_def_{—}2( ) Bool)
(declare-fun t135_val_{—}2( ) Real)
(assert t135_def_{—}2)
(assert (=t135_val_{—}2 1.0))
(declare-fun t135_def_{—}3( ) Bool)
(declare-fun t135_val_{—}3( ) Real)
(assert t135_def_{—}3)
(assert (=t135_val_{—}3 1.0))
(declare-fun t135_def_{—}4( ) Bool)
(declare-fun t135_val_{—}4( ) Real)
(assert t135_def_{—}4)
(assert (=t135_val_{—}4 1.0))
(declare-fun t135_def_{—}5( ) Bool)
(declare-fun t135_val_{—}5( ) Real)
(assert t135_def_{—}5)
(assert (=t135_val_{—}5 1.0))
(declare-fun t135_def_{—}6( ) Bool)
(declare-fun t135_val_{—}6( ) Real)
(assert t135_def_{—}6)
(assert (=t135_val_{—}6 1.0))
(declare-fun t135_def_{—}7( ) Bool)
(declare-fun t135_val_{—}7( ) Real)
(assert t135_def_{—}7)
(assert (=t135_val_{—}7 1.0))
(declare-fun t135_def_{—}8( ) Bool)
(declare-fun t135_val_{—}8( ) Real)
(assert t135_def_{—}8)
(assert (=t135_val_{—}8 1.0))
(declare-fun t135_def_{—}9( ) Bool)
(declare-fun t135_val_{—}9( ) Real)
(assert t135_def_{—}9)
(assert (=t135_val_{—}9 1.0))
(declare-fun t136_def_{—}1( ) Bool)
(declare-fun t136_val_{—}1( ) Real)
(assert t136_def_{—}1)
(assert (=t136_val_{—}1 1.0))
(declare-fun t136_def_{—}2( ) Bool)
(declare-fun t136_val_{—}2( ) Real)
(assert t136_def_{—}2)
(assert (=t136_val_{—}2 1.0))
(declare-fun t136_def_{—}3( ) Bool)
(declare-fun t136_val_{—}3( ) Real)
(assert t136_def_{—}3)
(assert (=t136_val_{—}3 1.0))
(declare-fun t136_def_{—}4( ) Bool)
(declare-fun t136_val_{—}4( ) Real)
(assert t136_def_{—}4)
(assert (=t136_val_{—}4 1.0))
(declare-fun t136_def_{—}5( ) Bool)
(declare-fun t136_val_{—}5( ) Real)
(assert t136_def_{—}5)
(assert (=t136_val_{—}5 1.0))
(declare-fun t136_def_{—}6( ) Bool)
(declare-fun t136_val_{—}6( ) Real)
(assert t136_def_{—}6)
(assert (=t136_val_{—}6 1.0))
(declare-fun t136_def_{—}7( ) Bool)
(declare-fun t136_val_{—}7( ) Real)
(assert t136_def_{—}7)
(assert (=t136_val_{—}7 1.0))
(declare-fun t136_def_{—}8( ) Bool)
(declare-fun t136_val_{—}8( ) Real)
(assert t136_def_{—}8)
(assert (=t136_val_{—}8 1.0))
(declare-fun t136_def_{—}9( ) Bool)
(declare-fun t136_val_{—}9( ) Real)
(assert t136_def_{—}9)
(assert (=t136_val_{—}9 1.0))
(declare-fun t137_def_{—}1( ) Bool)
(declare-fun t137_val_{—}1( ) Real)
(assert t137_def_{—}1)
(assert (=t137_val_{—}1 0.0))
(declare-fun t137_def_{—}2( ) Bool)
(declare-fun t137_val_{—}2( ) Real)
(assert t137_def_{—}2)
(assert (=t137_val_{—}2 0.0))
(declare-fun t137_def_{—}3( ) Bool)
(declare-fun t137_val_{—}3( ) Real)
(assert t137_def_{—}3)
(assert (=t137_val_{—}3 0.0))
(declare-fun t137_def_{—}4( ) Bool)
(declare-fun t137_val_{—}4( ) Real)
(assert t137_def_{—}4)
(assert (=t137_val_{—}4 0.0))
(declare-fun t137_def_{—}5( ) Bool)
(declare-fun t137_val_{—}5( ) Real)
(assert t137_def_{—}5)
(assert (=t137_val_{—}5 0.0))
(declare-fun t137_def_{—}6( ) Bool)
(declare-fun t137_val_{—}6( ) Real)
(assert t137_def_{—}6)
(assert (=t137_val_{—}6 0.0))
(declare-fun t137_def_{—}7( ) Bool)
(declare-fun t137_val_{—}7( ) Real)
(assert t137_def_{—}7)
(assert (=t137_val_{—}7 0.0))
(declare-fun t137_def_{—}8( ) Bool)
(declare-fun t137_val_{—}8( ) Real)
(assert t137_def_{—}8)
(assert (=t137_val_{—}8 0.0))
(declare-fun t137_def_{—}9( ) Bool)
(declare-fun t137_val_{—}9( ) Real)
(assert t137_def_{—}9)
(assert (=t137_val_{—}9 0.0))
(declare-fun t138_def_{—}1( ) Bool)
(declare-fun t138_val_{—}1( ) Real)
(declare-fun var1a_{—}1( ) Real)
(assert (=var1a_{—}1 t138_val_{—}1))
(declare-fun t138_def_{—}2( ) Bool)
(declare-fun t138_val_{—}2( ) Real)
(declare-fun var1a_{—}2( ) Real)
(assert (=var1a_{—}2 t138_val_{—}2))
(declare-fun t138_def_{—}3( ) Bool)
(declare-fun t138_val_{—}3( ) Real)
(declare-fun var1a_{—}3( ) Real)
(assert (=var1a_{—}3 t138_val_{—}3))
(declare-fun t138_def_{—}4( ) Bool)
(declare-fun t138_val_{—}4( ) Real)
(declare-fun var1a_{—}4( ) Real)
(assert (=var1a_{—}4 t138_val_{—}4))
(declare-fun t138_def_{—}5( ) Bool)
(declare-fun t138_val_{—}5( ) Real)
(declare-fun var1a_{—}5( ) Real)
(assert (=var1a_{—}5 t138_val_{—}5))
(declare-fun t138_def_{—}6( ) Bool)
(declare-fun t138_val_{—}6( ) Real)
(declare-fun var1a_{—}6( ) Real)
(assert (=var1a_{—}6 t138_val_{—}6))
(declare-fun t138_def_{—}7( ) Bool)
(declare-fun t138_val_{—}7( ) Real)
(declare-fun var1a_{—}7( ) Real)
(assert (=var1a_{—}7 t138_val_{—}7))
(declare-fun t138_def_{—}8( ) Bool)
(declare-fun t138_val_{—}8( ) Real)
(declare-fun var1a_{—}8( ) Real)
(assert (=var1a_{—}8 t138_val_{—}8))
(declare-fun t138_def_{—}9( ) Bool)
(declare-fun t138_val_{—}9( ) Real)
(declare-fun var1a_{—}9( ) Real)
(assert (=var1a_{—}9 t138_val_{—}9))
(assert (implies (and (and t132_def_{—}1 (>=t132_val_{—}1 0.0)) (not t134_def_{—}1))(not t138_def_{—}1)))
(assert (implies (and (and (and (>=t132_val_{—}1 0.0) t132_def_{—}1)(and (>=t134_val_{—}1 0.0) t134_def_{—}1)) t135_def_{—}1) (and t138_def_{—}1 (=t138_val_{—}1 (*t134_val_{—}1 t135_val_{—}1)))))
(assert (implies (and (and (and (>=t132_val_{—}1 0.0) t132_def_{—}1)(and (>=t134_val_{—}1 0.0) t134_def_{—}1)) (not t135_def_{—}1)) (not t138_def_{—}1)))
(assert (implies (and (and (and (>=t132_val_{—}1 0.0) t132_def_{—}1)(and (<t134_val_{—}1 0.0) t134_def_{—}1)) t136_def_{—}1) (and t138_def_{—}1 (=t138_val_{—}1 (*t134_val_{—}1 t136_val_{—}1)))))
(assert (implies (and (and (and (>=t132_val_{—}1 0.0) t132_def_{—}1)(and (<t134_val_{—}1 0.0) t134_def_{—}1)) (not t136_def_{—}1)) (not t138_def_{—}1)))
(assert (implies (and (and (>=t132_val_{—}1 0.0) t132_def_{—}1) (not t134_def_{—}1))(not t138_def_{—}1)))
(assert (implies (and (and (<t132_val_{—}1 0.0) t132_def_{—}1) t137_def_{—}1)(and t138_def_{—}1 (=t138_val_{—}1 t137_val_{—}1))))
(assert (implies (and (and (<t132_val_{—}1 0.0) t132_def_{—}1) (not t137_def_{—}1))(not t138_def_{—}1)))
(assert (implies (not t132_def_{—}1) (not t138_def_{—}1)))
(assert (implies (and (and t132_def_{—}2 (>=t132_val_{—}2 0.0)) (not t134_def_{—}2))(not t138_def_{—}2)))
(assert (implies (and (and (and (>=t132_val_{—}2 0.0) t132_def_{—}2)(and (>=t134_val_{—}2 0.0) t134_def_{—}2)) t135_def_{—}2) (and t138_def_{—}2 (=t138_val_{—}2 (*t134_val_{—}2 t135_val_{—}2)))))
(assert (implies (and (and (and (>=t132_val_{—}2 0.0) t132_def_{—}2)(and (>=t134_val_{—}2 0.0) t134_def_{—}2)) (not t135_def_{—}2)) (not t138_def_{—}2)))
(assert (implies (and (and (and (>=t132_val_{—}2 0.0) t132_def_{—}2)(and (<t134_val_{—}2 0.0) t134_def_{—}2)) t136_def_{—}2) (and t138_def_{—}2 (=t138_val_{—}2 (*t134_val_{—}2 t136_val_{—}2)))))
(assert (implies (and (and (and (>=t132_val_{—}2 0.0) t132_def_{—}2)(and (<t134_val_{—}2 0.0) t134_def_{—}2)) (not t136_def_{—}2)) (not t138_def_{—}2)))
(assert (implies (and (and (>=t132_val_{—}2 0.0) t132_def_{—}2) (not t134_def_{—}2))(not t138_def_{—}2)))
(assert (implies (and (and (<t132_val_{—}2 0.0) t132_def_{—}2) t137_def_{—}2)(and t138_def_{—}2 (=t138_val_{—}2 t137_val_{—}2))))
(assert (implies (and (and (<t132_val_{—}2 0.0) t132_def_{—}2) (not t137_def_{—}2))(not t138_def_{—}2)))
(assert (implies (not t132_def_{—}2) (not t138_def_{—}2)))
(assert (implies (and (and t132_def_{—}3 (>=t132_val_{—}3 0.0)) (not t134_def_{—}3))(not t138_def_{—}3)))
(assert (implies (and (and (and (>=t132_val_{—}3 0.0) t132_def_{—}3)(and (>=t134_val_{—}3 0.0) t134_def_{—}3)) t135_def_{—}3) (and t138_def_{—}3 (=t138_val_{—}3 (*t134_val_{—}3 t135_val_{—}3)))))
(assert (implies (and (and (and (>=t132_val_{—}3 0.0) t132_def_{—}3)(and (>=t134_val_{—}3 0.0) t134_def_{—}3)) (not t135_def_{—}3)) (not t138_def_{—}3)))
(assert (implies (and (and (and (>=t132_val_{—}3 0.0) t132_def_{—}3)(and (<t134_val_{—}3 0.0) t134_def_{—}3)) t136_def_{—}3) (and t138_def_{—}3 (=t138_val_{—}3 (*t134_val_{—}3 t136_val_{—}3)))))
(assert (implies (and (and (and (>=t132_val_{—}3 0.0) t132_def_{—}3)(and (<t134_val_{—}3 0.0) t134_def_{—}3)) (not t136_def_{—}3)) (not t138_def_{—}3)))
(assert (implies (and (and (>=t132_val_{—}3 0.0) t132_def_{—}3) (not t134_def_{—}3))(not t138_def_{—}3)))
(assert (implies (and (and (<t132_val_{—}3 0.0) t132_def_{—}3) t137_def_{—}3)(and t138_def_{—}3 (=t138_val_{—}3 t137_val_{—}3))))
(assert (implies (and (and (<t132_val_{—}3 0.0) t132_def_{—}3) (not t137_def_{—}3))(not t138_def_{—}3)))
(assert (implies (not t132_def_{—}3) (not t138_def_{—}3)))
(assert (implies (and (and t132_def_{—}4 (>=t132_val_{—}4 0.0)) (not t134_def_{—}4))(not t138_def_{—}4)))
(assert (implies (and (and (and (>=t132_val_{—}4 0.0) t132_def_{—}4)(and (>=t134_val_{—}4 0.0) t134_def_{—}4)) t135_def_{—}4) (and t138_def_{—}4 (=t138_val_{—}4 (*t134_val_{—}4 t135_val_{—}4)))))
(assert (implies (and (and (and (>=t132_val_{—}4 0.0) t132_def_{—}4)(and (>=t134_val_{—}4 0.0) t134_def_{—}4)) (not t135_def_{—}4)) (not t138_def_{—}4)))
(assert (implies (and (and (and (>=t132_val_{—}4 0.0) t132_def_{—}4)(and (<t134_val_{—}4 0.0) t134_def_{—}4)) t136_def_{—}4) (and t138_def_{—}4 (=t138_val_{—}4 (*t134_val_{—}4 t136_val_{—}4)))))
(assert (implies (and (and (and (>=t132_val_{—}4 0.0) t132_def_{—}4)(and (<t134_val_{—}4 0.0) t134_def_{—}4)) (not t136_def_{—}4)) (not t138_def_{—}4)))
(assert (implies (and (and (>=t132_val_{—}4 0.0) t132_def_{—}4) (not t134_def_{—}4))(not t138_def_{—}4)))
(assert (implies (and (and (<t132_val_{—}4 0.0) t132_def_{—}4) t137_def_{—}4)(and t138_def_{—}4 (=t138_val_{—}4 t137_val_{—}4))))
(assert (implies (and (and (<t132_val_{—}4 0.0) t132_def_{—}4) (not t137_def_{—}4))(not t138_def_{—}4)))
(assert (implies (not t132_def_{—}4) (not t138_def_{—}4)))
(assert (implies (and (and t132_def_{—}5 (>=t132_val_{—}5 0.0)) (not t134_def_{—}5))(not t138_def_{—}5)))
(assert (implies (and (and (and (>=t132_val_{—}5 0.0) t132_def_{—}5)(and (>=t134_val_{—}5 0.0) t134_def_{—}5)) t135_def_{—}5) (and t138_def_{—}5 (=t138_val_{—}5 (*t134_val_{—}5 t135_val_{—}5)))))
(assert (implies (and (and (and (>=t132_val_{—}5 0.0) t132_def_{—}5)(and (>=t134_val_{—}5 0.0) t134_def_{—}5)) (not t135_def_{—}5)) (not t138_def_{—}5)))
(assert (implies (and (and (and (>=t132_val_{—}5 0.0) t132_def_{—}5)(and (<t134_val_{—}5 0.0) t134_def_{—}5)) t136_def_{—}5) (and t138_def_{—}5 (=t138_val_{—}5 (*t134_val_{—}5 t136_val_{—}5)))))
(assert (implies (and (and (and (>=t132_val_{—}5 0.0) t132_def_{—}5)(and (<t134_val_{—}5 0.0) t134_def_{—}5)) (not t136_def_{—}5)) (not t138_def_{—}5)))
(assert (implies (and (and (>=t132_val_{—}5 0.0) t132_def_{—}5) (not t134_def_{—}5))(not t138_def_{—}5)))
(assert (implies (and (and (<t132_val_{—}5 0.0) t132_def_{—}5) t137_def_{—}5)(and t138_def_{—}5 (=t138_val_{—}5 t137_val_{—}5))))
(assert (implies (and (and (<t132_val_{—}5 0.0) t132_def_{—}5) (not t137_def_{—}5))(not t138_def_{—}5)))
(assert (implies (not t132_def_{—}5) (not t138_def_{—}5)))
(assert (implies (and (and t132_def_{—}6 (>=t132_val_{—}6 0.0)) (not t134_def_{—}6))(not t138_def_{—}6)))
(assert (implies (and (and (and (>=t132_val_{—}6 0.0) t132_def_{—}6)(and (>=t134_val_{—}6 0.0) t134_def_{—}6)) t135_def_{—}6) (and t138_def_{—}6 (=t138_val_{—}6 (*t134_val_{—}6 t135_val_{—}6)))))
(assert (implies (and (and (and (>=t132_val_{—}6 0.0) t132_def_{—}6)(and (>=t134_val_{—}6 0.0) t134_def_{—}6)) (not t135_def_{—}6)) (not t138_def_{—}6)))
(assert (implies (and (and (and (>=t132_val_{—}6 0.0) t132_def_{—}6)(and (<t134_val_{—}6 0.0) t134_def_{—}6)) t136_def_{—}6) (and t138_def_{—}6 (=t138_val_{—}6 (*t134_val_{—}6 t136_val_{—}6)))))
(assert (implies (and (and (and (>=t132_val_{—}6 0.0) t132_def_{—}6)(and (<t134_val_{—}6 0.0) t134_def_{—}6)) (not t136_def_{—}6)) (not t138_def_{—}6)))
(assert (implies (and (and (>=t132_val_{—}6 0.0) t132_def_{—}6) (not t134_def_{—}6))(not t138_def_{—}6)))
(assert (implies (and (and (<t132_val_{—}6 0.0) t132_def_{—}6) t137_def_{—}6)(and t138_def_{—}6 (=t138_val_{—}6 t137_val_{—}6))))
(assert (implies (and (and (<t132_val_{—}6 0.0) t132_def_{—}6) (not t137_def_{—}6))(not t138_def_{—}6)))
(assert (implies (not t132_def_{—}6) (not t138_def_{—}6)))
(assert (implies (and (and t132_def_{—}7 (>=t132_val_{—}7 0.0)) (not t134_def_{—}7))(not t138_def_{—}7)))
(assert (implies (and (and (and (>=t132_val_{—}7 0.0) t132_def_{—}7)(and (>=t134_val_{—}7 0.0) t134_def_{—}7)) t135_def_{—}7) (and t138_def_{—}7 (=t138_val_{—}7 (*t134_val_{—}7 t135_val_{—}7)))))
(assert (implies (and (and (and (>=t132_val_{—}7 0.0) t132_def_{—}7)(and (>=t134_val_{—}7 0.0) t134_def_{—}7)) (not t135_def_{—}7)) (not t138_def_{—}7)))
(assert (implies (and (and (and (>=t132_val_{—}7 0.0) t132_def_{—}7)(and (<t134_val_{—}7 0.0) t134_def_{—}7)) t136_def_{—}7) (and t138_def_{—}7 (=t138_val_{—}7 (*t134_val_{—}7 t136_val_{—}7)))))
(assert (implies (and (and (and (>=t132_val_{—}7 0.0) t132_def_{—}7)(and (<t134_val_{—}7 0.0) t134_def_{—}7)) (not t136_def_{—}7)) (not t138_def_{—}7)))
(assert (implies (and (and (>=t132_val_{—}7 0.0) t132_def_{—}7) (not t134_def_{—}7))(not t138_def_{—}7)))
(assert (implies (and (and (<t132_val_{—}7 0.0) t132_def_{—}7) t137_def_{—}7)(and t138_def_{—}7 (=t138_val_{—}7 t137_val_{—}7))))
(assert (implies (and (and (<t132_val_{—}7 0.0) t132_def_{—}7) (not t137_def_{—}7))(not t138_def_{—}7)))
(assert (implies (not t132_def_{—}7) (not t138_def_{—}7)))
(assert (implies (and (and t132_def_{—}8 (>=t132_val_{—}8 0.0)) (not t134_def_{—}8))(not t138_def_{—}8)))
(assert (implies (and (and (and (>=t132_val_{—}8 0.0) t132_def_{—}8)(and (>=t134_val_{—}8 0.0) t134_def_{—}8)) t135_def_{—}8) (and t138_def_{—}8 (=t138_val_{—}8 (*t134_val_{—}8 t135_val_{—}8)))))
(assert (implies (and (and (and (>=t132_val_{—}8 0.0) t132_def_{—}8)(and (>=t134_val_{—}8 0.0) t134_def_{—}8)) (not t135_def_{—}8)) (not t138_def_{—}8)))
(assert (implies (and (and (and (>=t132_val_{—}8 0.0) t132_def_{—}8)(and (<t134_val_{—}8 0.0) t134_def_{—}8)) t136_def_{—}8) (and t138_def_{—}8 (=t138_val_{—}8 (*t134_val_{—}8 t136_val_{—}8)))))
(assert (implies (and (and (and (>=t132_val_{—}8 0.0) t132_def_{—}8)(and (<t134_val_{—}8 0.0) t134_def_{—}8)) (not t136_def_{—}8)) (not t138_def_{—}8)))
(assert (implies (and (and (>=t132_val_{—}8 0.0) t132_def_{—}8) (not t134_def_{—}8))(not t138_def_{—}8)))
(assert (implies (and (and (<t132_val_{—}8 0.0) t132_def_{—}8) t137_def_{—}8)(and t138_def_{—}8 (=t138_val_{—}8 t137_val_{—}8))))
(assert (implies (and (and (<t132_val_{—}8 0.0) t132_def_{—}8) (not t137_def_{—}8))(not t138_def_{—}8)))
(assert (implies (not t132_def_{—}8) (not t138_def_{—}8)))
(assert (implies (and (and t132_def_{—}9 (>=t132_val_{—}9 0.0)) (not t134_def_{—}9))(not t138_def_{—}9)))
(assert (implies (and (and (and (>=t132_val_{—}9 0.0) t132_def_{—}9)(and (>=t134_val_{—}9 0.0) t134_def_{—}9)) t135_def_{—}9) (and t138_def_{—}9 (=t138_val_{—}9 (*t134_val_{—}9 t135_val_{—}9)))))
(assert (implies (and (and (and (>=t132_val_{—}9 0.0) t132_def_{—}9)(and (>=t134_val_{—}9 0.0) t134_def_{—}9)) (not t135_def_{—}9)) (not t138_def_{—}9)))
(assert (implies (and (and (and (>=t132_val_{—}9 0.0) t132_def_{—}9)(and (<t134_val_{—}9 0.0) t134_def_{—}9)) t136_def_{—}9) (and t138_def_{—}9 (=t138_val_{—}9 (*t134_val_{—}9 t136_val_{—}9)))))
(assert (implies (and (and (and (>=t132_val_{—}9 0.0) t132_def_{—}9)(and (<t134_val_{—}9 0.0) t134_def_{—}9)) (not t136_def_{—}9)) (not t138_def_{—}9)))
(assert (implies (and (and (>=t132_val_{—}9 0.0) t132_def_{—}9) (not t134_def_{—}9))(not t138_def_{—}9)))
(assert (implies (and (and (<t132_val_{—}9 0.0) t132_def_{—}9) t137_def_{—}9)(and t138_def_{—}9 (=t138_val_{—}9 t137_val_{—}9))))
(assert (implies (and (and (<t132_val_{—}9 0.0) t132_def_{—}9) (not t137_def_{—}9))(not t138_def_{—}9)))
(assert (implies (not t132_def_{—}9) (not t138_def_{—}9)))
(declare-fun t139_def_{—}1( ) Bool)
(declare-fun t139_val_{—}1( ) Real)
(assert t139_def_{—}1)
(assert (=t139_val_{—}1 1.0))
(declare-fun t139_def_{—}2( ) Bool)
(declare-fun t139_val_{—}2( ) Real)
(assert t139_def_{—}2)
(assert (=t139_val_{—}2 1.0))
(declare-fun t139_def_{—}3( ) Bool)
(declare-fun t139_val_{—}3( ) Real)
(assert t139_def_{—}3)
(assert (=t139_val_{—}3 1.0))
(declare-fun t139_def_{—}4( ) Bool)
(declare-fun t139_val_{—}4( ) Real)
(assert t139_def_{—}4)
(assert (=t139_val_{—}4 1.0))
(declare-fun t139_def_{—}5( ) Bool)
(declare-fun t139_val_{—}5( ) Real)
(assert t139_def_{—}5)
(assert (=t139_val_{—}5 1.0))
(declare-fun t139_def_{—}6( ) Bool)
(declare-fun t139_val_{—}6( ) Real)
(assert t139_def_{—}6)
(assert (=t139_val_{—}6 1.0))
(declare-fun t139_def_{—}7( ) Bool)
(declare-fun t139_val_{—}7( ) Real)
(assert t139_def_{—}7)
(assert (=t139_val_{—}7 1.0))
(declare-fun t139_def_{—}8( ) Bool)
(declare-fun t139_val_{—}8( ) Real)
(assert t139_def_{—}8)
(assert (=t139_val_{—}8 1.0))
(declare-fun t139_def_{—}9( ) Bool)
(declare-fun t139_val_{—}9( ) Real)
(assert t139_def_{—}9)
(assert (=t139_val_{—}9 1.0))
(declare-fun t140_def_{—}1_{—}1( ) Bool)
(declare-fun t140_val_{—}1_{—}1( ) Real)
(declare-fun t140_def_{—}2_{—}1( ) Bool)
(declare-fun t140_val_{—}2_{—}1( ) Real)
(declare-fun t140_def_{—}3_{—}1( ) Bool)
(declare-fun t140_val_{—}3_{—}1( ) Real)
(declare-fun t140_def_{—}1_{—}2( ) Bool)
(declare-fun t140_val_{—}1_{—}2( ) Real)
(declare-fun t140_def_{—}2_{—}2( ) Bool)
(declare-fun t140_val_{—}2_{—}2( ) Real)
(declare-fun t140_def_{—}3_{—}2( ) Bool)
(declare-fun t140_val_{—}3_{—}2( ) Real)
(declare-fun t140_def_{—}1_{—}3( ) Bool)
(declare-fun t140_val_{—}1_{—}3( ) Real)
(declare-fun t140_def_{—}2_{—}3( ) Bool)
(declare-fun t140_val_{—}2_{—}3( ) Real)
(declare-fun t140_def_{—}3_{—}3( ) Bool)
(declare-fun t140_val_{—}3_{—}3( ) Real)
(declare-fun t140_def_{—}1_{—}4( ) Bool)
(declare-fun t140_val_{—}1_{—}4( ) Real)
(declare-fun t140_def_{—}2_{—}4( ) Bool)
(declare-fun t140_val_{—}2_{—}4( ) Real)
(declare-fun t140_def_{—}3_{—}4( ) Bool)
(declare-fun t140_val_{—}3_{—}4( ) Real)
(declare-fun t140_def_{—}1_{—}5( ) Bool)
(declare-fun t140_val_{—}1_{—}5( ) Real)
(declare-fun t140_def_{—}2_{—}5( ) Bool)
(declare-fun t140_val_{—}2_{—}5( ) Real)
(declare-fun t140_def_{—}3_{—}5( ) Bool)
(declare-fun t140_val_{—}3_{—}5( ) Real)
(declare-fun t140_def_{—}1_{—}6( ) Bool)
(declare-fun t140_val_{—}1_{—}6( ) Real)
(declare-fun t140_def_{—}2_{—}6( ) Bool)
(declare-fun t140_val_{—}2_{—}6( ) Real)
(declare-fun t140_def_{—}3_{—}6( ) Bool)
(declare-fun t140_val_{—}3_{—}6( ) Real)
(declare-fun t140_def_{—}1_{—}7( ) Bool)
(declare-fun t140_val_{—}1_{—}7( ) Real)
(declare-fun t140_def_{—}2_{—}7( ) Bool)
(declare-fun t140_val_{—}2_{—}7( ) Real)
(declare-fun t140_def_{—}3_{—}7( ) Bool)
(declare-fun t140_val_{—}3_{—}7( ) Real)
(declare-fun t140_def_{—}1_{—}8( ) Bool)
(declare-fun t140_val_{—}1_{—}8( ) Real)
(declare-fun t140_def_{—}2_{—}8( ) Bool)
(declare-fun t140_val_{—}2_{—}8( ) Real)
(declare-fun t140_def_{—}3_{—}8( ) Bool)
(declare-fun t140_val_{—}3_{—}8( ) Real)
(declare-fun t140_def_{—}1_{—}9( ) Bool)
(declare-fun t140_val_{—}1_{—}9( ) Real)
(declare-fun t140_def_{—}2_{—}9( ) Bool)
(declare-fun t140_val_{—}2_{—}9( ) Real)
(declare-fun t140_def_{—}3_{—}9( ) Bool)
(declare-fun t140_val_{—}3_{—}9( ) Real)
(assert (not t140_def_{—}1_{—}1))
(assert (not t140_def_{—}2_{—}1))
(assert (not t140_def_{—}3_{—}1))
(assert (not t140_def_{—}1_{—}2))
(assert (not t140_def_{—}2_{—}2))
(assert (not t140_def_{—}3_{—}2))
(assert (not t140_def_{—}1_{—}3))
(assert (not t140_def_{—}2_{—}3))
(assert (not t140_def_{—}3_{—}3))
(assert (implies t138_def_{—}1 t140_def_{—}1_{—}4))
(assert (implies (not t138_def_{—}1) (not t140_def_{—}1_{—}4)))
(assert (implies t138_def_{—}1 (=t140_val_{—}1_{—}4 t138_val_{—}1)))
(assert (implies (and (not t140_def_{—}1_{—}4) (not t138_def_{—}2)) (not t140_def_{—}2_{—}4)))
(assert (implies (and (not t140_def_{—}1_{—}4) t138_def_{—}2) (and t140_def_{—}2_{—}4 (=t140_val_{—}2_{—}4 t138_val_{—}2))))
(assert (implies (and t140_def_{—}1_{—}4 (not t138_def_{—}2)) (and t140_def_{—}2_{—}4 (=t140_val_{—}2_{—}4 t140_val_{—}1_{—}4))))
(assert (implies (and (and t140_def_{—}1_{—}4 t138_def_{—}2) (<t138_val_{—}2 t140_val_{—}1_{—}4)) (and t140_def_{—}2_{—}4 (=t140_val_{—}2_{—}4 t138_val_{—}2))))
(assert (implies (and (and t140_def_{—}1_{—}4 t138_def_{—}2) (>=t138_val_{—}2 t140_val_{—}1_{—}4)) (and t140_def_{—}2_{—}4 (=t140_val_{—}2_{—}4 t140_val_{—}1_{—}4))))
(assert (implies (and (not t140_def_{—}2_{—}4) (not t138_def_{—}3)) (not t140_def_{—}3_{—}4)))
(assert (implies (and (not t140_def_{—}2_{—}4) t138_def_{—}3) (and t140_def_{—}3_{—}4 (=t140_val_{—}3_{—}4 t138_val_{—}3))))
(assert (implies (and t140_def_{—}2_{—}4 (not t138_def_{—}3)) (and t140_def_{—}3_{—}4 (=t140_val_{—}3_{—}4 t140_val_{—}2_{—}4))))
(assert (implies (and (and t140_def_{—}2_{—}4 t138_def_{—}3) (<t138_val_{—}3 t140_val_{—}2_{—}4)) (and t140_def_{—}3_{—}4 (=t140_val_{—}3_{—}4 t138_val_{—}3))))
(assert (implies (and (and t140_def_{—}2_{—}4 t138_def_{—}3) (>=t138_val_{—}3 t140_val_{—}2_{—}4)) (and t140_def_{—}3_{—}4 (=t140_val_{—}3_{—}4 t140_val_{—}2_{—}4))))
(assert (implies t138_def_{—}2 t140_def_{—}1_{—}5))
(assert (implies (not t138_def_{—}2) (not t140_def_{—}1_{—}5)))
(assert (implies t138_def_{—}2 (=t140_val_{—}1_{—}5 t138_val_{—}2)))
(assert (implies (and (not t140_def_{—}1_{—}5) (not t138_def_{—}3)) (not t140_def_{—}2_{—}5)))
(assert (implies (and (not t140_def_{—}1_{—}5) t138_def_{—}3) (and t140_def_{—}2_{—}5 (=t140_val_{—}2_{—}5 t138_val_{—}3))))
(assert (implies (and t140_def_{—}1_{—}5 (not t138_def_{—}3)) (and t140_def_{—}2_{—}5 (=t140_val_{—}2_{—}5 t140_val_{—}1_{—}5))))
(assert (implies (and (and t140_def_{—}1_{—}5 t138_def_{—}3) (<t138_val_{—}3 t140_val_{—}1_{—}5)) (and t140_def_{—}2_{—}5 (=t140_val_{—}2_{—}5 t138_val_{—}3))))
(assert (implies (and (and t140_def_{—}1_{—}5 t138_def_{—}3) (>=t138_val_{—}3 t140_val_{—}1_{—}5)) (and t140_def_{—}2_{—}5 (=t140_val_{—}2_{—}5 t140_val_{—}1_{—}5))))
(assert (implies (and (not t140_def_{—}2_{—}5) (not t138_def_{—}4)) (not t140_def_{—}3_{—}5)))
(assert (implies (and (not t140_def_{—}2_{—}5) t138_def_{—}4) (and t140_def_{—}3_{—}5 (=t140_val_{—}3_{—}5 t138_val_{—}4))))
(assert (implies (and t140_def_{—}2_{—}5 (not t138_def_{—}4)) (and t140_def_{—}3_{—}5 (=t140_val_{—}3_{—}5 t140_val_{—}2_{—}5))))
(assert (implies (and (and t140_def_{—}2_{—}5 t138_def_{—}4) (<t138_val_{—}4 t140_val_{—}2_{—}5)) (and t140_def_{—}3_{—}5 (=t140_val_{—}3_{—}5 t138_val_{—}4))))
(assert (implies (and (and t140_def_{—}2_{—}5 t138_def_{—}4) (>=t138_val_{—}4 t140_val_{—}2_{—}5)) (and t140_def_{—}3_{—}5 (=t140_val_{—}3_{—}5 t140_val_{—}2_{—}5))))
(assert (implies t138_def_{—}3 t140_def_{—}1_{—}6))
(assert (implies (not t138_def_{—}3) (not t140_def_{—}1_{—}6)))
(assert (implies t138_def_{—}3 (=t140_val_{—}1_{—}6 t138_val_{—}3)))
(assert (implies (and (not t140_def_{—}1_{—}6) (not t138_def_{—}4)) (not t140_def_{—}2_{—}6)))
(assert (implies (and (not t140_def_{—}1_{—}6) t138_def_{—}4) (and t140_def_{—}2_{—}6 (=t140_val_{—}2_{—}6 t138_val_{—}4))))
(assert (implies (and t140_def_{—}1_{—}6 (not t138_def_{—}4)) (and t140_def_{—}2_{—}6 (=t140_val_{—}2_{—}6 t140_val_{—}1_{—}6))))
(assert (implies (and (and t140_def_{—}1_{—}6 t138_def_{—}4) (<t138_val_{—}4 t140_val_{—}1_{—}6)) (and t140_def_{—}2_{—}6 (=t140_val_{—}2_{—}6 t138_val_{—}4))))
(assert (implies (and (and t140_def_{—}1_{—}6 t138_def_{—}4) (>=t138_val_{—}4 t140_val_{—}1_{—}6)) (and t140_def_{—}2_{—}6 (=t140_val_{—}2_{—}6 t140_val_{—}1_{—}6))))
(assert (implies (and (not t140_def_{—}2_{—}6) (not t138_def_{—}5)) (not t140_def_{—}3_{—}6)))
(assert (implies (and (not t140_def_{—}2_{—}6) t138_def_{—}5) (and t140_def_{—}3_{—}6 (=t140_val_{—}3_{—}6 t138_val_{—}5))))
(assert (implies (and t140_def_{—}2_{—}6 (not t138_def_{—}5)) (and t140_def_{—}3_{—}6 (=t140_val_{—}3_{—}6 t140_val_{—}2_{—}6))))
(assert (implies (and (and t140_def_{—}2_{—}6 t138_def_{—}5) (<t138_val_{—}5 t140_val_{—}2_{—}6)) (and t140_def_{—}3_{—}6 (=t140_val_{—}3_{—}6 t138_val_{—}5))))
(assert (implies (and (and t140_def_{—}2_{—}6 t138_def_{—}5) (>=t138_val_{—}5 t140_val_{—}2_{—}6)) (and t140_def_{—}3_{—}6 (=t140_val_{—}3_{—}6 t140_val_{—}2_{—}6))))
(assert (implies t138_def_{—}4 t140_def_{—}1_{—}7))
(assert (implies (not t138_def_{—}4) (not t140_def_{—}1_{—}7)))
(assert (implies t138_def_{—}4 (=t140_val_{—}1_{—}7 t138_val_{—}4)))
(assert (implies (and (not t140_def_{—}1_{—}7) (not t138_def_{—}5)) (not t140_def_{—}2_{—}7)))
(assert (implies (and (not t140_def_{—}1_{—}7) t138_def_{—}5) (and t140_def_{—}2_{—}7 (=t140_val_{—}2_{—}7 t138_val_{—}5))))
(assert (implies (and t140_def_{—}1_{—}7 (not t138_def_{—}5)) (and t140_def_{—}2_{—}7 (=t140_val_{—}2_{—}7 t140_val_{—}1_{—}7))))
(assert (implies (and (and t140_def_{—}1_{—}7 t138_def_{—}5) (<t138_val_{—}5 t140_val_{—}1_{—}7)) (and t140_def_{—}2_{—}7 (=t140_val_{—}2_{—}7 t138_val_{—}5))))
(assert (implies (and (and t140_def_{—}1_{—}7 t138_def_{—}5) (>=t138_val_{—}5 t140_val_{—}1_{—}7)) (and t140_def_{—}2_{—}7 (=t140_val_{—}2_{—}7 t140_val_{—}1_{—}7))))
(assert (implies (and (not t140_def_{—}2_{—}7) (not t138_def_{—}6)) (not t140_def_{—}3_{—}7)))
(assert (implies (and (not t140_def_{—}2_{—}7) t138_def_{—}6) (and t140_def_{—}3_{—}7 (=t140_val_{—}3_{—}7 t138_val_{—}6))))
(assert (implies (and t140_def_{—}2_{—}7 (not t138_def_{—}6)) (and t140_def_{—}3_{—}7 (=t140_val_{—}3_{—}7 t140_val_{—}2_{—}7))))
(assert (implies (and (and t140_def_{—}2_{—}7 t138_def_{—}6) (<t138_val_{—}6 t140_val_{—}2_{—}7)) (and t140_def_{—}3_{—}7 (=t140_val_{—}3_{—}7 t138_val_{—}6))))
(assert (implies (and (and t140_def_{—}2_{—}7 t138_def_{—}6) (>=t138_val_{—}6 t140_val_{—}2_{—}7)) (and t140_def_{—}3_{—}7 (=t140_val_{—}3_{—}7 t140_val_{—}2_{—}7))))
(assert (implies t138_def_{—}5 t140_def_{—}1_{—}8))
(assert (implies (not t138_def_{—}5) (not t140_def_{—}1_{—}8)))
(assert (implies t138_def_{—}5 (=t140_val_{—}1_{—}8 t138_val_{—}5)))
(assert (implies (and (not t140_def_{—}1_{—}8) (not t138_def_{—}6)) (not t140_def_{—}2_{—}8)))
(assert (implies (and (not t140_def_{—}1_{—}8) t138_def_{—}6) (and t140_def_{—}2_{—}8 (=t140_val_{—}2_{—}8 t138_val_{—}6))))
(assert (implies (and t140_def_{—}1_{—}8 (not t138_def_{—}6)) (and t140_def_{—}2_{—}8 (=t140_val_{—}2_{—}8 t140_val_{—}1_{—}8))))
(assert (implies (and (and t140_def_{—}1_{—}8 t138_def_{—}6) (<t138_val_{—}6 t140_val_{—}1_{—}8)) (and t140_def_{—}2_{—}8 (=t140_val_{—}2_{—}8 t138_val_{—}6))))
(assert (implies (and (and t140_def_{—}1_{—}8 t138_def_{—}6) (>=t138_val_{—}6 t140_val_{—}1_{—}8)) (and t140_def_{—}2_{—}8 (=t140_val_{—}2_{—}8 t140_val_{—}1_{—}8))))
(assert (implies (and (not t140_def_{—}2_{—}8) (not t138_def_{—}7)) (not t140_def_{—}3_{—}8)))
(assert (implies (and (not t140_def_{—}2_{—}8) t138_def_{—}7) (and t140_def_{—}3_{—}8 (=t140_val_{—}3_{—}8 t138_val_{—}7))))
(assert (implies (and t140_def_{—}2_{—}8 (not t138_def_{—}7)) (and t140_def_{—}3_{—}8 (=t140_val_{—}3_{—}8 t140_val_{—}2_{—}8))))
(assert (implies (and (and t140_def_{—}2_{—}8 t138_def_{—}7) (<t138_val_{—}7 t140_val_{—}2_{—}8)) (and t140_def_{—}3_{—}8 (=t140_val_{—}3_{—}8 t138_val_{—}7))))
(assert (implies (and (and t140_def_{—}2_{—}8 t138_def_{—}7) (>=t138_val_{—}7 t140_val_{—}2_{—}8)) (and t140_def_{—}3_{—}8 (=t140_val_{—}3_{—}8 t140_val_{—}2_{—}8))))
(assert (implies t138_def_{—}6 t140_def_{—}1_{—}9))
(assert (implies (not t138_def_{—}6) (not t140_def_{—}1_{—}9)))
(assert (implies t138_def_{—}6 (=t140_val_{—}1_{—}9 t138_val_{—}6)))
(assert (implies (and (not t140_def_{—}1_{—}9) (not t138_def_{—}7)) (not t140_def_{—}2_{—}9)))
(assert (implies (and (not t140_def_{—}1_{—}9) t138_def_{—}7) (and t140_def_{—}2_{—}9 (=t140_val_{—}2_{—}9 t138_val_{—}7))))
(assert (implies (and t140_def_{—}1_{—}9 (not t138_def_{—}7)) (and t140_def_{—}2_{—}9 (=t140_val_{—}2_{—}9 t140_val_{—}1_{—}9))))
(assert (implies (and (and t140_def_{—}1_{—}9 t138_def_{—}7) (<t138_val_{—}7 t140_val_{—}1_{—}9)) (and t140_def_{—}2_{—}9 (=t140_val_{—}2_{—}9 t138_val_{—}7))))
(assert (implies (and (and t140_def_{—}1_{—}9 t138_def_{—}7) (>=t138_val_{—}7 t140_val_{—}1_{—}9)) (and t140_def_{—}2_{—}9 (=t140_val_{—}2_{—}9 t140_val_{—}1_{—}9))))
(assert (implies (and (not t140_def_{—}2_{—}9) (not t138_def_{—}8)) (not t140_def_{—}3_{—}9)))
(assert (implies (and (not t140_def_{—}2_{—}9) t138_def_{—}8) (and t140_def_{—}3_{—}9 (=t140_val_{—}3_{—}9 t138_val_{—}8))))
(assert (implies (and t140_def_{—}2_{—}9 (not t138_def_{—}8)) (and t140_def_{—}3_{—}9 (=t140_val_{—}3_{—}9 t140_val_{—}2_{—}9))))
(assert (implies (and (and t140_def_{—}2_{—}9 t138_def_{—}8) (<t138_val_{—}8 t140_val 2_{—}9)) (and t140_def_{—}3_{—}9 (=t140_val_{—}3_{—}9 t138_val_{—}8))))
(assert (implies (and (and t140_def_{—}2_{—}9 t138_def_{—}8) (>=t138_val_{—}8 t140_val_{—}2_{—}9)) (and t140_def_{—}3_{—}9 (=t140_val_{—}3_{—}9 t140_val_{—}2_{—}9))))
(declare-fun t140_def_{—}1( ) Bool)
(declare-fun t140_val_{—}1( ) Real)
(assert (=t140_def_{—}3_{—}1 t140_def_{—}1))
(assert (=t140_val_{—}3_{—}1 t140_val_{—}1))
(declare-fun t140_def_{—}2( ) Bool)
(declare-fun t140_val_{—}2( ) Real)
(assert (=t140_def_{—}3_{—}2 t140 3_{—}2 t140_def_{—}2))
(assert (=t140_val_{—}3_{—}2 t140_val_{—}2))
(declare-fun t140_def_{—}3( ) Bool)
(declare-fun t140_val_{—}3( ) Real)
(assert (=t140_def_{—}3_{—}3 t140_def_{—}3))
(assert (=t140_val_{—}3_{—}3 t140_val_{—}3))
(declare-fun t140_def_{—}4( ) Bool)
(declare-fun t140_val_{—}4( ) Real)
(assert (=t140_def_{—}3_{—}4 t140_def_{—}4))
(assert (=t140_val_{—}3_{—}4 t140_val_{—}4))
(declare-fun t140_def_{—}5( ) Bool)
(declare-fun t140_val_{—}5( ) Real)
(assert (=t140_def_{—}3_{—}5 t140 3_{—}5 t140_def_{—}5))
(assert (=t140_val_{—}3_{—}5 t140_val_{—}5))
(declare-fun t140_def_{—}6( ) Bool)
(declare-fun t140_val_{—}6( ) Real)
(assert (=t140_def_{—}3_{—}6 t140_def_{—}6))
(assert (=t140_val_{—}3_{—}6 t140_val_{—}6))
(declare-fun t140_def_{—}7( ) Bool)
(declare-fun t140_val_{—}7( ) Real)
(assert (=t140_def_{—}3_{—}7 t140 3_{—}7 t140_def_{—}7))
(assert (=t140_val_{—}3_{—}7 t140_val_{—}7))
(declare-fun t140_def_{—}8( ) Bool)
(declare-fun t140_val_{—}8( ) Real)
(assert (=t140_def_{—}3_{—}8 t140 3_{—}8 t140_def_{—}8))
(assert (=t140_val_{—}3_{—}8 t140_val_{—}8))
(declare-fun t140_def_{—}9( ) Bool)
(declare-fun t140_val_{—}9( ) Real)
(assert (=t140_def_{—}3_{—}9 t140_def_{—}9))
(assert (=t140_val_{—}3_{—}9 t140_val_{—}9))
(declare-fun t141_def_{—}1( ) Bool)
(declare-fun t141_val_{—}1( ) Real)
(assert t141_def_{—}1)
(assert (=t141_val_{—}1 1.0))
(declare-fun t141_def_{—}2( ) Bool)
(declare-fun t141_val_{—}2( ) Real)
(assert t141_def_{—}2)
(assert (=t141_val_{—}2 1.0))
(declare-fun t141_def_{—}3( ) Bool)
(declare-fun t141_val_{—}3( ) Real)
(assert t141_def_{—}3)
(assert (=t141_val_{—}3 1.0))
(declare-fun t141_def_{—}4( ) Bool)
(declare-fun t141_val_{—}4( ) Real)
(assert t141_def_{—}4)
(assert (=t141_val_{—}4 1.0))
(declare-fun t141_def_{—}5( ) Bool)
(declare-fun t141_val_{—}5( ) Real)
(assert t141_def_{—}5)
(assert (=t141 val_{—}5 1.0))
(declare-fun t141_def_{—}6( ) Bool)
(declare-fun t141_val_{—}6( ) Real)
(assert t141_def_{—}6)
(assert (=t141_val_{—}6 1.0))
(declare-fun t141_def_{—}7( ) Bool)
(declare-fun t141_val_{—}7( ) Real)
(assert t141_def_{—}7)
(assert (=t141_val_{—}7 1.0))
(declare-fun t141_def_{—}8( ) Bool)
(declare-fun t141_val_{—}8( ) Real)
(assert t141_def_{—}8)
(assert (=t141_val_{—}8 1.0))
(declare-fun t141_def_{—}9( ) Bool)
(declare-fun t141_val_{—}9( ) Real)
(assert t141_def_{—}9)
(assert (=t141_val_{—}9 1.0))
(declare-fun t142_def_{—}1( ) Bool)
(declare-fun t142_val_{—}1( ) Real)
(assert t142_def_{—}1)
(assert (=t142_val_{—}1 1.0))
(declare-fun t142_def_{—}2( ) Bool)
(declare-fun t142_val_{—}2( ) Real)
(assert t142_def_{—}2)
(assert (=t142_val_{—}2 1.0))
(declare-fun t142_def_{—}3( ) Bool)
(declare-fun t142_val_{—}3( ) Real)
(assert t142_def_{—}3)
(assert (=t142_val_{—}3 1.0))
(declare-fun t142_def_{—}4( ) Bool)
(declare-fun t142_val_{—}4( ) Real)
(assert t142_def_{—}4)
(assert (=t142_val_{—}4 1.0))
(declare-fun t142_def_{—}5( ) Bool)
(declare-fun t142_val_{—}5( ) Real)
(assert t142_def_{—}5)
(assert (=t142_val_{—}5 1.0))
(declare-fun t142_def_{—}6( ) Bool)
(declare-fun t142_val_{—}6( ) Real)
(assert t142_def_{—}6)
(assert (=t142_val_{—}6 1.0))
(declare-fun t142_def_{—}7( ) Bool)
(declare-fun t142_val_{—}7( ) Real)
(assert t142_def_{—}7)
(assert (=t142_val_{—}7 1.0))
(declare-fun t142_def_{—}8( ) Bool)
(declare-fun t142_val_{—}8( ) Real)
(assert t142_def_{—}8)
(assert (=t142_val_{—}8 1.0))
(declare-fun t142_def_{—}9( ) Bool)
(declare-fun t142_val_{—}9( ) Real)
(assert t142_def_{—}9)
(assert (=t142_val_{—}9 1.0))
(declare-fun t143_def_{—}1( ) Bool)
(declare-fun t143_val_{—}1( ) Real)
(assert t143_def_{—}1)
(assert (=t143_val_{—}1 0.0))
(declare-fun t143_def_{—}2( ) Bool)
(declare-fun t143_val_{—}2( ) Real)
(assert t143_def_{—}2)
(assert (=t143_val_{—}2 0.0))
(declare-fun t143_def_{—}3( ) Bool)
(declare-fun t143_val_{—}3( ) Real)
(assert t143_def_{—}3)
(assert (=t143_val_{—}3 0.0))
(declare-fun t143_def_{—}4( ) Bool)
(declare-fun t143_val_{—}4( ) Real)
(assert t143_def_{—}4)
(assert (=t143_val_{—}4 0.0))
(declare-fun t143_def_{—}5( ) Bool)
(declare-fun t143_val_{—}5( ) Real)
(assert t143_def_{—}5)
(assert (=t143_val_{—}5 0.0))
(declare-fun t143_def_{—}6( ) Bool)
(declare-fun t143_val_{—}6( ) Real)
(assert t143_def_{—}6)
(assert (=t143_val_{—}6 0.0))
(declare-fun t143_def_{—}7( ) Bool)
(declare-fun t143_val_{—}7( ) Real)
(assert t143_def_{—}7)
(assert (=t143_val_{—}7 0.0))
(declare-fun t143_def_{—}8( ) Bool)
(declare-fun t143_val_{—}8( ) Real)
(assert t143_def_{—}8)
(assert (=t143_val_{—}8 0.0))
(declare-fun t143_def_{—}9( ) Bool)
(declare-fun t143_val_{—}9( ) Real)
(assert t143_def_{—}9)
(assert (=t143_val_{—}9 0.0))
(declare-fun t144_def_{—}1( ) Bool)
(declare-fun t144_val_{—}1( ) Real)
(declare-fun var2a_{—}1( ) Real)
(assert (=var2a_{—}1 t144_val_{—}1))
(declare-fun t144_def_{—}2( ) Bool)
(declare-fun t144_val_{—}2( ) Real)
(declare-fun var2a_{—}2( ) Real)
(assert (=var2a_{—}2 t144_val_{—}2))
(declare-fun t144_def_{—}3( ) Bool)
(declare-fun t144_val_{—}3( ) Real)
(declare-fun var2a_{—}3( ) Real)
(assert (=var2a_{—}3 t144_val_{—}3))
(declare-fun t144_def_{—}4( ) Bool)
(declare-fun t144_val_{—}4( ) Real)
(declare-fun var2a_{—}4( ) Real)
(assert (=var2a_{—}4 t144_val_{—}4))
(declare-fun t144_def_{—}5( ) Bool)
(declare-fun t144_val_{—}5( ) Real)
(declare-fun var2a_{—}5( ) Real)
(assert (=var2a_{—}5 t144_val_{—}5))
(declare-fun t144_def_{—}6( ) Bool)
(declare-fun t144_val_{—}6( ) Real)
(declare-fun var2a_{—}6( ) Real)
(assert (=var2a_{—}6 t144_val_{—}6))
(declare-fun t144_def_{—}7( ) Bool)
(declare-fun t144_val_{—}7( ) Real)
(declare-fun var2a_{—}7( ) Real)
(assert (=var2a_{—}7 t144_val_{—}7))
(declare-fun t144_def_{—}8( ) Bool)
(declare-fun t144_val_{—}8( ) Real)
(declare-fun var2a_{—}8( ) Real)
(assert (=var2a_{—}8 t144_val_{—}8))
(declare-fun t144_def_{—}9( ) Bool)
(declare-fun t144_val_{—}9( ) Real)
(declare-fun var2a_{—}9( ) Real)
(assert (=var2a_{—}9 t144_val_{—}9))
(assert (implies (and (and t139_def_{—}1 (>=t139_val_{—}1 0.0)) (not t140_def_{—}1))(not t144_def_{—}1)))
(assert (implies (and (and (and (>=t139_val_{—}1 0.0) t139_def_{—}1)(and (>=t140_val_{—}1 0.0) t140_def_{—}1)) t141_def_{—}1) (and t144_def_{—}1 (=t144_val_{—}1 (*t140_val_{—}1 t141_val_{—}1)))))
(assert (implies (and (and (and (>=t139_val_{—}1 0.0) t139_def_{—}1)(and (>=t140_val_{—}1 0.0) t140_def_{—}1)) (not t141_def_{—}1)) (not t144_def_{—}1)))
(assert (implies (and (and (and (>=t139_val_{—}1 0.0) t139_def_{—}1)(and (<t140_val_{—}1 0.0) t140_def_{—}1)) t142_def_{—}1) (and t144_def_{—}1 (=t144_val_{—}1 (*t140_val_{—}1 t142_val_{—}1)))))
(assert (implies (and (and (and (>=t139_val_{—}1 0.0) t139_def_{—}1)(and (<t140_val_{—}1 0.0) t140_def_{—}1)) (not t142_def_{—}1)) (not t144_def_{—}1)))
(assert (implies (and (and (>=t139_val_{—}1 0.0) t139_def_{—}1) (not t140_def_{—}1))(not t144_def_{—}1)))
(assert (implies (and (and (<t139_val_{—}1 0.0) t139_def_{—}1) t143_def_{—}1)(and t144_def_{—}1 (=t144_val_{—}1 t143_val_{—}1))))
(assert (implies (and (and (<t139_val_{—}1 0.0) t139_def_{—}1) (not t143_def_{—}1))(not t144_def_{—}1)))
(assert (implies (not t139_def_{—}1) (not t144_def_{—}1)))
(assert (implies (and (and t139_def_{—}2 (>=t139_val_{—}2 0.0)) (not t140_def_{—}2))(not t144_def_{—}2)))
(assert (implies (and (and (and (>=t139_val_{—}2 0.0) t139_def_{—}2)(and (>=t140_val_{—}2 0.0) t140_def_{—}2)) t141_def_{—}2) (and t144_def_{—}2 (=t144_val_{—}2 (*t140_val_{—}2 t141_val_{—}2)))))
(assert (implies (and (and (and (>=t139_val_{—}2 0.0) t139_def_{—}2)(and (>=t140_val_{—}2 0.0) t140_def_{—}2)) (not t141_def_{—}2)) (not t144_def_{—}2)))
(assert (implies (and (and (and (>=t139_val_{—}2 0.0) t139_def_{—}2)(and (<t140_val_{—}2 0.0) t140_def_{—}2)) t142_def_{—}2) (and t144_def_{—}2 (=t144_val_{—}2 (*t140_val_{—}2 t142_val_{—}2)))))
(assert (implies (and (and (and (>=t139_val_{—}2 0.0) t139_def_{—}2)(and (<t140_val_{—}2 0.0) t140_def_{—}2)) (not t142_def_{—}2)) (not t144_def_{—}2)))
(assert (implies (and (and (>=t139_val_{—}2 0.0) t139_def_{—}2) (not t140_def_{—}2))(not t144_def_{—}2)))
(assert (implies (and (and (<t139_val_{—}2 0.0) t139_def_{—}2) t143_def_{—}2)(and t144_def_{—}2 (=t144_val_{—}2 t143_val_{—}2))))
(assert (implies (and (and (<t139_val_{—}2 0.0) t139_def_{—}2) (not t143_def_{—}2))(not t144_def_{—}2)))
(assert (implies (not t139_def_{—}2) (not t144_def_{—}2)))
(assert (implies (and (and t139_def_{—}3 (>=t139_val_{—}3 0.0)) (not t140_def_{—}3))(not t144_def_{—}3)))
(assert (implies (and (and (and (>=t139_val_{—}3 0.0) t139_def_{—}3)(and (>=t140_val_{—}3 0.0) t140_def_{—}3)) t141_def_{—}3) (and t144_def_{—}3 (=t144_val_{—}3 (*t140_val_{—}3 t141_val_{—}3)))))
(assert (implies (and (and (and (>=t139_val_{—}3 0.0) t139_def_{—}3)(and (>=t140_val_{—}3 0.0) t140_def_{—}3)) (not t141_def_{—}3)) (not t144_def_{—}3)))
(assert (implies (and (and (and (>=t139_val_{—}3 0.0) t139_def_{—}3)(and (<t140_val_{—}3 0.0) t140_def_{—}3)) t142_def_{—}3) (and t144_def_{—}3 (=t144_val_{—}3 (*t140_val_{—}3 t142_val_{—}3)))))
(assert (implies (and (and (and (>=t139_val_{—}3 0.0) t139_def_{—}3)(and (<t140_val_{—}3 0.0) t140_def_{—}3)) (not t142_def_{—}3)) (not t144_def_{—}3)))
(assert (implies (and (and (>=t139_val_{—}3 0.0) t139_def_{—}3) (not t140_def_{—}3))(not t144_def_{—}3)))
(assert (implies (and (and (<t139_val_{—}3 0.0) t139_def_{—}3) t143_def_{—}3)(and t144_def_{—}3 (=t144_val_{—}3 t143_val_{—}3))))
(assert (implies (and (and (<t139_val_{—}3 0.0) t139_def_{—}3) (not t143_def_{—}3))(not t144_def_{—}3)))
(assert (implies (not t139_def_{—}3) (not t144_def_{—}3)))
(assert (implies (and (and t139_def_{—}4 (>=t139_val_{—}4 0.0)) (not t140_def_{—}4))(not t144_def_{—}4)))
(assert (implies (and (and (and (>=t139_val_{—}4 0.0) t139_def_{—}4)(and (>=t140_val_{—}4 0.0) t140_def_{—}4)) t141_def_{—}4) (and t144_def_{—}4 (=t144_val_{—}4 (*t140_val_{—}4 t141_val_{—}4)))))
(assert (implies (and (and (and (>=t139_val_{—}4 0.0) t139_def_{—}4)(and (>=t140_val_{—}4 0.0) t140_def_{—}4)) (not t141_def_{—}4)) (not t144_def_{—}4)))
(assert (implies (and (and (and (>=t139_val_{—}4 0.0) t139_def_{—}4)(and (<t140_val_{—}4 0.0) t140_def_{—}4)) t142_def_{—}4) (and t144_def_{—}4 (=t144_val_{—}4 (*t140_val_{—}4 t142_val_{—}4)))))
(assert (implies (and (and (and (>=t139_val_{—}4 0.0) t139_def_{—}4)(and (<t140_val_{—}4 0.0) t140_def_{—}4)) (not t142_def_{—}4)) (not t144_def_{—}4)))
(assert (implies (and (and (>=t139_val_{—}4 0.0) t139_def_{—}4) (not t140_def_{—}4))(not t144_def_{—}4)))
(assert (implies (and (and (<t139_val_{—}4 0.0) t139_def_{—}4) t143_def_{—}4)(and t144_def_{—}4 (=t144_val_{—}4 t143_val_{—}4))))
(assert (implies (and (and (<t139_val_{—}4 0.0) t139_def_{—}4) (not t143_def_{—}4))(not t144_def_{—}4)))
(assert (implies (not t139_def_{—}4) (not t144_def_{—}4)))
(assert (implies (and (and t139_def_{—}5 (>=t139_val_{—}5 0.0)) (not t140_def_{—}5))(not t144_def_{—}5)))
(assert (implies (and (and (and (>=t139_val_{—}5 0.0) t139_def_{—}5)(and (>=t140_val_{—}5 0.0) t140_def_{—}5)) t141_def_{—}5) (and t144_def_{—}5 (=t144_val_{—}5 (*t140_val_{—}5 t141_val_{—}5)))))
(assert (implies (and (and (and (>=t139_val_{—}5 0.0) t139_def_{—}5)(and (>=t140_val_{—}5 0.0) t140_def_{—}5)) (not t141_def_{—}5)) (not t144_def_{—}5)))
(assert (implies (and (and (and (>=t139_val_{—}5 0.0) t139_def_{—}5)(and (<t140_val_{—}5 0.0) t140_def_{—}5)) t142_def_{—}5) (and t144_def_{—}5 (=t144_val_{—}5 (*t140_val_{—}5 t142_val_{—}5)))))
(assert (implies (and (and (and (>=t139_val_{—}5 0.0) t139_def_{—}5)(and (<t140_val_{—}5 0.0) t140_def_{—}5)) (not t142_def_{—}5)) (not t144_def_{—}5)))
(assert (implies (and (and (>=t139_val_{—}5 0.0) t139_def_{—}5) (not t140_def_{—}5))(not t144_def_{—}5)))
(assert (implies (and (and (<t139_val_{—}5 0.0) t139_def_{—}5) t143_def_{—}5)(and t144_def_{—}5 (=t144_val_{—}5 t143_val_{—}5))))
(assert (implies (and (and (<t139_val_{—}5 0.0) t139_def_{—}5) (not t143_def_{—}5))(not t144_def_{—}5)))
(assert (implies (not t139_def_{—}5) (not t144_def_{—}5)))
(assert (implies (and (and t139_def_{—}6 (>=t139_val_{—}6 0.0)) (not t140_def_{—}6))(not t144_def_{—}6)))
(assert (implies (and (and (and (>=t139_val_{—}6 0.0) t139_def_{—}6)(and (>=t140_val_{—}6 0.0) t140_def_{—}6)) t141_def_{—}6) (and t144_def_{—}6 (=t144_val_{—}6 (*t140_val_{—}6 t141_val_{—}6)))))
(assert (implies (and (and (and (>=t139_val_{—}6 0.0) t139_def_{—}6)(and (>=t140_val_{—}6 0.0) t140_def_{—}6)) (not t141_def_{—}6)) (not t144_def_{—}6)))
(assert (implies (and (and (and (>=t139_val_{—}6 0.0) t139_def_{—}6)(and (<t140_val_{—}6 0.0) t140_def_{—}6)) t142_def_{—}6) (and t144_def_{—}6 (=t144_val_{—}6 (*t140_val_{—}6 t142_val_{—}6)))))
(assert (implies (and (and (and (>=t139_val_{—}6 0.0) t139_def_{—}6)(and (<t140_val_{—}6 0.0) t140_def_{—}6)) (not t142_def_{—}6)) (not t144_def_{—}6)))
(assert (implies (and (and (>=t139_val_{—}6 0.0) t139_def_{—}6) (not t140_def_{—}6))(not t144_def_{—}6)))
(assert (implies (and (and (<t139_val_{—}6 0.0) t139_def_{—}6) t143_def_{—}6)(and t144_def_{—}6 (=t144_val_{—}6 t143_val_{—}6))))
(assert (implies (and (and (<t139_val_{—}6 0.0) t139_def_{—}6) (not t143_def_{—}6))(not t144_def_{—}6)))
(assert (implies (not t139_def_{—}6) (not t144_def_{—}6)))
(assert (implies (and (and t139_def_{—}7 (>=t139_val_{—}7 0.0)) (not t140_def_{—}7))(not t144_def_{—}7)))
(assert (implies (and (and (and (>=t139_val_{—}7 0.0) t139_def_{—}7)(and (>=t140_val_{—}7 0.0) t140_def_{—}7)) t141_def_{—}7) (and t144_def_{—}7 (=t144_val_{—}7 (*t140_val_{—}7 t141_val_{—}7)))))
(assert (implies (and (and (and (>=t139_val_{—}7 0.0) t139_def_{—}7)(and (>=t140_val_{—}7 0.0) t140_def_{—}7)) (not t141_def_{—}7)) (not t144_def_{—}7)))
(assert (implies (and (and (and (>=t139_val_{—}7 0.0) t139_def_{—}7)(and (<t140_val_{—}7 0.0) t140_def_{—}7)) t142_def_{—}7) (and t144_def_{—}7 (=t144_val_{—}7 (*t140_val_{—}7 t142_val_{—}7)))))
(assert (implies (and (and (and (>=t139_val_{—}7 0.0) t139_def_{—}7)(and (<t140_val_{—}7 0.0) t140_def_{—}7)) (not t142_def_{—}7)) (not t144_def_{—}7)))
(assert (implies (and (and (>=t139_val_{—}7 0.0) t139_def_{—}7) (not t140_def_{—}7))(not t144_def_{—}7)))
(assert (implies (and (and (<t139_val_{—}7 0.0) t139_def_{—}7) t143_def_{—}7)(and t144_def_{—}7 (=t144_val_{—}7 t143_val_{—}7))))
(assert (implies (and (and (<t139_val_{—}7 0.0) t139_def_{—}7) (not t143_def_{—}7))(not t144_def_{—}7)))
(assert (implies (not t139_def_{—}7) (not t144_def_{—}7)))
(assert (implies (and (and t139_def_{—}8 (>=t139_val_{—}8 0.0)) (not t140_def_{—}8))(not t144_def_{—}8)))
(assert (implies (and (and (and (>=t139_val_{—}8 0.0) t139_def_{—}8)(and (>=t140_val_{—}8 0.0) t140_def_{—}8)) t141_def_{—}8) (and t144_def_{—}8 (=t144_val_{—}8 (*t140_val_{—}8 t141_val_{—}8)))))
(assert (implies (and (and (and (>=t139_val_{—}8 0.0) t139_def_{—}8)(and (>=t140_val_{—}8 0.0) t140_def_{—}8)) (not t141_def_{—}8)) (not t144_def_{—}8)))
(assert (implies (and (and (and (>=t139_val_{—}8 0.0) t139_def_{—}8)(and (<t140_val_{—}8 0.0) t140_def_{—}8)) t142_def_{—}8) (and t144_def_{—}8 (=t144_val_{—}8 (*t140_val_{—}8 t142_val_{—}8)))))
(assert (implies (and (and (and (>=t139_val_{—}8 0.0) t139_def_{—}8)(and (<t140_val_{—}8 0.0) t140_def_{—}8)) (not t142_def_{—}8)) (not t144_def_{—}8)))
(assert (implies (and (and (>=t139_val_{—}8 0.0) t139_def_{—}8) (not t140_def_{—}8))(not t144_def_{—}8)))
(assert (implies (and (and (<t139_val_{—}8 0.0) t139_def_{—}8) t143_def_{—}8)(and t144_def_{—}8 (=t144_val_{—}8 t143_val_{—}8))))
(assert (implies (and (and (<t139_val_{—}8 0.0) t139_def_{—}8) (not t143_def_{—}8))(not t144_def_{—}8)))
(assert (implies (not t139_def_{—}8) (not t144_def_{—}8)))
(assert (implies (and (and t139_def_{—}9 (>=t139_val_{—}9 0.0)) (not t140_def_{—}9))(not t144_def_{—}9)))
(assert (implies (and (and (and (>=t139_val_{—}9 0.0) t139_def_{—}9)(and (>=t140_val_{—}9 0.0) t140_def_{—}9)) t141_def_{—}9) (and t144_def_{—}9 (=t144_val_{—}9 (*t140_val_{—}9 t141_val_{—}9)))))
(assert (implies (and (and (and (>=t139_val_{—}9 0.0) t139_def_{—}9)(and (>=t140_val_{—}9 0.0) t140_def_{—}9)) (not t141_def_{—}9)) (not t144_def_{—}9)))
(assert (implies (and (and (and (>=t139_val_{—}9 0.0) t139_def_{—}9)(and (<t140_val_{—}9 0.0) t140_def_{—}9)) t142_def_{—}9) (and t144_def_{—}9 (=t144_val_{—}9 (*t140_val_{—}9 t142_val_{—}9)))))
(assert (implies (and (and (and (>=t139_val_{—}9 0.0) t139_def_{—}9)(and (<t140_val_{—}9 0.0) t140_def_{—}9)) (not t142_def_{—}9)) (not t144_def_{—}9)))
(assert (implies (and (and (>=t139_val_{—}9 0.0) t139_def_{—}9) (not t140_def_{—}9))(not t144_def_{—}9)))
(assert (implies (and (and (<t139_val_{—}9 0.0) t139_def_{—}9) t143_def_{—}9)(and t144_def_{—}9 (=t144_val_{—}9 t143_val_{—}9))))
(assert (implies (and (and (<t139_val_{—}9 0.0) t139_def_{—}9) (not t143_def_{—}9))(not t144_def_{—}9)))
(assert (implies (not t139_def_{—}9) (not t144_def_{—}9)))
(declare-fun t145_def_{—}1( ) Bool)
(declare-fun t145_val_{—}1( ) Real)
(assert t145_def_{—}1)
(assert (=t145_val_{—}1 1.0))
(declare-fun t145_def_{—}2( ) Bool)
(declare-fun t145_val_{—}2( ) Real)
(assert t145_def_{—}2)
(assert (=t145_val_{—}2 1.0))
(declare-fun t145_def_{—}3( ) Bool)
(declare-fun t145_val_{—}3( ) Real)
(assert t145_def_{—}3)
(assert (=t145_val_{—}3 1.0))
(declare-fun t145_def_{—}4( ) Bool)
(declare-fun t145_val_{—}4( ) Real)
(assert t145_def_{—}4)
(assert (=t145_val_{—}4 1.0))
(declare-fun t145_def_{—}5( ) Bool)
(declare-fun t145_val_{—}5( ) Real)
(assert t145_def_{—}5)
(assert (=t145_val_{—}5 1.0))
(declare-fun t145_def_{—}6( ) Bool)
(declare-fun t145_val_{—}6( ) Real)
(assert t145_def_{—}6)
(assert (=t145_val_{—}6 1.0))
(declare-fun t145_def_{—}7( ) Bool)
(declare-fun t145_val_{—}7( ) Real)
(assert t145_def_{—}7)
(assert (=t145_val_{—}7 1.0))
(declare-fun t145_def_{—}8( ) Bool)
(declare-fun t145_val_{—}8( ) Real)
(assert t145_def_{—}8)
(assert (=t145_val_{—}8 1.0))
(declare-fun t145_def_{—}9( ) Bool)
(declare-fun t145_val_{—}9( ) Real)
(assert t145_def_{—}9)
(assert (=t145_val_{—}9 1.0))
(declare-fun t146_def_{—}1_{—}1( ) Bool)
(declare-fun t146_val_{—}1_{—}1( ) Real)
(declare-fun t146_def_{—}2_{—}1( ) Bool)
(declare-fun t146_val_{—}2_{—}1( ) Real)
(declare-fun t146_def_{—}3_{—}1( ) Bool)
(declare-fun t146_val_{—}3_{—}1( ) Real)
(declare-fun t146_def_{—}1_{—}2( ) Bool)
(declare-fun t146_val_{—}1_{—}2( ) Real)
(declare-fun t146_def_{—}2_{—}2( ) Bool)
(declare-fun t146_val_{—}2_{—}2( ) Real)
(declare-fun t146_def_{—}3_{—}2( ) Bool)
(declare-fun t146_val_{—}3_{—}2( ) Real)
(declare-fun t146_def_{—}1_{—}3( ) Bool)
(declare-fun t146_val_{—}1_{—}3( ) Real)
(declare-fun t146_def_{—}2_{—}3( ) Bool)
(declare-fun t146_val_{—}2_{—}3( ) Real)
(declare-fun t146_def_{—}3_{—}3( ) Bool)
(declare-fun t146_val_{—}3_{—}3( ) Real)
(declare-fun t146_def_{—}1_{—}4( ) Bool)
(declare-fun t146_val_{—}1_{—}4( ) Real)
(declare-fun t146_def_{—}2_{—}4( ) Bool)
(declare-fun t146_val_{—}2_{—}4( ) Real)
(declare-fun t146_def_{—}3_{—}4( ) Bool)
(declare-fun t146_val_{—}3_{—}4( ) Real)
(declare-fun t146_def_{—}1_{—}5( ) Bool)
(declare-fun t146_val_{—}1_{—}5( ) Real)
(declare-fun t146_def_{—}2_{—}5( ) Bool)
(declare-fun t146_val_{—}2_{—}5( ) Real)
(declare-fun t146_def_{—}3_{—}5( ) Bool)
(declare-fun t146_val_{—}3_{—}5( ) Real)
(declare-fun t146_def_{—}1_{—}6( ) Bool)
(declare-fun t146_val_{—}1_{—}6( ) Real)
(declare-fun t146_def_{—}2_{—}6( ) Bool)
(declare-fun t146_val_{—}2_{—}6( ) Real)
(declare-fun t146_def_{—}3_{—}6( ) Bool)
(declare-fun t146_val_{—}3_{—}6( ) Real)
(declare-fun t146_def_{—}1_{—}7( ) Bool)
(declare-fun t146_val_{—}1_{—}7( ) Real)
(declare-fun t146_def_{—}2_{—}7( ) Bool)
(declare-fun t146_val_{—}2_{—}7( ) Real)
(declare-fun t146_def_{—}3_{—}7( ) Bool)
(declare-fun t146_val_{—}3_{—}7( ) Real)
(declare-fun t146_def_{—}1_{—}8( ) Bool)
(declare-fun t146_val_{—}1_{—}8( ) Real)
(declare-fun t146_def_{—}2_{—}8( ) Bool)
(declare-fun t146_val_{—}2_{—}8( ) Real)
(declare-fun t146_def_{—}3_{—}8( ) Bool)
(declare-fun t146_val_{—}3_{—}8( ) Real)
(declare-fun t146_def_{—}1_{—}9( ) Bool)
(declare-fun t146_val_{—}1_{—}9( ) Real)
(declare-fun t146_def_{—}2_{—}9( ) Bool)
(declare-fun t146_val_{—}2_{—}9( ) Real)
(declare-fun t146_def_{—}3_{—}9( ) Bool)
(declare-fun t146_val_{—}3_{—}9( ) Real)
(assert (not t146_def_{—}1_{—}1))
(assert (not t146_def_{—}2_{—}1))
(assert (not t146_def_{—}3_{—}1))
(assert (not t146_def_{—}1_{—}2))
(assert (not t146_def_{—}2_{—}2))
(assert (not t146_def_{—}3_{—}2))
(assert (not t146_def_{—}1_{—}3))
(assert (not t146_def_{—}2_{—}3))
(assert (not t146_def_{—}3_{—}3))
(assert (implies t133_def_{—}1 t146_def_{—}1_{—}4))
(assert (implies (not t133_def_{—}1) (not t146_def_{—}1_{—}4)))
(assert (implies t133_def_{—}1 (=t146_val_{—}1_{—}4 t133_val_{—}1)))
(assert (implies (and (not t146_def_{—}1_{—}4) (not t133_def_{—}2)) (not t146_def_{—}2_{—}4)))
(assert (implies (and (not t146_def_{—}1_{—}4) t133_def_{—}2) (and t146_def_{—}2_{—}4 (=t146_val_{—}2_{—}4 t133_val_{—}2))))
(assert (implies (and t146_def_{—}1_{—}4 (not t133_def_{—}2)) (and t146_def_{—}2_{—}4 (=t146_val_{—}2_{—}4 t146_val_{—}1_{—}4))))
(assert (implies (and (and t146_def_{—}1_{—}4 t133_def_{—}2) (<t133_val_{—}2 t146_val_{—}1_{—}4)) (and t146_def_{—}2_{—}4 (=t146_val_{—}2_{—}4 t133_val_{—}2))))
(assert (implies (and (and t146_def_{—}1_{—}4 t133_def_{—}2) (>=t133_val_{—}2 t146_val_{—}1_{—}4)) (and t146_def_{—}2_{—}4 (=t146_val_{—}2_{—}4 t146_val_{—}1_{—}4))))
(assert (implies (and (not t146_def_{—}2_{—}4) (not t133_def_{—}3)) (not t146_def_{—}3_{—}4)))
(assert (implies (and (not t146_def_{—}2_{—}4) t133_def_{—}3) (and t146_def_{—}3_{—}4 (=t146_val_{—}3_{—}4 t133_val_{—}3))))
(assert (implies (and t146_def_{—}2_{—}4 (not t133_def_{—}3)) (and t146_def_{—}3_{—}4 (=t146_val_{—}3_{—}4 t146_val_{—}2_{—}4))))
(assert (implies (and (and t146_def_{—}2_{—}4 t133_def_{—}3) (<t133_val_{—}3 t146_val_{—}2_{—}4)) (and t146_def_{—}3_{—}4 (=t146_val_{—}3_{—}4 t133_val_{—}3))))
(assert (implies (and (and t146_def_{—}2_{—}4 t133_def_{—}3) (>=t133_val_{—}3 t146_val_{—}2_{—}4)) (and t146_def_{—}3_{—}4 (=t146_val_{—}3_{—}4 t146_val_{—}2_{—}4))))
(assert (implies t133_def_{—}2 t146_def_{—}1_{—}5))
(assert (implies (not t133_def_{—}2) (not t146_def_{—}1_{—}5)))
(assert (implies t133_def_{—}2 (=t146_val_{—}1_{—}5 t133_val_{—}2)))
(assert (implies (and (not t146_def_{—}1_{—}5) (not t133_def_{—}3)) (not t146_def_{—}2_{—}5)))
(assert (implies (and (not t146_def_{—}1_{—}5) t133_def_{—}3) (and t146_def_{—}2_{—}5 (=t146_val_{—}2_{—}5 t133_val_{—}3))))
(assert (implies (and t146_def_{—}1_{—}5 (not t133_def_{—}3)) (and t146_def_{—}2_{—}5 (=t146_val_{—}2_{—}5 t146_val_{—}1_{—}5))))
(assert (implies (and (and t146_def_{—}1_{—}5 t133_def_{—}3) (<t133_val_{—}3 t146_val_{—}1_{—}5)) (and t146_def_{—}2_{—}5 (=t146_val_{—}2_{—}5 t133_val_{—}3))))
(assert (implies (and (and t146_def_{—}1_{—}5 t133_def_{—}3) (>=t133_val_{—}3 t146_val_{—}1_{—}5)) (and t146_def_{—}2_{—}5 (=t146_val_{—}2_{—}5 t146_val_{—}1_{—}5))))
(assert (implies (and (not t146_def_{—}2_{—}5) (not t133_def_{—}4)) (not t146_def_{—}3_{—}5)))
(assert (implies (and (not t146_def_{—}2_{—}5) t133_def_{—}4) (and t146_def_{—}3_{—}5 (=t146_val_{—}3_{—}5 t133_val_{—}4))))
(assert (implies (and t146_def_{—}2_{—}5 (not t133_def_{—}4)) (and t146_def_{—}3_{—}5 (=t146_val_{—}3_{—}5 t146_val_{—}2_{—}5))))
(assert (implies (and (and t146_def_{—}2_{—}5 t133_def_{—}4) (<t133_val_{—}4 t146_val_{—}2_{—}5)) (and t146_def_{—}3_{—}5 (=t146_val_{—}3_{—}5 t133_val_{—}4))))
(assert (implies (and (and t146_def_{—}2_{—}5 t133_def_{—}4) (>=t133_val_{—}4 t146_val_{—}2_{—}5)) (and t146_def_{—}3_{—}5 (=t146_val_{—}3_{—}5 t146_val_{—}2_{—}5))))
(assert (implies t133_def_{—}3 t146_def_{—}1_{—}6))
(assert (implies (not t133_def_{—}3) (not t146_def_{—}1_{—}6)))
(assert (implies t133_def_{—}3 (=t146_val_{—}1_{—}6 t133_val_{—}3)))
(assert (implies (and (not t146_def_{—}1_{—}6) (not t133_def_{—}4)) (not t146_def_{—}2_{—}6)))
(assert (implies (and (not t146_def_{—}1_{—}6) t133_def_{—}4) (and t146_def_{—}2_{—}6 (=t146_val_{—}2_{—}6 t133_val_{—}4))))
(assert (implies (and t146_def_{—}1_{—}6 (not t133_def_{—}4)) (and t146_def_{—}2_{—}6 (=t146_val_{—}2_{—}6 t146_val_{—}1_{—}6))))
(assert (implies (and (and t146_def_{—}1_{—}6 t133_def_{—}4) (<t133_val_{—}4 t146_val_{—}1_{—}6)) (and t146_def_{—}2_{—}6 (=t146_val_{—}2_{—}6 t133_val_{—}4))))
(assert (implies (and (and t146_def_{—}1_{—}6 t133_def_{—}4) (>=t133_val_{—}4 t146_val_{—}1_{—}6)) (and t146_def_{—}2_{—}6 (=t146_val_{—}2_{—}6 t146_val_{—}1_{—}6))))
(assert (implies (and (not t146_def_{—}2_{—}6) (not t133_def_{—}5)) (not t146_def_{—}3_{—}6)))
(assert (implies (and (not t146_def_{—}2_{—}6) t133_def_{—}5) (and t146_def_{—}3_{—}6 (=t146_val_{—}3_{—}6 t133_val_{—}5))))
(assert (implies (and t146_def_{—}2_{—}6 (not t133_def_{—}5)) (and t146_def_{—}3_{—}6 (=t146_val_{—}3_{—}6 t146_val_{—}2_{—}6))))
(assert (implies (and (and t146_def_{—}2_{—}6 t133_def_{—}5) (<t133_val_{—}5 t146_val_{—}2_{—}6)) (and t146_def_{—}3_{—}6 (=t146_val_{—}3_{—}6 t133_val_{—}5))))
(assert (implies (and (and t146_def_{—}2_{—}6 t133_def_{—}5) (>=t133_val_{—}5 t146_val_{—}2_{—}6)) (and t146_def_{—}3_{—}6 (=t146_val_{—}3_{—}6 t146_val_{—}2_{—}6))))
(assert (implies t133_def_{—}4 t146_def_{—}1_{—}7))
(assert (implies (not t133_def_{—}4) (not t146_def_{—}1_{—}7)))
(assert (implies t133_def_{—}4 (=t146_val_{—}1_{—}7 t133_val_{—}4)))
(assert (implies (and (not t146_def_{—}1_{—}7) (not t133_def_{—}5)) (not t146_def_{—}2_{—}7)))
(assert (implies (and (not t146_def_{—}1_{—}7) t133_def_{—}5) (and t146_def_{—}2_{—}7 (=t146_val_{—}2_{—}7 t133_val_{—}5))))
(assert (implies (and t146_def_{—}1_{—}7 (not t133_def_{—}5)) (and t146_def_{—}2_{—}7 (=t146_val_{—}2_{—}7 t146_val_{—}1_{—}7))))
(assert (implies (and (and t146_def_{—}1_{—}7 t133_def_{—}5) (<t133_val_{—}5 t146_val_{—}1_{—}7)) (and t146_def_{—}2_{—}7 (=t146_val_{—}2_{—}7 t133_val_{—}5))))
(assert (implies (and (and t146_def_{—}1_{—}7 t133_def_{—}5) (>=t133_val_{—}5 t146_val_{—}1_{—}7)) (and t146_def_{—}2_{—}7 (=t146_val_{—}2_{—}7 t146_val_{—}1_{—}7))))
(assert (implies (and (not t146_def_{—}2_{—}7) (not t133_def_{—}6)) (not t146_def_{—}3_{—}7)))
(assert (implies (and (not t146_def_{—}2_{—}7) t133_def_{—}6) (and t146_def_{—}3_{—}7 (=t146_val_{—}3_{—}7 t133_val_{—}6))))
(assert (implies (and t146_def_{—}2_{—}7 (not t133_def_{—}6)) (and t146_def_{—}3_{—}7 (=t146_val_{—}3_{—}7 t146_val_{—}2_{—}7))))
(assert (implies (and (and t146_def_{—}2_{—}7 t133_def_{—}6) (<t133_val_{—}6 t146_val_{—}2_{—}7)) (and t146_def_{—}3_{—}7 (=t146_val_{—}3_{—}7 t133_val_{—}6))))
(assert (implies (and (and t146_def_{—}2_{—}7 t133_def_{—}6) (>=t133_val_{—}6 t146_val_{—}2_{—}7)) (and t146_def_{—}3_{—}7 (=t146_val_{—}3_{—}7 t146_val_{—}2_{—}7))))
(assert (implies t133_def_{—}5 t146_def_{—}1_{—}8))
(assert (implies (not t133_def_{—}5) (not t146_def_{—}1_{—}8)))
(assert (implies t133_def_{—}5 (=t146_val_{—}1_{—}8 t133_val_{—}5)))
(assert (implies (and (not t146_def_{—}1_{—}8) (not t133_def_{—}6)) (not t146_def_{—}2_{—}8)))
(assert (implies (and (not t146_def_{—}1_{—}8) t133_def_{—}6) (and t146_def_{—}2_{—}8 (=t146_val_{—}2_{—}8 t133_val_{—}6))))
(assert (implies (and t146_def_{—}1_{—}8 (not t133_def_{—}6)) (and t146_def_{—}2_{—}8 (=t146_val_{—}2_{—}8 t146_val_{—}1_{—}8))))
(assert (implies (and (and t146_def_{—}1_{—}8 t133_def_{—}6) (<t133_val_{—}6 t146_val_{—}1_{—}8)) (and t146_def_{—}2_{—}8 (=t146_val_{—}2_{—}8 t133_val_{—}6))))
(assert (implies (and (and t146_def_{—}1_{—}8 t133_def_{—}6) (>=t133_val_{—}6 t146_val_{—}1_{—}8)) (and t146_def_{—}2_{—}8 (=t146_val_{—}2_{—}8 t146_val_{—}1_{—}8))))
(assert (implies (and (not t146_def_{—}2_{—}8) (not t133_def_{—}7)) (not t146_def_{—}3_{—}8)))
(assert (implies (and (not t146_def_{—}2_{—}8) t133_def_{—}7) (and t146_def_{—}3_{—}8 (=t146_val_{—}3_{—}8 t133_val_{—}7))))
(assert (implies (and t146_def_{—}2_{—}8 (not t133_def_{—}7)) (and t146_def_{—}3_{—}8 (=t146_val_{—}3_{—}8 t146_val_{—}2_{—}8))))
(assert (implies (and (and t146_def_{—}2_{—}8 t133_def_{—}7) (<t133_val_{—}7 t146_val_{—}2_{—}8)) (and t146_def_{—}3_{—}8 (=t146_val_{—}3_{—}8 t133_val_{—}7))))
(assert (implies (and (and t146_def_{—}2_{—}8 t133_def_{—}7) (>=t133_val_{—}7 t146_val_{—}2_{—}8)) (and t146_def_{—}3_{—}8 (=t146_val_{—}3_{—}8 t146_val_{—}2_{—}8))))
(assert (implies t133_def_{—}6 t146_def_{—}1_{—}9))
(assert (implies (not t133_def_{—}6) (not t146_def_{—}1_{—}9)))
(assert (implies t133_def_{—}6 (=t146_val_{—}1_{—}9 t133_val_{—}6)))
(assert (implies (and (not t146_def_{—}1_{—}9) (not t133_def_{—}7)) (not t146_def_{—}2_{—}9)))
(assert (implies (and (not t146_def_{—}1_{—}9) t133_def_{—}7) (and t146_def_{—}2_{—}9 (=t146_val_{—}2_{—}9 t133_val_{—}7))))
(assert (implies (and t146_def_{—}1_{—}9 (not t133_def_{—}7)) (and t146_def_{—}2_{—}9 (=t146_val_{—}2_{—}9 t146_val_{—}1_{—}9))))
(assert (implies (and (and t146_def_{—}1_{—}9 t133_def_{—}7) (<t133_val_{—}7 t146_val_{—}1_{—}9)) (and t146_def_{—}2_{—}9 (=t146_val_{—}2_{—}9 t133_val_{—}7))))
(assert (implies (and (and t146_def_{—}1_{—}9 t133_def_{—}7) (>=t133_val_{—}7 t146_val_{—}1_{—}9)) (and t146_def_{—}2_{—}9 (=t146_val_{—}2_{—}9 t146_val_{—}1_{—}9))))
(assert (implies (and (not t146_def_{—}2_{—}9) (not t133_def_{—}8)) (not t146_def_{—}3_{—}9)))
(assert (implies (and (not t146_def_{—}2_{—}9) t133_def_{—}8) (and t146_def_{—}3_{—}9 (=t146_val_{—}3_{—}9 t133_val_{—}8))))
(assert (implies (and t146_def_{—}2_{—}9 (not t133_def_{—}8)) (and t146_def_{—}3_{—}9 (=t146_val_{—}3_{—}9 t146_val_{—}2_{—}9))))
(assert (implies (and (and t146_def_{—}2_{—}9 t133_def_{—}8) (<t133_val_{—}8 t146_val_{—}2_{—}9)) (and t146_def_{—}3_{—}9 (=t146_val_{—}3_{—}9 t133_val_{—}8))))
(assert (implies (and (and t146_def_{—}2_{—}9 t133_def_{—}8) (>=t133_val_{—}8 t146_val_{—}2_{—}9)) (and t146_def_{—}3_{—}9 (=t146_val_{—}3_{—}9 t146_val_{—}2_{—}9))))
(declare-fun t146_def_{—}1( ) Bool)
(declare-fun t146_val_{—}1( ) Real)
(assert (=t146_def_{—}3_{—}1 t146_def_{—}1))
(assert (=t146_val_{—}3_{—}1 t146_val_{—}1))
(declare-fun t146_def_{—}2( ) Bool)
(declare-fun t146_val_{—}2( ) Real)
(assert (=t146_def_{—}3_{—}2 t146_def_{—}2))
(assert (=t146_val_{—}3_{—}2 t146_val_{—}2))
(declare-fun t146_def_{—}3( ) Bool)
(declare-fun t146_val_{—}3( ) Real)
(assert (=t146_def_{—}3_{—}3 t146_def_{—}3))
(assert (=t146_val_{—}3_{—}3 t146_val_{—}3))
(declare-fun t146_def_{—}4( ) Bool)
(declare-fun t146_val_{—}4( ) Real)
(assert (=t146_def_{—}3_{—}4 t146_def_{—}4))
(assert (=t146_val_{—}3_{—}4 t146_val_{—}4))
(declare-fun t146_def_{—}5( ) Bool)
(declare-fun t146_val_{—}5( ) Real)
(assert (=t146_def_{—}3_{—}5 t146_def_{—}5))
(assert (=t146_val_{—}3_{—}5 t146_val_{—}5))
(declare-fun t146_def_{—}6( ) Bool)
(declare-fun t146_val_{—}6( ) Real)
(assert (=t146_def_{—}3_{—}6 t146_def_{—}6))
(assert (=t146_val_{—}3_{—}6 t146_val_{—}6))
(declare-fun t146_def_{—}7( ) Bool)
(declare-fun t146_val_{—}7( ) Real)
(assert (=t146_def_{—}3_{—}7 t146_def_{—}7))
(assert (=t146_val_{—}3_{—}7 t146_val_{—}7))
(declare-fun t146_def_{—}8( ) Bool)
(declare-fun t146_val_{—}8( ) Real)
(assert (=t146_def_{—}3_{—}8 t146_def_{—}8))
(assert (=t146_val_{—}3_{—}8 t146_val_{—}8))
(declare-fun t146_def_{—}9( ) Bool)
(declare-fun t146_val_{—}9( ) Real)
(assert (=t146_def_{—}3_{—}9 t146_def_{—}9))
(assert (=t146_val_{—}3_{—}9 t146_val_{—}9))
(declare-fun t147_def_{—}1( ) Bool)
(declare-fun t147_val_{—}1( ) Real)
(assert t147_def_{—}1)
(assert (=t147_val_{—}1 1.0))
(declare-fun t147_def_{—}2( ) Bool)
(declare-fun t147_val_{—}2( ) Real)
(assert t147_def_{—}2)
(assert (=t147_val_{—}2 1.0))
(declare-fun t147_def_{—}3( ) Bool)
(declare-fun t147_val_{—}3( ) Real)
(assert t147_def_{—}3)
(assert (=t147_val_{—}3 1.0))
(declare-fun t147_def_{—}4( ) Bool)
(declare-fun t147_val_{—}4( ) Real)
(assert t147_def_{—}4)
(assert (=t147_val_{—}4 1.0))
(declare-fun t147_def_{—}5( ) Bool)
(declare-fun t147_val_{—}5( ) Real)
(assert t147_def_{—}5)
(assert (=t147_val_{—}5 1.0))
(declare-fun t147_def_{—}6( ) Bool)
(declare-fun t147_val_{—}6( ) Real)
(assert t147_def_{—}6)
(assert (=t147_val_{—}6 1.0))
(declare-fun t147_def_{—}7( ) Bool)
(declare-fun t147_val_{—}7( ) Real)
(assert t147_def_{—}7)
(assert (=t147_val_{—}7 1.0))
(declare-fun t147_def_{—}8( ) Bool)
(declare-fun t147_val_{—}8( ) Real)
(assert t147_def_{—}8)
(assert (=t147_val_{—}8 1.0))
(declare-fun t147_def_{—}9( ) Bool)
(declare-fun t147_val_{—}9( ) Real)
(assert t147_def_{—}9)
(assert (=t147_val_{—}9 1.0))
(declare-fun t148_def_{—}1( ) Bool)
(declare-fun t148_val_{—}1( ) Real)
(assert t148_def_{—}1)
(assert (=t148_val_{—}1 1.0))
(declare-fun t148_def_{—}2( ) Bool)
(declare-fun t148_val_{—}2( ) Real)
(assert t148_def_{—}2)
(assert (=t148_val_{—}2 1.0))
(declare-fun t148_def_{—}3( ) Bool)
(declare-fun t148_val_{—}3( ) Real)
(assert t148_def_{—}3)
(assert (=t148_val_{—}3 1.0))
(declare-fun t148_def_{—}4( ) Bool)
(declare-fun t148_val_{—}4( ) Real)
(assert t148_def_{—}4)
(assert (=t148_val_{—}4 1.0))
(declare-fun t148_def_{—}5( ) Bool)
(declare-fun t148_val_{—}5( ) Real)
(assert t148_def_{—}5)
(assert (=t148_val_{—}5 1.0))
(declare-fun t148_def_{—}6( ) Bool)
(declare-fun t148_val_{—}6( ) Real)
(assert t148_def_{—}6)
(assert (=t148_val_{—}6 1.0))
(declare-fun t148_def_{—}7( ) Bool)
(declare-fun t148_val_{—}7( ) Real)
(assert t148_def_{—}7)
(assert (=t148_val_{—}7 1.0))
(declare-fun t148_def_{—}8( ) Bool)
(declare-fun t148_val_{—}8( ) Real)
(assert t148_def_{—}8)
(assert (=t148_val_{—}8 1.0))
(declare-fun t148_def_{—}9( ) Bool)
(declare-fun t148_val_{—}9( ) Real)
(assert t148_def_{—}9)
(assert (=t148_val_{—}9 1.0))
(declare-fun t149_def_{—}1( ) Bool)
(declare-fun t149_val_{—}1( ) Real)
(assert t149_def_{—}1)
(assert (=t149_val_{—}1 0.0))
(declare-fun t149_def_{—}2( ) Bool)
(declare-fun t149_val_{—}2( ) Real)
(assert t149_def_{—}2)
(assert (=t149_val_{—}2 0.0))
(declare-fun t149_def_{—}3( ) Bool)
(declare-fun t149_val_{—}3( ) Real)
(assert t149_def_{—}3)
(assert (=t149_val_{—}3 0.0))
(declare-fun t149_def_{—}4( ) Bool)
(declare-fun t149_val_{—}4( ) Real)
(assert t149_def_{—}4)
(assert (=t149_val_{—}4 0.0))
(declare-fun t149_def_{—}5( ) Bool)
(declare-fun t149_val_{—}5( ) Real)
(assert t149_def_{—}5)
(assert (=t149_val_{—}5 0.0))
(declare-fun t149_def_{—}6( ) Bool)
(declare-fun t149_val_{—}6( ) Real)
(assert t149_def_{—}6)
(assert (=t149_val_{—}6 0.0))
(declare-fun t149_def_{—}7( ) Bool)
(declare-fun t149_val_{—}7( ) Real)
(assert t149_def_{—}7)
(assert (=t149_val_{—}7 0.0))
(declare-fun t149_def_{—}8( ) Bool)
(declare-fun t149_val_{—}8( ) Real)
(assert t149_def_{—}8)
(assert (=t149_val_{—}8 0.0))
(declare-fun t149_def_{—}9( ) Bool)
(declare-fun t149_val_{—}9( ) Real)
(assert t149_def_{—}9)
(assert (=t149_val_{—}9 0.0))
(declare-fun t150_def_{—}1 Bool)
(declare-fun t150_val_{—}1( ) Real)
(declare-fun var1b_{—}1( ) Real)
(assert (=var1b_{—}1 t150_val_{—}1))
(declare-fun t150_def_{—}2( ) Bool)
(declare-fun t150_val_{—}2( ) Real)
(declare-fun var1b_{—}2( ) Real)
(assert (=var1b_{—}2 t150_val_{—}2))
(declare-fun t150_def_{—}3( ) Bool)
(declare-fun t150_val_{—}3( ) Real)
(declare-fun var1b_{—}3( ) Real)
(assert (=var1b_{—}3 t150_val_{—}3))
(declare-fun t150_def_{—}4( ) Bool)
(declare-fun t150_val_{—}4( ) Real)
(declare-fun var1b_{—}4( ) Real)
(assert (=var1b_{—}4 t150_val_{—}4))
(declare-fun t150_def_{—}5( ) Bool)
(declare-fun t150_val_{—}5( ) Real)
(declare-fun var1b_{—}5( ) Real)
(assert (=var1b_{—}5 t150_val_{—}5))
(declare-fun t150_def_{—}6( ) Bool)
(declare-fun t150_val_{—}6( ) Real)
(declare-fun var1b_{—}60(Real)
(assert (=var1b_{—}6 t150_val_{—}6))
(declare-fun t150_def_{—}7( ) Bool)
(declare-fun t150_val_{—}7( ) Real)
(declare-fun var1b_{—}7( ) Real)
(assert (=var1b_{—}7 t150_val_{—}7))
(declare-fun t150_def_{—}8( ) Bool)
(declare-fun t150_val_{—}8( ) Real)
(declare-fun var1b_{—}8( ) Real)
(assert (=var1b_{—}8 t150_val_{—}8))
(declare-fun t150_def_{—}9( ) Bool)
(declare-fun t150_val_{—}9( ) Real)
(declare-fun var1b_{—}9( ) Real)
(assert (=var1b_{—}9 t150_val_{—}9))
(assert (implies (and (and t145_def_{—}1 (>=t145_val_{—}1 0.0)) (not t146_def_{—}1))(not t150_def_{—}1)))
(assert (implies (and (and (and (>=t145_val_{—}1 0.0) t145_def_{—}1)(and (>=t146_val_{—}1 0.0) t146_def_{—}1)) t147_def_{—}1) (and t150_def_{—}1 (=t150_val_{—}1 (*t146_val_{—}1 t147_val_{—}1)))))
(assert (implies (and (and (and (>=t145_val_{—}1 0.0) t145_def_{—}1)(and (>=t146_val_{—}1 0.0) t146_def_{—}1)) (not t147_def_{—}1)) (not t150_def_{—}1)))
(assert (implies (and (and (and (>=t145_val_{—}1 0.0) t145_def_{—}1)(and (<t146_val_{—}1 0.0) t146_def_{—}1)) t148_def_{—}1) (and t150_def_{—}1 (=t150_val_{—}1 (*t146_val_{—}1 t148_val_{—}1)))))
(assert (implies (and (and (and (>=t145_val_{—}1 0.0) t145_def_{—}1)(and (<t146_val_{—}1 0.0) t146_def_{—}1)) (not t148_def_{—}1)) (not t150_def_{—}1)))
(assert (implies (and (and (>=t145_val_{—}1 0.0) t145_def_{—}1) (not t146_def_{—}1))(not t150_def_{—}1)))
(assert (implies (and (and (<t145_val_{—}1 0.0) t145_def_{—}1) t149_def_{—}1)(and t150_def_{—}1 (=t150_val_{—}1 t149_val_{—}1))))
(assert (implies (and (and (<t145_val_{—}1 0.0) t145_def_{—}1) (not t149_def_{—}1))(not t150_def_{—}1)))
(assert (implies (not t145_def_{—}1) (not t150_def_{—}1)))
(assert (implies (and (and t145_def_{—}2 (>=t145_val_{—}2 0.0)) (not t146_def_{—}2))(not t150_def_{—}2)))
(assert (implies (and (and (and (>=t145_val_{—}2 0.0) t145_def_{—}2)(and (>=t146_val_{—}2 0.0) t146_def_{—}2)) t147_def_{—}2) (and t150_def_{—}2 (=t150_val_{—}2 (*t146_val_{—}2 t147_val_{—}2)))))
(assert (implies (and (and (and (>=t145_val_{—}2 0.0) t145_def_{—}2)(and (>=t146_val_{—}2 0.0) t146_def_{—}2)) (not t147_def_{—}2)) (not t150_def_{—}2)))
(assert (implies (and (and (and (>=t145_val_{—}2 0.0) t145_def_{—}2)(and (<t146_val_{—}2 0.0) t146_def_{—}2)) t148_def_{—}2) (and t150_def_{—}2 (=t150_val_{—}2 (*t146_val_{—}2 t148_val_{—}2)))))
(assert (implies (and (and (and (>=t145_val_{—}2 0.0) t145_def_{—}2)(and (<t146_val_{—}2 0.0) t146_def_{—}2)) (not t148_def_{—}2)) (not t150_def_{—}2)))
(assert (implies (and (and (>=t145_val_{—}2 0.0) t145_def_{—}2) (not t146_def_{—}2))(not t150_def_{—}2)))
(assert (implies (and (and (<t145_val_{—}2 0.0) t145_def_{—}2) t149_def_{—}2)(and t150_def_{—}2 (=t150_val_{—}2 t149_val_{—}2))))
(assert (implies (and (and (<t145_val_{—}2 0.0) t145_def_{—}2) (not t149_def_{—}2))(not t150_def_{—}2)))
(assert (implies (not t145_def_{—}2) (not t150_def_{—}2)))
(assert (implies (and (and t145_def_{—}3 (>=t145_val_{—}3 0.0)) (not t146_def_{—}3))(not t150_def_{—}3)))
(assert (implies (and (and (and (>=t145_val_{—}3 0.0) t145_def_{—}3)(and (>=t146_val_{—}3 0.0) t146_def_{—}3)) t147_def_{—}3) (and t150_def_{—}3 (=t150_val_{—}3 (*t146_val_{—}3 t147_val_{—}3)))))
(assert (implies (and (and (and (>=t145_val_{—}3 0.0) t145_def_{—}3)(and (>=t146_val_{—}3 0.0) t146_def_{—}3)) (not t147_def_{—}3)) (not t150_def_{—}3)))
(assert (implies (and (and (and (>=t145_val_{—}3 0.0) t145_def_{—}3)(and (<t146_val_{—}3 0.0) t146_def_{—}3)) t148_def_{—}3) (and t150_def_{—}3 (=t150_val_{—}3 (*t146_val_{—}3 t148_val_{—}3)))))
(assert (implies (and (and (and (>=t145_val_{—}3 0.0) t145_def_{—}3)(and (<t146_val_{—}3 0.0) t146_def_{—}3)) (not t148_def_{—}3)) (not t150_def_{—}3)))
(assert (implies (and (and (>=t145_val_{—}3 0.0) t145_def_{—}3) (not t146_def_{—}3))(not t150_def_{—}3)))
(assert (implies (and (and (<t145_val_{—}3 0.0) t145_def_{—}3) t149_def_{—}3)(and t150_def_{—}3 (=t150_val_{—}3 t149_val_{—}3))))
(assert (implies (and (and (<t145_val_{—}3 0.0) t145_def_{—}3) (not t149_def_{—}3))(not t150_def_{—}3)))
(assert (implies (not t145_def_{—}3) (not t150_def_{—}3)))
(assert (implies (and (and t145_def_{—}4 (>=t145_val_{—}4 0.0)) (not t146_def_{—}4))(not t150_def_{—}4)))
(assert (implies (and (and (and (>=t145_val_{—}4 0.0) t145_def_{—}4)(and (>=t146_val_{—}4 0.0) t146_def_{—}4)) t147_def_{—}4) (and t150_def_{—}4 (=t150_val_{—}4 (*t146_val_{—}4 t147_val_{—}4)))))
(assert (implies (and (and (and (>=t145_val_{—}4 0.0) t145_def_{—}4)(and (>=t146_val_{—}4 0.0) t146_def_{—}4)) (not t147_def_{—}4)) (not t150_def_{—}4)))
(assert (implies (and (and (and (>=t145_val_{—}4 0.0) t145_def_{—}4)(and (<t146_val_{—}4 0.0) t146_def_{—}4)) t148_def_{—}4) (and t150_def_{—}4 (=t150_val_{—}4 (*t146_val_{—}4 t148_val_{—}4)))))
(assert (implies (and (and (and (>=t145_val_{—}4 0.0) t145_def_{—}4)(and (<t146_val_{—}4 0.0) t146_def_{—}4)) (not t148_def_{—}4)) (not t150_def_{—}4)))
(assert (implies (and (and (>=t145_val_{—}4 0.0) t145_def_{—}4) (not t146_def_{—}4))(not t150_def_{—}4)))
(assert (implies (and (and (<t145_val_{—}4 0.0) t145_def_{—}4) t149_def_{—}4)(and t150_def_{—}4 (=t150_val_{—}4 t149_val_{—}4))))
(assert (implies (and (and (<t145_val_{—}4 0.0) t145_def_{—}4) (not t149_def_{—}4))(not t150_def_{—}4)))
(assert (implies (not t145_def_{—}4) (not t150_def_{—}4)))
(assert (implies (and (and t145_def_{—}5 (>=t145_val_{—}5 0.0)) (not t146_def_{—}5))(not t150_def_{—}5)))
(assert (implies (and (and (and (>=t145_val_{—}5 0.0) t145_def_{—}5)(and (>=t146_val_{—}5 0.0) t146_def_{—}5)) t147_def_{—}5) (and t150_def_{—}5 (=t150_val_{—}5 (*t146_val_{—}5 t147_val_{—}5)))))
(assert (implies (and (and (and (>=t145_val_{—}5 0.0) t145_def_{—}5)(and (>=t146_val_{—}5 0.0) t146_def_{—}5)) (not t147_def_{—}5)) (not t150_def_{—}5)))
(assert (implies (and (and (and (>=t145_val_{—}5 0.0) t145_def_{—}5)(and (<t146_val_{—}5 0.0) t146_def_{—}5)) t148_def_{—}5) (and t150_def_{—}5 (=t150_val_{—}5 (*t146_val_{—}5 t148_val_{—}5)))))
(assert (implies (and (and (and (>=t145_val_{—}5 0.0) t145_def_{—}5)(and (<t146_val_{—}5 0.0) t146_def_{—}5)) (not t148_def_{—}5)) (not t150_def_{—}5)))
(assert (implies (and (and (>=t145_val_{—}5 0.0) t145_def_{—}5) (not t146_def_{—}5))(not t150_def_{—}5)))
(assert (implies (and (and (<t145_val_{—}5 0.0) t145_def_{—}5) t149_def_{—}5)(and t150_def_{—}5 (=t150_val_{—}5 t149_val_{—}5))))
(assert (implies (and (and (<t145_val_{—}5 0.0) t145_def_{—}5) (not t149_def_{—}5))(not t150_def_{—}5)))
(assert (implies (not t145_def_{—}5) (not t150_def_{—}5)))
(assert (implies (and (and t145_def_{—}6 (>=t145_val_{—}6 0.0)) (not t146_def_{—}6))(not t150_def_{—}6)))
(assert (implies (and (and (and (>=t145_val_{—}6 0.0) t145_def_{—}6)(and (>=t146_val_{—}6 0.0) t146_def_{—}6)) t147_def_{—}6) (and t150_def_{—}6 (=t150_val_{—}6 (*t146_val_{—}6 t147_val_{—}6)))))
(assert (implies (and (and (and (>=t145_val_{—}6 0.0) t145_def_{—}6)(and (>=t146_val_{—}6 0.0) t146_def_{—}6)) (not t147_def_{—}6)) (not t150_def_{—}6)))
(assert (implies (and (and (and (>=t145_val_{—}6 0.0) t145_def_{—}6)(and (<t146_val_{—}6 0.0) t146_def_{—}6)) t148_def_{—}6) (and t150_def_{—}6 (=t150_val_{—}6 (*t146_val_{—}6 t148_val_{—}6)))))
(assert (implies (and (and (and (>=t145_val_{—}6 0.0) t145_def_{—}6)(and (<t146_val_{—}6 0.0) t146_def_{—}6)) (not t148_def_{—}6)) (not t150_def_{—}6)))
(assert (implies (and (and (>=t145_val_{—}6 0.0) t145_def_{—}6) (not t146_def_{—}6))(not t150_def_{—}6)))
(assert (implies (and (and (<t145_val_{—}6 0.0) t145_def_{—}6) t149_def_{—}6)(and t150_def_{—}6 (=t150_val_{—}6 t149_val_{—}6))))
(assert (implies (and (and (<t145_val_{—}6 0.0) t145_def_{—}6) (not t149_def_{—}6))(not t150_def_{—}6)))
(assert (implies (not t145_def_{—}6) (not t150_def_{—}6)))
(assert (implies (and (and t145_def_{—}7 (>=t145_val_{—}7 0.0)) (not t146_def_{—}7))(not t150_def_{—}7)))
(assert (implies (and (and (and (>=t145_val_{—}7 0.0) t145_def_{—}7)(and (>=t146_val_{—}7 0.0) t146_def_{—}7)) t147_def_{—}7) (and t150_def_{—}7 (=t150_val_{—}7 (*t146_val_{—}7 t147_val_{—}7)))))
(assert (implies (and (and (and (>=t145_val_{—}7 0.0) t145_def_{—}7)(and (>=t146_val_{—}7 0.0) t146_def_{—}7)) (not t147_def_{—}7)) (not t150_def_{—}7)))
(assert (implies (and (and (and (>=t145_val_{—}7 0.0) t145_def_{—}7)(and (<t146_val_{—}7 0.0) t146_def_{—}7)) t148_def_{—}7) (and t150_def_{—}7 (=t150_val_{—}7 (*t146_val_{—}7 t148_val_{—}7)))))
(assert (implies (and (and (and (>=t145_val_{—}7 0.0) t145_def_{—}7)(and (<t146_val_{—}7 0.0) t146_def_{—}7)) (not t148_def_{—}7)) (not t150_def_{—}7)))
(assert (implies (and (and (>=t145_val_{—}7 0.0) t145_def_{—}7) (not t146_def_{—}7))(not t150_def_{—}7)))
(assert (implies (and (and (<t145_val_{—}7 0.0) t145_def_{—}7) t149_def_{—}7)(and t150_def_{—}7 (=t150_val_{—}7 t149_val_{—}7))))
(assert (implies (and (and (<t145_val_{—}7 0.0) t145_def_{—}7) (not t149_def_{—}7))(not t150_def_{—}7)))
(assert (implies (not t145_def_{—}7) (not t150_def_{—}7)))
(assert (implies (and (and t145_def_{—}8 (>=t145_val_{—}8 0.0)) (not t146_def_{—}8))(not t150_def_{—}8)))
(assert (implies (and (and (and (>=t145_val_{—}8 0.0) t145_def_{—}8)(and (>=t146_val_{—}8 0.0) t146_def_{—}8)) t147_def_{—}8) (and t150_def_{—}8 (=t150_val_{—}8 (*t146_val_{—}8 t147_val_{—}8)))))
(assert (implies (and (and (and (>=t145_val_{—}8 0.0) t145_def_{—}8)(and (>=t146_val_{—}8 0.0) t146_def_{—}8)) (not t147_def_{—}8)) (not t150_def_{—}8)))
(assert (implies (and (and (and (>=t145_val_{—}8 0.0) t145_def_{—}8)(and (<t146_val_{—}8 0.0) t146_def_{—}8)) t148_def_{—}8) (and t150_def_{—}8 (=t150_val_{—}8 (*t146_val_{—}8 t148_val_{—}8)))))
(assert (implies (and (and (and (>=t145_val_{—}8 0.0) t145_def_{—}8)(and (<t146_val_{—}8 0.0) t146_def_{—}8)) (not t148_def_{—}8)) (not t150_def_{—}8)))
(assert (implies (and (and (>=t145_val_{—}8 0.0) t145_def_{—}8) (not t146_def_{—}8))(not t150_def_{—}8)))
(assert (implies (and (and (<t145_val_{—}8 0.0) t145_def_{—}8) t149_def_{—}8)(and t150_def_{—}8 (=t150_val_{—}8 t149_val_{—}8))))
(assert (implies (and (and (<t145_val_{—}8 0.0) t145_def_{—}8) (not t149_def_{—}8))(not t150_def_{—}8)))
(assert (implies (not t145_def_{—}8) (not t150_def_{—}8)))
(assert (implies (and (and t145_def_{—}9 (>=t145_val_{—}9 0.0)) (not t146_def_{—}9))(not t150_def_{—}9)))
(assert (implies (and (and (and (>=t145_val_{—}9 0.0) t145_def_{—}9)(and (>=t146_val_{—}9 0.0) t146_def_{—}9)) t147_def_{—}9) (and t150_def_{—}9 (=t150_val_{—}9 (*t146_val_{—}9 t147_val_{—}9)))))
(assert (implies (and (and (and (>=t145_val_{—}9 0.0) t145_def_{—}9)(and (>=t146_val_{—}9 0.0) t146_def_{—}9)) (not t147_def_{—}9)) (not t150_def_{—}9)))
(assert (implies (and (and (and (>=t145_val_{—}9 0.0) t145_def_{—}9)(and (<t146_val_{—}9 0.0) t146_def_{—}9)) t148_def_{—}9) (and t150_def_{—}9 (=t150_val_{—}9 (*t146_val_{—}9 t148_val_{—}9)))))
(assert (implies (and (and (and (>=t145_val_{—}9 0.0) t145_def_{—}9)(and (<t146_val_{—}9 0.0) t146_def_{—}9)) (not t148_def_{—}9)) (not t150_def_{—}9)))
(assert (implies (and (and (>=t145_val_{—}9 0.0) t145_def_{—}9) (not t146_def_{—}9))(not t150_def_{—}9)))
(assert (implies (and (and (<t145_val_{—}9 0.0) t145_def_{—}9) t149_def_{—}9)(and t150_def_{—}9 (=t150_val_{—}9 t149_val_{—}9))))
(assert (implies (and (and (<t145_val_{—}9 0.0) t145_def_{—}9) (not t149_def_{—}9))(not t150_def_{—}9)))
(assert (implies (not t145_def_{—}9) (not t150_def_{—}9)))
(declare-fun t151_def_{—}1( ) Bool)
(declare-fun t151_val_{—}1( ) Real)
(assert t151_def_{—}1)
(assert (=t151_val_{—}1 1.0))
(declare-fun t151_def_{—}2( ) Bool)
(declare-fun t151_val_{—}2( ) Real)
(assert t151_def_{—}2)
(assert (=t151_val_{—}2 1.0))
(declare-fun t151_def_{—}3( ) Bool)
(declare-fun t151_val_{—}3( ) Real)
(assert t151_def_{—}3)
(assert (=t151_val_{—}3 1.0))
(declare-fun t151_def_{—}4( ) Bool)
(declare-fun t151_val_{—}4( ) Real)
(assert t151_def_{—}4)
(assert (=t151_val_{—}4 1.0))
(declare-fun t151_def_{—}5( ) Bool)
(declare-fun t151_val_{—}5( ) Real)
(assert t151_def_{—}5)
(assert (=t151_val_{—}5 1.0))
(declare-fun t151_def_{—}6( ) Bool)
(declare-fun t151_val_{—}6( ) Real)
(assert t151_def_{—}6)
(assert (=t151_val_{—}6 1.0))
(declare-fun t151_def_{—}7( ) Bool)
(declare-fun t151_val_{—}7( ) Real)
(assert t151_def_{—}7)
(assert (=t151_val_{—}7 1.0))
(declare-fun t151_def_{—}8( ) Bool)
(declare-fun t151_val_{—}8( ) Real)
(assert t151_def_{—}8)
(assert (=t151_val_{—}8 1.0))
(declare-fun t151_def_{—}9( ) Bool)
(declare-fun t151_val_{—}9( ) Real)
(assert t151_def_{—}9)
(assert (=t151_val_{—}9 1.0))
(declare-fun t152_def_{—}1( ) Bool)
(declare-fun t152_val_{—}1( ) Real)
(declare-fun t152_def_{—}2( ) Bool)
(declare-fun t152_val_{—}2( ) Real)
(declare-fun t152_def_{—}3( ) Bool)
(declare-fun t152_val_{—}3( ) Real)
(declare-fun t152_def_{—}4( ) Bool)
(declare-fun t152_val_{—}4( ) Real)
(declare-fun t152_def_{—}5( ) Bool)
(declare-fun t152_val_{—}5( ) Real)
(declare-fun t152_def_{—}6( ) Bool)
(declare-fun t152_val_{—}6( ) Real)
(declare-fun t152_def_{—}7( ) Bool)
(declare-fun t152_val_{—}7( ) Real)
(declare-fun t152_def_{—}8( ) Bool)
(declare-fun t152_val_{—}8( ) Real)
(declare-fun t152_def_{—}9( ) Bool)
(declare-fun t152_val_{—}9( ) Real)
(assert (not t152_def_{—}1))
(assert (not t152_def_{—}2))
(assert (implies t150_def_{—}1 (and t152_def_{—}3 (=t150_val_{—}1 t152_val_{—}3))))
(assert (implies (not t150_def_{—}1) (not t152_def_{—}3)))
(assert (implies t150_def_{—}2 (and t152_def_{—}4 (=t150_val_{—}2 t152_val_{—}4))))
(assert (implies (not t150_def_{—}2) (not t152_def_{—}4)))
(assert (implies t150_def_{—}3 (and t152_def_{—}5 (=t150_val_{—}3 t152_val_{—}5))))
(assert (implies (not t150_def_{—}3) (not t152_def_{—}5)))
(assert (implies t150_def_{—}4 (and t152_def_{—}6 (=t150_val_{—}4 t152_val_{—}6))))
(assert (implies (not t150_def_{—}4) (not t152_def_{—}6)))
(assert (implies t150_def_{—}5 (and t152_def_{—}7 (=t150_val_{—}5 t152_val_{—}7))))
(assert (implies (not t150_def_{—}5) (not t152_def_{—}7)))
(assert (implies t150_def_{—}6 (and t152_def_{—}8 (=t150_val_{—}6 t152_val_{—}8))))
(assert (implies (not t150_def_{—}6) (not t152_def_{—}8)))
(assert (implies t150_def_{—}7 (and t152_def_{—}9 (=t150_val_{—}7 t152_val_{—}9))))
(assert (implies (not t150_def_{—}7) (not t152_def_{—}9)))
(declare-fun t153_def_{—}1( ) Bool)
(declare-fun t153_val_{—}1( ) Real)
(assert t153_def_{—}1)
(assert (=t153_val_{—}1 1.0))
(declare-fun t153_def_{—}2( ) Bool)
(declare-fun t153_val_{—}2( ) Real)
(assert t153_def_{—}2)
(assert (=t153_val_{—}2 1.0))
(declare-fun t153_def_{—}3( ) Bool)
(declare-fun t153_val_{—}3( ) Real)
(assert t153_def_{—}3)
(assert (=t153_val_{—}3 1.0))
(declare-fun t153_def_{—}4( ) Bool)
(declare-fun t153_val_{—}4( ) Real)
(assert t153_def_{—}4)
(assert (=t153_val_{—}4 1.0))
(declare-fun t153_def_{—}5( ) Bool)
(declare-fun t153_val_{—}5( ) Real)
(assert t153_def_{—}5)
(assert (=t153_val_{—}5 1.0))
(declare-fun t153_def_{—}6( ) Bool)
(declare-fun t153_val_{—}6( ) Real)
(assert t153_def_{—}6)
(assert (=t153_val_{—}6 1.0))
(declare-fun t153_def_{—}7( ) Bool)
(declare-fun t153_val_{—}7( ) Real)
(assert t153_def_{—}7)
(assert (=t153_val_{—}7 1.0))
(declare-fun t153_def_{—}8( ) Bool)
(declare-fun t153_val_{—}8( ) Real)
(assert t153_def_{—}8)
(assert (=t153_val_{—}8 1.0))
(declare-fun t153_def_{—}9( ) Bool)
(declare-fun t153_val_{—}9( ) Real)
(assert t153_def_{—}9)
(assert (=t153_val_{—}9 1.0))
(declare-fun t154_def_{—}1( ) Bool)
(declare-fun t154_val_{—}1( ) Real)
(assert t154_def_{—}1)
(assert (=t154_val_{—}1 1.0))
(declare-fun t154_def_{—}2( ) Bool)
(declare-fun t154_val_{—}2( ) Real)
(assert t154_def_{—}2)
(assert (=t154_val_{—}2 1.0))
(declare-fun t154_def_{—}3( ) Bool)
(declare-fun t154_val_{—}3( ) Real)
(assert t154_def_{—}3)
(assert (=t154_val_{—}3 1.0))
(declare-fun t154_def_{—}4( ) Bool)
(declare-fun t154_val_{—}4( ) Real)
(assert t154_def_{—}4)
(assert (=t154_val_{—}4 1.0))
(declare-fun t154_def_{—}5( ) Bool)
(declare-fun t154_val_{—}5( ) Real)
(assert t154_def_{—}5)
(assert (=t154_val_{—}5 1.0))
(declare-fun t154_def_{—}6( ) Bool)
(declare-fun t154_val_{—}6( ) Real)
(assert t154_def_{—}6)
(assert (=t154_val_{—}6 1.0))
(declare-fun t154_def_{—}7( ) Bool)
(declare-fun t154_val_{—}7( ) Real)
(assert t154_def_{—}7)
(assert (=t154_val_{—}7 1.0))
(declare-fun t154_def_{—}8( ) Bool)
(declare-fun t154_val_{—}8( ) Real)
(assert t154_def_{—}8)
(assert (=t154_val_{—}8 1.0))
(declare-fun t154_def_{—}9( ) Bool)
(declare-fun t154_val_{—}9( ) Real)
(assert t154_def_{—}9)
(assert (=t154_val_{—}9 1.0))
(declare-fun t155_def_{—}1( ) Bool)
(declare-fun t155_val_{—}1( ) Real)
(assert t155_def_{—}1)
(assert (=t155_val_{—}1 0.0))
(declare-fun t155_def_{—}2( ) Bool)
(declare-fun t155_val_{—}2( ) Real)
(assert t155_def_{—}2)
(assert (=t155_val_{—}2 0.0))
(declare-fun t155_def_{—}3( ) Bool)
(declare-fun t155_val_{—}3( ) Real)
(assert t155_def_{—}3)
(assert (=t155_val_{—}3 0.0))
(declare-fun t155_def_{—}4( ) Bool)
(declare-fun t155_val_{—}4( ) Real)
(assert t155_def_{—}4)
(assert (=t155_val_{—}4 0.0))
(declare-fun t155_def_{—}5( ) Bool)
(declare-fun t155_val_{—}5( ) Real)
(assert t155_def_{—}5)
(assert (=t155_val_{—}5 0.0))
(declare-fun t155_def_{—}6( ) Bool)
(declare-fun t155_val_{—}6( ) Real)
(assert t155_def_{—}6)
(assert (=t155_val_{—}6 0.0))
(declare-fun t155_def_{—}7( ) Bool)
(declare-fun t155_val_{—}7( ) Real)
(assert t155_def_{—}7)
(assert (=t155_val_{—}7 0.0))
(declare-fun t155_def_{—}8( ) Bool)
(declare-fun t155_val_{—}8( ) Real)
(assert t155_def_{—}8)
(assert (=t155_val_{—}8 0.0))
(declare-fun t155_def_{—}9( ) Bool)
(declare-fun t155_val_{—}9( ) Real)
(assert t155_def_{—}9)
(assert (=t155_val_{—}9 0.0))
(declare-fun t156_def_{—}1( ) Bool)
(declare-fun t156_val_{—}1( ) Real)
(declare-fun var2b_{—}1( ) Real)
(assert (=var2b_{—}1 t156_val_{—}1))
(declare-fun t156_def_{—}2( ) Bool)
(declare-fun t156_val_{—}2( ) Real)
(declare-fun var2b_{—}2( ) Real)
(assert (=var2b_{—}2 t156_val_{—}2))
(declare-fun t156_def_{—}3( ) Bool)
(declare-fun t156_val_{—}3( ) Real)
(declare-fun var2b_{—}3( ) Real)
(assert (=var2b_{—}3 t156_val_{—}3))
(declare-fun t156_def_{—}4( ) Bool)
(declare-fun t156_val_{—}4( ) Real)
(declare-fun var2b_{—}4( ) Real)
(assert (=var2b_{—}4 t156_val_{—}4))
(declare-fun t156_def_{—}5( ) Bool)
(declare-fun t156_val_{—}5( ) Real)
(declare-fun var2b_{—}5( ) Real)
(assert (=var2b_{—}5 t156_val_{—}5))
(declare-fun t156_def_{—}6( ) Bool)
(declare-fun t156_val_{—}6( ) Real)
(declare-fun var2b_{—}6( ) Real)
(assert (=var2b_{—}6 t156_val_{—}6))
(declare-fun t156_def_{—}7( ) Bool)
(declare-fun t156_val_{—}7( ) Real)
(declare-fun var2b_{—}7( ) Real)
(assert (=var2b_{—}7 t156_val_{—}7))
(declare-fun t156_def_{—}8( ) Bool)
(declare-fun t156_val_{—}8( ) Real)
(declare-fun var2b_{—}8( ) Real)
(assert (=var2b_{—}8 t156_val_{—}8))
(declare-fun t156_def_{—}9( ) Bool)
(declare-fun t156_val_{—}9( ) Real)
(declare-fun var2b_{—}9( ) Real)
(assert (=var2b_{—}9 t156_val_{—}9))
(assert (implies (and (and t151_def_{—}1 (>=t151_val_{—}1 0.0)) (not t152_def_{—}1))(not t156_def_{—}1)))
(assert (implies (and (and (and (>=t151_val_{—}1 0.0) t151_def_{—}1)(and (>=t152_val_{—}1 0.0) t152_def_{—}1)) t153_def_{—}1) (and t156_def_{—}1 (=t156_val_{—}1 (*t152_val_{—}1 t153_val_{—}1)))))
(assert (implies (and (and (and (>=t151_val_{—}1 0.0) t151_def_{—}1)(and (>=t152_val_{—}1 0.0) t152_def_{—}1)) (not t153_def_{—}1)) (not t156_def_{—}1)))
(assert (implies (and (and (and (>=t151_val_{—}1 0.0) t151_def_{—}1)(and (<t152_val_{—}1 0.0) t152_def_{—}1)) t154_def_{—}1) (and t156_def_{—}1 (=t156_val_{—}1 (*t152_val_{—}1 t154_val_{—}1)))))
(assert (implies (and (and (and (>=t151_val_{—}1 0.0) t151_def_{—}1)(and (<t152_val_{—}1 0.0) t152_def_{—}1)) (not t154_def_{—}1)) (not t156_def_{—}1)))
(assert (implies (and (and (>=t151_val_{—}1 0.0) t151_def_{—}1) (not t152_def_{—}1))(not t156_def_{—}1)))
(assert (implies (and (and (<t151_val_{—}1 0.0) t151_def_{—}1) t155_def_{—}1)(and t156_def_{—}1 (=t156_val_{—}1 t155_val_{—}1))))
(assert (implies (and (and (<t151_val_{—}1 0.0) t151_def_{—}1) (not t155_def_{—}1))(not t156_def_{—}1)))
(assert (implies (not t151_def_{—}1) (not t156_def_{—}1)))
(assert (implies (and (and t151_def_{—}2 (>=t151_val_{—}2 0.0)) (not t152_def_{—}2))(not t156_def_{—}2)))
(assert (implies (and (and (and (>=t151_val_{—}2 0.0) t151_def_{—}2)(and (>=t152_val_{—}2 0.0) t152_def_{—}2)) t153_def_{—}2) (and t156_def_{—}2 (=t156_val_{—}2 (*t152_val_{—}2 t153_val_{—}2)))))
(assert (implies (and (and (and (>=t151_val_{—}2 0.0) t151_def_{—}2)(and (>=t152_val_{—}2 0.0) t152_def_{—}2)) (not t153_def_{—}2)) (not t156_def_{—}2)))
(assert (implies (and (and (and (>=t151_val_{—}2 0.0) t151_def_{—}2)(and (<t152_val_{—}2 0.0) t152_def_{—}2)) t154_def_{—}2) (and t156_def_{—}2 (=t156_val_{—}2 (*t152_val_{—}2 t154_val_{—}2)))))
(assert (implies (and (and (and (>=t151_val_{—}2 0.0) t151_def_{—}2)(and (<t152_val_{—}2 0.0) t152_def_{—}2)) (not t154_def_{—}2)) (not t156_def_{—}2)))
(assert (implies (and (and (>=t151_val_{—}2 0.0) t151_def_{—}2) (not t152_def_{—}2))(not t156_def_{—}2)))
(assert (implies (and (and (<t151_val_{—}2 0.0) t151_def_{—}2) t155_def_{—}2)(and t156_def_{—}2 (=t156_val_{—}2 t155_val_{—}2))))
(assert (implies (and (and (<t151_val_{—}2 0.0) t151_def_{—}2) (not t155_def_{—}2))(not t156_def_{—}2)))
(assert (implies (not t151_def_{—}2) (not t156_def_{—}2)))
(assert (implies (and (and t151_def_{—}3 (>=t151_val_{—}3 0.0)) (not t152_def_{—}3))(not t156_def_{—}3)))
(assert (implies (and (and (and (>=t151_val_{—}3 0.0) t151_def_{—}3)(and (>=t152_val_{—}3 0.0) t152_def_{—}3)) t153_def_{—}3) (and t156_def_{—}3 (=t156_val_{—}3 (*t152_val_{—}3 t153_val_{—}3)))))
(assert (implies (and (and (and (>=t151_val_{—}3 0.0) t151_def_{—}3)(and (>=t152_val_{—}3 0.0) t152_def_{—}3)) (not t153_def_{—}3)) (not t156_def_{—}3)))
(assert (implies (and (and (and (>=t151_val_{—}3 0.0) t151_def_{—}3)(and (<t152_val_{—}3 0.0) t152_def_{—}3)) t154_def_{—}3) (and t156_def_{—}3 (=t156_val_{—}3 (*t152_val_{—}3 t154_val_{—}3)))))
(assert (implies (and (and (and (>=t151_val_{—}3 0.0) t151_def_{—}3)(and (<t152_val_{—}3 0.0) t152_def_{—}3)) (not t154_def_{—}3)) (not t156_def_{—}3)))
(assert (implies (and (and (>=t151_val_{—}3 0.0) t151_def_{—}3) (not t152_def_{—}3))(not t156_def_{—}3)))
(assert (implies (and (and (<t151_val_{—}3 0.0) t151_def_{—}3) t155_def_{—}3)(and t156_def_{—}3 (=t156_val_{—}3 t155_val_{—}3))))
(assert (implies (and (and (<t151_val_{—}3 0.0) t151_def_{—}3) (not t155_def_{—}3))(not t156_def_{—}3)))
(assert (implies (not t151_def_{—}3) (not t156_def_{—}3)))
(assert (implies (and (and t151_def_{—}4 (>=t151_val_{—}4 0.0)) (not t152_def_{—}4))(not t156_def_{—}4)))
(assert (implies (and (and (and (>=t151_val_{—}4 0.0) t151_def_{—}4)(and (>=t152_val_{—}4 0.0) t152_def_{—}4)) t153_def_{—}4) (and t156_def_{—}4 (=t156_val_{—}4 (*t152_val_{—}4 t153_val_{—}4)))))
(assert (implies (and (and (and (>=t151_val_{—}4 0.0) t151_def_{—}4)(and (>=t152_val_{—}4 0.0) t152_def_{—}4)) (not t153_def_{—}4)) (not t156_def_{—}4)))
(assert (implies (and (and (and (>=t151_val_{—}4 0.0) t151_def_{—}4)(and (<t152_val_{—}4 0.0) t152_def_{—}4)) t154_def_{—}4) (and t156_def_{—}4 (=t156_val_{—}4 (*t152_val_{—}4 t154_val_{—}4)))))
(assert (implies (and (and (and (>=t151_val_{—}4 0.0) t151_def_{—}4)(and (<t152_val_{—}4 0.0) t152_def_{—}4)) (not t154_def_{—}4)) (not t156_def_{—}4)))
(assert (implies (and (and (>=t151_val_{—}4 0.0) t151_def_{—}4) (not t152_def_{—}4))(not t156_def_{—}4)))
(assert (implies (and (and (<t151_val_{—}4 0.0) t151_def_{—}4) t155_def_{—}4)(and t156_def_{—}4 (=t156_val_{—}4 t155_val_{—}4))))
(assert (implies (and (and (<t151_val_{—}4 0.0) t151_def_{—}4) (not t155_def_{—}4))(not t156_def_{—}4)))
(assert (implies (not t151_def_{—}4) (not t156_def_{—}4)))
(assert (implies (and (and t151_def_{—}5 (>=t151_val_{—}5 0.0)) (not t152_def_{—}5))(not t156_def_{—}5)))
(assert (implies (and (and (and (>=t151_val_{—}5 0.0) t151_def_{—}5)(and (>=t152_val_{—}5 0.0) t152_def_{—}5)) t153_def_{—}5) (and t156_def_{—}5 (=t156_val_{—}5 (*t152_val_{—}5 t153_val_{—}5)))))
(assert (implies (and (and (and (>=t151_val_{—}5 0.0) t151_def_{—}5)(and (>=t152_val_{—}5 0.0) t152_def_{—}5)) (not t153_def_{—}5)) (not t156_def_{—}5)))
(assert (implies (and (and (and (>=t151_val_{—}5 0.0) t151_def_{—}5)(and (<t152_val_{—}5 0.0) t152_def_{—}5)) t154_def_{—}5) (and t156_def_{—}5 (=t156_val_{—}5 (*t152_val_{—}5 t154_val_{—}5)))))
(assert (implies (and (and (and (>=t151_val_{—}5 0.0) t151_def_{—}5)(and (<t152_val_{—}5 0.0) t152_def_{—}5)) (not t154_def_{—}5)) (not t156_def_{—}5)))
(assert (implies (and (and (>=t151_val_{—}5 0.0) t151_def_{—}5) (not t152_def_{—}5))(not t156_def_{—}5)))
(assert (implies (and (and (<t151_val_{—}5 0.0) t151_def_{—}5) t155_def_{—}5)(and t156_def_{—}5 (=t156_val_{—}5 t155_val_{—}5))))
(assert (implies (and (and (<t151_val_{—}5 0.0) t151_def_{—}5) (not t155_def_{—}5))(not t156_def_{—}5)))
(assert (implies (not t151_def_{—}5) (not t156_def_{—}5)))
(assert (implies (and (and t151_def_{—}6 (>=t151_val_{—}6 0.0)) (not t152_def_{—}6))(not t156_def_{—}6)))
(assert (implies (and (and (and (>=t151_val_{—}6 0.0) t151_def_{—}6)(and (>=t152_val_{—}6 0.0) t152_def_{—}6)) t153_def_{—}6) (and t156_def_{—}6 (=t156_val_{—}6 (*t152_val_{—}6 t153_val_{—}6)))))
(assert (implies (and (and (and (>=t151_val_{—}6 0.0) t151_def_{—}6)(and (>=t152_val_{—}6 0.0) t152_def_{—}6)) (not t153_def_{—}6)) (not t156_def_{—}6)))
(assert (implies (and (and (and (>=t151_val_{—}6 0.0) t151_def_{—}6)(and (<t152_val_{—}6 0.0) t152_def_{—}6)) t154_def_{—}6) (and t156_def_{—}6 (=t156_val_{—}6 (*t152_val_{—}6 t154_val_{—}6)))))
(assert (implies (and (and (and (>=t151_val_{—}6 0.0) t151_def_{—}6)(and (<t152_val_{—}6 0.0) t152_def_{—}6)) (not t154_def_{—}6)) (not t156_def_{—}6)))
(assert (implies (and (and (>=t151_val_{—}6 0.0) t151_def_{—}6) (not t152_def_{—}6))(not t156_def_{—}6)))
(assert (implies (and (and (<t151_val_{—}6 0.0) t151_def_{—}6) t155_def_{—}6)(and t156_def_{—}6 (=t156_val_{—}6 t155_val_{—}6))))
(assert (implies (and (and (<t151_val_{—}6 0.0) t151_def_{—}6) (not t155_def_{—}6))(not t156_def_{—}6)))
(assert (implies (not t151_def_{—}6) (not t156_def_{—}6)))
(assert (implies (and (and t151_def_{—}7 (>=t151_val_{—}7 0.0)) (not t152_def_{—}7))(not t156_def_{—}7)))
(assert (implies (and (and (and (>=t151_val_{—}7 0.0) t151_def_{—}7)(and (>=t152_val_{—}7 0.0) t152_def_{—}7)) t153_def_{—}7) (and t156_def_{—}7 (=t156_val_{—}7 (*t152_val_{—}7 t153_val_{—}7)))))
(assert (implies (and (and (and (>=t151_val_{—}7 0.0) t151_def_{—}7)(and (>=t152_val_{—}7 0.0) t152_def_{—}7)) (not t153_def_{—}7)) (not t156_def_{—}7)))
(assert (implies (and (and (and (>=t151_val_{—}7 0.0) t151_def_{—}7)(and (<t152_val_{—}7 0.0) t152_def_{—}7)) t154_def_{—}7) (and t156_def_{—}7 (=t156_val_{—}7 (*t152_val_{—}7 t154_val_{—}7)))))
(assert (implies (and (and (and (>=t151_val_{—}7 0.0) t151_def_{—}7)(and (<t152_val_{—}7 0.0) t152_def_{—}7)) (not t154_def_{—}7)) (not t156_def_{—}7)))
(assert (implies (and (and (>=t151_val_{—}7 0.0) t151_def_{—}7) (not t152_def_{—}7))(not t156_def_{—}7)))
(assert (implies (and (and (<t151_val_{—}7 0.0) t151_def_{—}7) t155_def_{—}7)(and t156_def_{—}7 (=t156_val_{—}7 t155_val_{—}7))))
(assert (implies (and (and (<t151_val_{—}7 0.0) t151_def_{—}7) (not t155_def_{—}7))(not t156_def_{—}7)))
(assert (implies (not t151_def_{—}7) (not t156_def_{—}7)))
(assert (implies (and (and t151_def_{—}8 (>=t151_val_{—}8 0.0)) (not t152_def_{—}8))(not t156_def_{—}8)))
(assert (implies (and (and (and (>=t151_val_{—}8 0.0) t151_def_{—}8)(and (>=t152_val_{—}8 0.0) t152_def_{—}8)) t153_def_{—}8) (and t156_def_{—}8 (=t156_val_{—}8 (*t152_val_{—}8 t153_val_{—}8)))))
(assert (implies (and (and (and (>=t151_val_{—}8 0.0) t151_def_{—}8)(and (>=t152_val_{—}8 0.0) t152_def_{—}8)) (not t153_def_{—}8)) (not t156_def_{—}8)))
(assert (implies (and (and (and (>=t151_val_{—}8 0.0) t151_def_{—}8)(and (<t152_val_{—}8 0.0) t152_def_{—}8)) t154_def_{—}8) (and t156_def_{—}8 (=t156_val_{—}8 (*t152_val_{—}8 t154_val_{—}8)))))
(assert (implies (and (and (and (>=t151_val_{—}8 0.0) t151_def_{—}8)(and (<t152_val_{—}8 0.0) t152_def_{—}8)) (not t154_def_{—}8)) (not t156_def_{—}8)))
(assert (implies (and (and (>=t151_val_{—}8 0.0) t151_def_{—}8) (not t152_def_{—}8))(not t156_def_{—}8)))
(assert (implies (and (and (<t151_val_{—}8 0.0) t151_def_{—}8) t155_def_{—}8)(and t156_def_{—}8 (=t156_val_{—}8 t155_val_{—}8))))
(assert (implies (and (and (<t151_val_{—}8 0.0) t151_def_{—}8) (not t155_def_{—}8))(not t156_def_{—}8)))
(assert (implies (not t151_def_{—}8) (not t156_def_{—}8)))
(assert (implies (and (and t151_def_{—}9 (>=t151_val_{—}9 0.0)) (not t152_def_{—}9))(not t156_def_{—}9)))
(assert (implies (and (and (and (>=t151_val_{—}9 0.0) t151_def_{—}9)(and (>=t152_val_{—}9 0.0) t152_def_{—}9)) t153_def_{—}9) (and t156_def_{—}9 (=t156_val_{—}9 (*t152_val_{—}9 t153_val_{—}9)))))
(assert (implies (and (and (and (>=t151_val_{—}9 0.0) t151_def_{—}9)(and (>=t152_val_{—}9 0.0) t152_def_{—}9)) (not t153_def_{—}9)) (not t156_def_{—}9)))
(assert (implies (and (and (and (>=t151_val_{—}9 0.0) t151_def_{—}9)(and (<t152_val_{—}9 0.0) t152_def_{—}9)) t154_def_{—}9) (and t156_def_{—}9 (=t156_val_{—}9 (*t152_val_{—}9 t154_val_{—}9)))))
(assert (implies (and (and (and (>=t151_val_{—}9 0.0) t151_def_{—}9)(and (<t152_val_{—}9 0.0) t152_def_{—}9)) (not t154_def_{—}9)) (not t156_def_{—}9)))
(assert (implies (and (and (>=t151_val_{—}9 0.0) t151_def_{—}9) (not t152_def_{—}9))(not t156_def_{—}9)))
(assert (implies (and (and (<t151_val_{—}9 0.0) t151_def_{—}9) t155_def_{—}9)(and t156_def_{—}9 (=t156_val_{—}9 t155_val_{—}9))))
(assert (implies (and (and (<t151_val_{—}9 0.0) t151_def_{—}9) (not t155_def_{—}9))(not t156_def_{—}9)))
(assert (implies (not t151_def_{—}9) (not t156_def_{—}9)))

The problem whether variables ‘var2a’ and ‘var2b’ are equivalent is encoded into SMT-LIB as:
(assert (or (and t144_def_{—}9 (not t156_def_{—}9)) (and t156_def_{—}9 (not t144_def_{—}9))
   (and (and t144_def_{—}9 t156_def_{—}9) (not (=t144_val_{—}9 t156_val_{—}9)))))

### Subsuming Rules

### Example Rules:

| | | | | | | |
|---|---|---|---|---|---|---|
| rvar12 | T | (tsum var3 4) | 1 | 1 | BAD | var12 |
| rvar13 | T | (tmax var3 4) | 1 | 1 | BAD | var13 |
| rvar14 | (<var12 0) | 2 | 1 | 1 | BAD | var14 |
| rvar15 | (<var13 0) | 2 | 1 | 1 | BAD | var15 |

In the above example, the variable ‘var14’ is subsumed by the variable ‘var15’ (i.e., for all variable assignment, if ‘var15’ gets a defined value, then ‘var14’ also gets this defined value, but not necessarily vice versa).

The encoding of the above example into SMT-LIB format (without the encoding of the subsumption problem):
(declare-fun t157_def_{—}1( ) Bool)
(declare-fun t157_val_{—}1( ) Real)
(assert t157_def_{—}1)
(assert (=t157_val_{—}1 1.0))
(declare-fun t157_def_{—}2( ) Bool)
(declare-fun t157_val_{—}2( ) Real)
(assert t157_def_{—}2)
(assert (=t157_val_{—}2 1.0))
(declare-fun t157_def_{—}3( ) Bool)
(declare-fun t157_val_{—}3( ) Real)
(assert t157_def_{—}3)
(assert (=t157_val_{—}3 1.0))
(declare-fun t157_def_{—}4( ) Bool)
(declare-fun t157_val_{—}4( ) Real)
(assert t157_def_{—}4)
(assert (=t157_val_{—}4 1.0))
(declare-fun t157_def_{—}5( ) Bool)
(declare-fun t157_val_{—}5( ) Real)
(assert t157_def_{—}5)
(assert (=t157_val_{—}5 1.0))
(declare-fun t158_def_{—}1( ) Bool)
(declare-fun t158_val_{—}1( ) Real)
(declare-fun var3_{—}1( ) Real)
(assert (=var3_{—}1 t158_val_{—}1))
(declare-fun t158_def_{—}2( ) Bool)
(declare-fun t158_val_{—}2( ) Real)
(declare-fun var3_{—}2( ) Real)
(assert (=var3_{—}2 t158_val_{—}2))
(declare-fun t158_def_{—}3( ) Bool)
(declare-fun t158_val_{—}3( ) Real)
(declare-fun var3_{—}3( ) Real)
(assert (=var3_{—}3 t158_val_{—}3))
(declare-fun t158_def_{—}4( ) Bool)
(declare-fun t158_val_{—}4( ) Real)
(declare-fun var3_{—}4) Real)
(assert (=var3_{—}4 t158_val_{—}4))
(declare-fun t158_def_{—}5( ) Bool)
(declare-fun t158_val_{—}5( ) Real)
(declare-fun var3_{—}5( ) Real)
(assert (=var3_{—}5 t158_val_{—}5))
(declare-fun t159_def_{—}1_{—}1( ) Bool)
(declare-fun t159_val_{—}1_{—}1( ) Real)
(declare-fun t159_def_{—}2_{—}1( ) Bool)
(declare-fun t159_val_{—}2_{—}1( ) Real)
(declare-fun t159_def_{—}3_{—}1( ) Bool)
(declare-fun t159_val_{—}3_{—}1( ) Real)
(declare-fun t159_def_{—}4_{—}1( ) Bool)
(declare-fun t159_val_{—}4_{—}1( ) Real)
(declare-fun t159_def_{—}1_{—}2( ) Bool)
(declare-fun t159_val_{—}1_{—}2( ) Real)
(declare-fun t159_def_{—}2_{—}2( ) Bool)
(declare-fun t159_val_{—}2_{—}2( ) Real)
(declare-fun t159_def_{—}3_{—}2( ) Bool)
(declare-fun t159_val_{—}3_{—}2( ) Real)
(declare-fun t159_def_{—}4_{—}2( ) Bool)
(declare-fun t159_val_{—}4_{—}2( ) Real)
(declare-fun t159_def_{—}1_{—}3( ) Bool)
(declare-fun t159_val_{—}1_{—}3( ) Real)
(declare-fun t159_def_{—}2_{—}3( ) Bool)
(declare-fun t159_val_{—}2_{—}3( ) Real)
(declare-fun t159_def_{—}3_{—}3( ) Bool)
(declare-fun t159_val_{—}3_{—}3( ) Real)
(declare-fun t159_def_{—}4_{—}3( ) Bool)
(declare-fun t159_val_{—}4_{—}3( ) Real)
(declare-fun t159_def_{—}1_{—}4( ) Bool)
(declare-fun t159_val_{—}1_{—}4( ) Real)
(declare-fun t159_def_{—}2_{—}4( ) Bool)
(declare-fun t159_val_{—}2_{—}4( ) Real)
(declare-fun t159_def_{—}3_{—}4( ) Bool)
(declare-fun t159_val_{—}3_{—}4( ) Real)
(declare-fun t159_def_{—}4_{—}4( ) Bool)
(declare-fun t159_val_{—}4_{—}4( ) Real)
(declare-fun t159_def_{—}1_{—}5( ) Bool)
(declare-fun t159_val_{—}1_{—}5( ) Real)
(declare-fun t159_def_{—}2_{—}5( ) Bool)
(declare-fun t159_val_{—}2_{—}5( ) Real)
(declare-fun t159_def_{—}3_{—}5( ) Bool)
(declare-fun t159_val_{—}3_{—}5( ) Real)
(declare-fun t159_def_{—}4_{—}5( ) Bool)
(declare-fun t159_val_{—}4_{—}5( ) Real)
(assert (not t159_def_{—}1_{—}1))
(assert (not t159_def_{—}2_{—}1))
(assert (not t159_def_{—}3_{—}1))
(assert (not t159_def_{—}4_{—}1))
(assert (not t159_def_{—}1_{—}2))
(assert (not t159_def_{—}2_{—}2))
(assert (not t159_def_{—}3_{—}2))
(assert (not t159_def_{—}4_{—}2))
(assert (not t159_def_{—}1_{—}3))
(assert (not t159_def_{—}2_{—}3))
(assert (not t159_def_{—}3_{—}3))
(assert (not t159_def_{—}4_{—}3))
(assert (not t159_def_{—}1_{—}4))
(assert (not t159_def_{—}2_{—}4))
(assert (not t159_def_{—}3_{—}4))
(assert (not t159_def_{—}4_{—}4))
(assert t159_def_{—}1_{—}5)
(assert (implies t158_def_{—}1 (=t159_val_{—}1_{—}5 t158_val_{—}1)))
(assert (implies (not t158_def_{—}1) (=t159_val_{—}1_{—}5 0.0)))
(assert t159_def_{—}2_{—}5)
(assert (implies t158_def_{—}2 (=t159_val_{—}2_{—}5 (+t158_val_{—}2 t159_val_{—}1_{—}5))))
(assert (implies (not t158_def_{—}2) (=t159_val_{—}2_{—}5 t159_val_{—}1_{—}5)))
(assert t159_def_{—}3_{—}5)
(assert (implies t158_def_{—}3 (=t159_val_{—}3_{—}5 (+t158_val_{—}3 t159_val_{—}2_{—}5))))
(assert (implies (not t158_def_{—}3) (=t159_val_{—}3_{—}5 t159_val_{—}2_{—}5)))
(assert t159_def_{—}4_{—}5)
(assert (implies t158_def_{—}4 (=t159_val_{—}4_{—}5 (+t158_val_{—}4 t159_val_{—}3_{—}5))))
(assert (implies (not t158_def_{—}4) (=t159_val_{—}4_{—}5 t159_val_{—}3_{—}5)))
(declare-fun t159_def_{—}1( ) Bool)
(declare-fun t159_val_{—}1( ) Real)
(assert (=t159_def_{—}4_{—}1 t159_def_{—}1))
(assert (=t159_val_{—}4_{—}1 t159_val_{—}1))
(declare-fun t159_def_{—}2( ) Bool)
(declare-fun t159_val_{—}2( ) Real)
(assert (=t159_def_{—}4_{—}2 t159_def_{—}2))
(assert (=t159_val_{—}4_{—}2 t159_val_{—}2))
(declare-fun t159_def_{—}3( ) Bool)
(declare-fun t159_val_{—}3( ) Real)
(assert (=t159_def_{—}4_{—}3 t159_def_{—}3))
(assert (=t159_val_{—}4_{—}3 t159_val_{—}3))
(declare-fun t159_def_{—}4( ) Bool)
(declare-fun t159_val_{—}4( ) Real)
(assert (=t159_def_{—}4_{—}4 t159_def_{—}4))
(assert (=t159_val_{—}4_{—}4 t159_val_{—}4))
(declare-fun t159_def_{—}5( ) Bool)
(declare-fun t159_val_{—}5( ) Real)
(assert (=t159_def_{—}4_{—}5 t159_def_{—}5))
(assert (=t159_val_{—}4_{—}5 t159_val_{—}5))
(declare-fun t160_def_{—}1( ) Bool)
(declare-fun t160_val_{—}1( ) Real)
(assert t160_def_{—}1)
(assert (=t160_val_{—}1 1.0))
(declare-fun t160_def_{—}2( ) Bool)
(declare-fun t160_val_{—}2( ) Real)
(assert t160_def_{—}2)
(assert (=t160_val_{—}2 1.0))
(declare-fun t160_def_{—}3( ) Bool)
(declare-fun t160_val_{—}3( ) Real)
(assert t160_def_{—}3)
(assert (=t160_val_{—}3 1.0))
(declare-fun t160_def_{—}4( ) Bool)
(declare-fun t160_val_{—}4( ) Real)
(assert t160_def_{—}4)
(assert (=t160_val_{—}4 1.0))
(declare-fun t160_def_{—}5( ) Bool)
(declare-fun t160_val_{—}5( ) Real)
(assert t160_def_{—}5)
(assert (=t160_val_{—}5 1.0))
(declare-fun t161_def_{—}1( ) Bool)
(declare-fun t161_val_{—}1( ) Real)
(assert t161_def_{—}1)
(assert (=t161_val_{—}1 1.0))
(declare-fun t161_def_{—}2( ) Bool)
(declare-fun t161_val_{—}2( ) Real)
(assert t161_def_{—}2)
(assert (=t161_val_{—}2 1.0))
(declare-fun t161_def_{—}3( ) Bool)
(declare-fun t161_val_{—}3( ) Real)
(assert t161_def_{—}3)
(assert (=t161_val_{—}3 1.0))
(declare-fun t161_def_{—}4( ) Bool)
(declare-fun t161_val_{—}4( ) Real)
(assert t161_def_{—}4)
(assert (=t161_val_{—}4 1.0))
(declare-fun t161_def_{—}5( ) Bool)
(declare-fun t161_val_{—}5( ) Real)
(assert t161_def_{—}5)
(assert (=t161_val_{—}5 1.0))
(declare-fun t162_def_{—}1( ) Bool)
(declare-fun t162_val_{—}1( ) Real)
(assert (not t162_def_{—}1))
(declare-fun t162_def_{—}2( ) Bool)
(declare-fun t162_val_{—}2( ) Real)
(assert (not t162_def_{—}2))
(declare-fun t162_def_{—}3( ) Bool)
(declare-fun t162_val_{—}3( ) Real)
(assert (not t162_def_{—}3))
(declare-fun t162_def_{—}4( ) Bool)
(declare-fun t162_val_{—}4( ) Real)
(assert (not t162_def_{—}4))
(declare-fun t162_def_{—}5( ) Bool)
(declare-fun t162_val_{—}5( ) Real)
(assert (not t162_def_{—}5))
(declare-fun t163_def_{—}1( ) Bool)
(declare-fun t163_val_{—}1( ) Real)
(declare-fun var12_{—}1( ) Real)
(assert (=var12_{—}1 t163_val_{—}1))
(declare-fun t163_def_{—}2( ) Bool)
(declare-fun t163_val_{—}2( ) Real)
(declare-fun var12_{—}2( ) Real)
(assert (=var12_{—}2 t163_val_{—}2))
(declare-fun t163_def_{—}3( ) Bool)
(declare-fun t163_val_{—}3( ) Real)
(declare-fun var12_{—}3( ) Real)
(assert (=var12_{—}3 t163_val_{—}3))
(declare-fun t163_def_{—}4( ) Bool)
(declare-fun t163_val_{—}4( ) Real)
(declare-fun var12_{—}4( ) Real)
(assert (=var12_{—}4 t163_val_{—}4))
(declare-fun t163_def_{—}5( ) Bool)
(declare-fun t163_val_{—}5( ) Real)
(declare-fun var12_{—}5( ) Real)
(assert (=var12_{—}5 t163_val_{—}5))
(assert (implies (and (and t157_def_{—}1 (>=t157_val_{—}1 0.0)) (not t159_def_{—}1))(not t163_def_{—}1)))
(assert (implies (and (and (and (>=t157_val_{—}1 0.0) t157_def_{—}1)(and (>=t159_val_{—}1 0.0) t159_def_{—}1)) t160_def_{—}1) (and t163_def_{—}1 (=t163_val_{—}1 (*t159_val_{—}1 t160_val_{—}1)))))
(assert (implies (and (and (and (>=t157_val_{—}1 0.0) t157_def_{—}1)(and (>=t159_val_{—}1 0.0) t159_def_{—}1)) (not t160_def_{—}1)) (not t163_def_{—}1)))
(assert (implies (and (and (and (>=t157_val_{—}1 0.0) t157_def_{—}1)(and (<t159_val_{—}1 0.0) t159_def_{—}1)) t161_def_{—}1) (and t163_def_{—}1 (=t163_val_{—}1 (*t159_val_{—}1 t161_val_{—}1)))))
(assert (implies (and (and (and (>=t157_val_{—}1 0.0) t157_def_{—}1)(and (<t159_val_{—}1 0.0) t159_def_{—}1)) (not t161_def_{—}1)) (not t163_def_{—}1)))
(assert (implies (and (and (>=t157_val_{—}1 0.0) t157_def_{—}1) (not t159_def_{—}1))(not t163_def_{—}1)))
(assert (implies (and (and (<t157_val_{—}1 0.0) t157_def_{—}1) t162_def_{—}1)(and t163_def_{—}1 (=t163_val_{—}1 t162_val_{—}1))))
(assert (implies (and (and (<t157_val_{—}1 0.0) t157_def_{—}1) (not t162_def_{—}1))(not t163_def_{—}1)))
(assert (implies (not t157_def_{—}1) (not t163_def_{—}1)))
(assert (implies (and (and t157_def_{—}2 (>=t157_val_{—}2 0.0)) (not t159_def_{—}2))(not t163_def_{—}2)))
(assert (implies (and (and (and (>=t157_val_{—}2 0.0) t157_def_{—}2)(and (>=t159_val_{—}2 0.0) t159_def_{—}2)) t160_def_{—}2) (and t163_def_{—}2 (=t163_val_{—}2 (*t159_val_{—}2 t160_val_{—}2)))))
(assert (implies (and (and (and (>=t157_val_{—}2 0.0) t157_def_{—}2)(and (>=t159_val_{—}2 0.0) t159_def_{—}2)) (not t160_def_{—}2)) (not t163_def_{—}2)))
(assert (implies (and (and (and (>=t157_val_{—}2 0.0) t157_def_{—}2)(and (<t159_val_{—}2 0.0) t159_def_{—}2)) t161_def_{—}2) (and t163_def_{—}2 (=t163_val_{—}2 (*t159_val_{—}2 t161_val_{—}2)))))
(assert (implies (and (and (and (>=t157_val_{—}2 0.0) t157_def_{—}2)(and (<t159_val_{—}2 0.0) t159_def_{—}2)) (not t161_def_{—}2)) (not t163_def_{—}2)))
(assert (implies (and (and (>=t157_val_{—}2 0.0) t157_def_{—}2) (not t159_def_{—}2))(not t163_def_{—}2)))
(assert (implies (and (and (<t157_val_{—}2 0.0) t157_def_{—}2) t162_def_{—}2)(and t163_def_{—}2 (=t163_val_{—}2 t162_val_{—}2))))
(assert (implies (and (and (<t157_val_{—}2 0.0) t157_def_{—}2) (not t162_def_{—}2))(not t163_def_{—}2)))
(assert (implies (not t157_def_{—}2) (not t163_def_{—}2)))
(assert (implies (and (and t157_def_{—}3 (>=t157_val_{—}3 0.0)) (not t159_def_{—}3))(not t163_def_{—}3)))
(assert (implies (and (and (and (>=t157_val_{—}3 0.0) t157_def_{—}3)(and (>=t159_val_{—}3 0.0) t159_def_{—}3)) t160_def_{—}3) (and t163_def_{—}3 (=t163_val_{—}3 (*t159_val_{—}3 t160_val_{—}3)))))
(assert (implies (and (and (and (>=t157_val_{—}3 0.0) t157_def_{—}3)(and (>=t159_val_{—}3 0.0) t159_def_{—}3)) (not t160_def_{—}3)) (not t163_def_{—}3)))
(assert (implies (and (and (and (>=t157_val_{—}3 0.0) t157_def_{—}3)(and (<t159_val_{—}3 0.0) t159_def_{—}3)) t161_def_{—}3) (and t163_def_{—}3 (=t163_val_{—}3 (*t159_val_{—}3 t161_val_{—}3)))))
(assert (implies (and (and (and (>=t157_val_{—}3 0.0) t157_def_{—}3)(and (<t159_val_{—}3 0.0) t159_def_{—}3)) (not t161_def_{—}3)) (not t163_def_{—}3)))
(assert (implies (and (and (>=t157_val_{—}3 0.0) t157_def_{—}3) (not t159_def_{—}3))(not t163_def_{—}3)))
(assert (implies (and (and (<t157_val_{—}3 0.0) t157_def_{—}3) t162_def_{—}3)(and t163_def_{—}3 (=t163_val_{—}3 t162_val_{—}3))))
(assert (implies (and (and (<t157_val_{—}3 0.0) t157_def_{—}3) (not t162_def_{—}3))(not t163_def_{—}3)))
(assert (implies (not t157_def_{—}3) (not t163_def_{—}3)))
(assert (implies (and (and t157_def_{—}4 (>=t157_val_{—}4 0.0)) (not t159_def_{—}4))(not t163_def_{—}4)))
(assert (implies (and (and (and (>=t157_val_{—}4 0.0) t157_def_{—}4)(and (>=t159_val_{—}4 0.0) t159_def_{—}4)) t160_def_{—}4) (and t163_def_{—}4 (=t163_val_{—}4 (*t159_val_{—}4 t160_val_{—}4)))))
(assert (implies (and (and (and (>=t157_val_{—}4 0.0) t157_def_{—}4)(and (>=t159_val_{—}4 0.0) t159_def_{—}4)) (not t160_def_{—}4)) (not t163_def_{—}4)))
(assert (implies (and (and (and (>=t157_val_{—}4 0.0) t157_def_{—}4)(and (<t159_val_{—}4 0.0) t159_def_{—}4)) t161_def_{—}4) (and t163_def_{—}4 (=t163_val_{—}4 (*t159_val_{—}4 t161_val_{—}4)))))
(assert (implies (and (and (and (>=t157_val_{—}4 0.0) t157_def_{—}4)(and (<t159_val_{—}4 0.0) t159_def_{—}4)) (not t161_def_{—}4)) (not t163_def_{—}4)))
(assert (implies (and (and (>=t157_val_{—}4 0.0) t157_def_{—}4) (not t159_def_{—}4))(not t163_def_{—}4)))
(assert (implies (and (and (<t157_val_{—}4 0.0) t157_def_{—}4) t162_def_{—}4)(and t163_def_{—}4 (=t163_val_{—}4 t162_val_{—}4))))
(assert (implies (and (and (<t157_val_{—}4 0.0) t157_def_{—}4) (not t162_def_{—}4))(not t163_def_{—}4)))
(assert (implies (not t157_def_{—}4) (not t163_def_{—}4)))
(assert (implies (and (and t157_def_{—}5 (>=t157_val_{—}5 0.0)) (not t159_def_{—}5))(not t163_def_{—}5)))
(assert (implies (and (and (and (>=t157_val_{—}5 0.0) t157_def_{—}5)(and (>=t159_val_{—}5 0.0) t159_def_{—}5)) t160_def_{—}5) (and t163_def_{—}5 (=t163_val_{—}5 (*t159_val_{—}5 t160_val_{—}5)))))
(assert (implies (and (and (and (>=t157_val_{—}5 0.0) t157_def_{—}5)(and (>=t159_val_{—}5 0.0) t159_def_{—}5)) (not t160_def_{—}5)) (not t163_def_{—}5)))
(assert (implies (and (and (and (>=t157_val_{—}5 0.0) t157_def_{—}5)(and (<t159_val_{—}5 0.0) t159_def_{—}5)) t161_def_{—}5) (and t163_def_{—}5 (=t163_val_{—}5 (*t159_val_{—}5 t161_val_{—}5)))))
(assert (implies (and (and (and (>=t157_val_{—}5 0.0) t157_def_{—}5)(and (<t159_val_{—}5 0.0) t159_def_{—}5)) (not t161_def_{—}5)) (not t163_def_{—}5)))
(assert (implies (and (and (>=t157_val_{—}5 0.0) t157_def_{—}5) (not t159_def_{—}5))(not t163_def_{—}5)))
(assert (implies (and (and (<t157_val_{—}5 0.0) t157_def_{—}5) t162_def_{—}5)(and t163_def_{—}5 (=t163_val_{—}5 t162_val_{—}5))))
(assert (implies (and (and (<t157_val_{—}5 0.0) t157_def_{—}5) (not t162_def_{—}5))(not t163_def_{—}5)))
(assert (implies (not t157_def_{—}5) (not t163_def_{—}5)))
(declare-fun t164_def_{—}1( ) Bool)
(declare-fun t164_val_{—}1( ) Real)
(assert t164_def_{—}1)
(assert (=t164_val_{—}1 1.0))
(declare-fun t164_def_{—}2( ) Bool)
(declare-fun t164_val_{—}2( ) Real)
(assert t164_def_{—}2)
(assert (=t164_val_{—}2 1.0))
(declare-fun t164_def_{—}3( ) Bool)
(declare-fun t164_val_{—}3( ) Real)
(assert t164_def_{—}3)
(assert (=t164_val_{—}3 1.0))
(declare-fun t164_def_{—}4( ) Bool)
(declare-fun t164_val_{—}4( ) Real)
(assert t164_def_{—}4)
(assert (=t164_val_{—}4 1.0))
(declare-fun t164_def_{—}5( ) Bool)
(declare-fun t164_val_{—}5( ) Real)
(assert t164_def_{—}5)
(assert (=t164_val_{—}5 1.0))
(declare-fun t165_def_{—}1_{—}1( ) Bool)
(declare-fun t165_val_{—}1_{—}1( ) Real)
(declare-fun t165_def_{—}2_{—}1( ) Bool)
(declare-fun t165_val_{—}2_{—}1( ) Real)
(declare-fun t165_def_{—}3_{—}1( ) Bool)
(declare-fun t165_val_{—}3_{—}1( ) Real)
(declare-fun t165_def_{—}4_{—}1( ) Bool)
(declare-fun t165_val_{—}4_{—}1( ) Real)
(declare-fun t165_def_{—}1_{—}2( ) Bool)
(declare-fun t165_val_{—}1_{—}2( ) Real)
(declare-fun t165_def_{—}2_{—}2( ) Bool)
(declare-fun t165_val_{—}2_{—}2( ) Real)
(declare-fun t165_def_{—}3_{—}2( ) Bool)
(declare-fun t165_val_{—}3_{—}2( ) Real)
(declare-fun t165_def_{—}4_{—}2( ) Bool)
(declare-fun t165_val_{—}4_{—}2( ) Real)
(declare-fun t165_def_{—}1_{—}3( ) Bool)
(declare-fun t165_val_{—}1_{—}3( ) Real)
(declare-fun t165_def_{—}2_{—}3( ) Bool)
(declare-fun t165_val_{—}2_{—}3( ) Real)
(declare-fun t165_def_{—}3_{—}3( ) Bool)
(declare-fun t165_val_{—}3_{—}3( ) Real)
(declare-fun t165_def_{—}4_{—}3( ) Bool)
(declare-fun t165_val_{—}4_{—}3( ) Real)
(declare-fun t165_def_{—}1_{—}4( ) Bool)
(declare-fun t165_val_{—}1_{—}4) Real)
(declare-fun t165_def_{—}2_{—}4( ) Bool)
(declare-fun t165_val_{—}2_{—}4( ) Real)
(declare-fun t165_def_{—}3_{—}4( ) Bool)
(declare-fun t165_val_{—}3_{—}4( ) Real)
(declare-fun t165_def_{—}4_{—}4( ) Bool)
(declare-fun t165_val_{—}4_{—}4( ) Real)
(declare-fun t165_def_{—}1_{—}5( ) Bool)
(declare-fun t165_val_{—}1_{—}5( ) Real)
(declare-fun t165_def_{—}2_{—}5( ) Bool)
(declare-fun t165_val_{—}2_{—}5( ) Real)
(declare-fun t165_def_{—}3_{—}5( ) Bool)
(declare-fun t165_val_{—}3_{—}5( ) Real)
(declare-fun t165_def_{—}4_{—}5( ) Bool)
(declare-fun t165_val_{—}4_{—}5( ) Real)
(assert (not t165_def_{—}1_{—}1))
(assert (not t165_def_{—}2_{—}1))
(assert (not t165_def_{—}3_{—}1))
(assert (not t165_def_{—}4_{—}1))
(assert (not t165_def_{—}1_{—}2))
(assert (not t165_def_{—}2_{—}2))
(assert (not t165_def_{—}3_{—}2))
(assert (not t165_def_{—}4_{—}2))
(assert (not t165_def_{—}1_{—}3))
(assert (not t165_def_{—}2_{—}3))
(assert (not t165_def_{—}3_{—}3))
(assert (not t165_def_{—}4_{—}3))
(assert (not t165_def_{—}1_{—}4))
(assert (not t165_def_{—}2_{—}4))
(assert (not t165_def_{—}3_{—}4))
(assert (not t165_def_{—}4_{—}4))
(assert (implies t158_def_{—}1 t165_def_{—}1_{—}5))
(assert (implies (not t158_def_{—}1) (not t165_def_{—}1_{—}5)))
(assert (implies t158_def_{—}1 (=t165_val_{—}1_{—}5 t158_val_{—}1)))
(assert (implies (and (not t165_def_{—}1_{—}5) (not t158_def_{—}2)) (not t165_def_{—}2_{—}5)))
(assert (implies (and (not t165_def_{—}1_{—}5) t158_def_{—}2) (and t165_def_{—}2_{—}5 (=t165_val_{—}2_{—}5 t158_val_{—}2))))
(assert (implies (and t165_def_{—}1_{—}5 (not t158_def_{—}2)) (and t165_def_{—}2_{—}5 (=t165_val_{—}2_{—}5 t165_val_{—}1_{—}5))))
(assert (implies (and (and t165_def_{—}1_{—}5 t158_def_{—}2) (>t158_val_{—}2 t165_val_{—}1_{—}5)) (and t165_def_{—}2_{—}5 (=t165_val_{—}2_{—}5 t158_val_{—}2))))
(assert (implies (and (and t165_def_{—}1_{—}5 t158_def_{—}2) (<=t158_val_{—}2 t165_val_{—}1_{—}5)) (and t165_def_{—}2_{—}5 (=t165_val_{—}2_{—}5 t165_val_{—}1_{—}5))))
(assert (implies (and (not t165_def_{—}2_{—}5) (not t158_def_{—}3)) (not t165_def_{—}3_{—}5)))
(assert (implies (and (not t165_def_{—}2_{—}5) t158_def_{—}3) (and t165_def_{—}3_{—}5 (=t165_val_{—}3_{—}5 t158_val_{—}3))))
(assert (implies (and t165_def_{—}2_{—}5 (not t158_def_{—}3)) (and t165_def_{—}3_{—}5 (=t165_val_{—}3_{—}5 t165_val_{—}2_{—}5))))
(assert (implies (and (and t165_def_{—}2_{—}5 t158_def_{—}3) (>t158_val_{—}3 t165_val_{—}2_{—}5)) (and t165_def_{—}3_{—}5 (=t165_val_{—}3_{—}5 t158_val_{—}3))))
(assert (implies (and (and t165_def_{—}2_{—}5 t158_def_{—}3) (<=t158_val_{—}3 t165_val_{—}2_{—}5)) (and t165_def_{—}3_{—}5 (=t165_val_{—}3_{—}5 t165_val_{—}2_{—}5))))
(assert (implies (and (not t165_def_{—}3_{—}5) (not t158_def_{—}4)) (not t165_def_{—}4_{—}5)))
(assert (implies (and (not t165_def_{—}3_{—}5) t158_def_{—}4) (and t165_def_{—}4_{—}5 (=t165_val_{—}4_{—}5 t158_val_{—}4))))
(assert (implies (and t165_def_{—}3_{—}5 (not t158_def_{—}4)) (and t165_def_{—}4_{—}5 (=t165_val_{—}4_{—}5 t165_val_{—}3_{—}5))))
(assert (implies (and (and t165_def_{—}3_{—}5 t158_def_{—}4) (>t158_val_{—}4 t165_val_{—}3_{—}5)) (and t165_def_{—}4_{—}5 (=t165_val_{—}4_{—}5 t158_val_{—}4))))
(assert (implies (and (and t165_def_{—}3_{—}5 t158_def_{—}4) (<=t158_val_{—}4 t165_val_{—}3_{—}5)) (and t165_def_{—}4_{—}5 (=t165_val_{—}4_{—}5 t165_val_{—}3_{—}5))))
(declare-fun t165_def_{—}1( ) Bool)
(declare-fun t165_val_{—}1( ) Real)
(assert (=t165_def_{—}4_{—}1 t165_def_{—}1))
(assert (=t165_val_{—}4_{—}1 t165_val_{—}1))
(declare-fun t165_def_{—}2( ) Bool)
(declare-fun t165_val_{—}2( ) Real)
(assert (=t165_def_{—}4_{—}2 t165_def_{—}2))
(assert (=t165_val_{—}4_{—}2 t165_val_{—}2))
(declare-fun t165_def_{—}3( ) Bool)
(declare-fun t165_val_{—}3( ) Real)
(assert (=t165_def_{—}4_{—}3 t165_def_{—}3))
(assert (=t165_val_{—}4_{—}3 t165_val_{—}3))
(declare-fun t165_def_{—}4( ) Bool)
(declare-fun t165_val_{—}4( ) Real)
(assert (=t165_def_{—}4_{—}4 t165_def_{—}4))
(assert (=t165_val_{—}4_{—}4 t165_val_{—}4))
(declare-fun t165_def_{—}5( ) Bool)
(declare-fun t165_val_{—}5( ) Real)
(assert (=t165_def_{—}4_{—}5 t165_def_{—}5))
(assert (=t165_val_{—}4_{—}5 t165_val_{—}5))
(declare-fun t166_def_{—}1( ) Bool)
(declare-fun t166_val_{—}1( ) Real)
(assert t166_def_{—}1)
(assert (=t166_val_{—}1 1.0))
(declare-fun t166_def_{—}2( ) Bool)
(declare-fun t166_val_{—}2( ) Real)
(assert t166_def_{—}2)
(assert (=t166_val_{—}2 1.0))
(declare-fun t166_def_{—}3( ) Bool)
(declare-fun t166_val_{—}3( ) Real)
(assert t166_def_{—}3)
(assert (=t166_val_{—}3 1.0))
(declare-fun t166_def_{—}4( ) Bool)
(declare-fun t166_val_{—}4( ) Real)
(assert t166_def_{—}4)
(assert (=t166_val_{—}4 1.0))
(declare-fun t166_def_{—}5( ) Bool)
(declare-fun t166_val_{—}5( ) Real)
(assert t166_def_{—}5)
(assert (=t166_val_{—}5 1.0))
(declare-fun t167_def_{—}1( ) Bool)
(declare-fun t167_val_{—}1( ) Real)
(assert t167_def_{—}1)
(assert (=t167_val_{—}1 1.0))
(declare-fun t167_def_{—}2( ) Bool)
(declare-fun t167_val_{—}2( ) Real)
(assert t167_def_{—}2)
(assert (=t167_val_{—}2 1.0))
(declare-fun t167_def_{—}3( ) Bool)
(declare-fun t167_val_{—}3( ) Real)
(assert t167_def_{—}3)
(assert (=t167_val_{—}3 1.0))
(declare-fun t167_def_{—}4( ) Bool)
(declare-fun t167_val_{—}4( ) Real)
(assert t167_def_{—}4)
(assert (=t167_val_{—}4 1.0))
(declare-fun t167_def_{—}5( ) Bool)
(declare-fun t167_val_{—}5( ) Real)
(assert t167_def_{—}5)
(assert (=t167_val_{—}5 1.0))
(declare-fun t168_def_{—}1( ) Bool)
(declare-fun t168_val_{—}1( ) Real)
(assert (not t168_def_{—}1))
(declare-fun t168_def_{—}2( ) Bool)
(declare-fun t168_val_{—}2( ) Real)
(assert (not t168_def_{—}2))
(declare-fun t168_def_{—}3( ) Bool)
(declare-fun t168_val_{—}3( ) Real)
(assert (not t168_def_{—}3))
(declare-fun t168_def_{—}4( ) Bool)
(declare-fun t168_val_{—}4( ) Real)
(assert (not t168_def_{—}4))
(declare-fun t168_def_{—}5( ) Bool)
(declare-fun t168_val_{—}5( ) Real)
(assert (not t168_def_{—}5))
(declare-fun t169_def_{—}1( ) Bool)
(declare-fun t169_val_{—}1( ) Real)
(declare-fun var13_{—}1( ) Real)
(assert (=var13_{—}1 t169_val_{—}1))
(declare-fun t169_def_{—}2( ) Bool)
(declare-fun t169_val_{—}2( ) Real)
(declare-fun var13_{—}2( ) Real)
(assert (=var13_{—}2 t169_val_{—}2))
(declare-fun t169_def_{—}3( ) Bool)
(declare-fun t169_val_{—}3( ) Real)
(declare-fun var13_{—}3( ) Real)
(assert (=var13_{—}3 t169_val_{—}3))
(declare-fun t169_def_{—}4( ) Bool)
(declare-fun t169_val_{—}4( ) Real)
(declare-fun var13_{—}4( ) Real)
(assert (=var13_{—}4 t169_val_{—}4))
(declare-fun t169_def_{—}5( ) Bool)
(declare-fun t169_val_{—}5( ) Real)
(declare-fun var13_{—}5( ) Real)
(assert (=var13_{—}5 t169_val_{—}5))
(assert (implies (and (and t164_def_{—}1 (>=t164_val_{—}1 0.0)) (not t165_def_{—}1))(not t169_def_{—}1)))
(assert (implies (and (and (and (>=t164_val_{—}1 0.0) t164_def_{—}1)(and (>=t165_val_{—}1 0.0) t165_def_{—}1)) t166_def_{—}1) (and t169_def_{—}1 (=t169_val_{—}1 (*t165_val_{—}1 t166_val_{—}1)))))
(assert (implies (and (and (and (>=t164_val_{—}1 0.0) t164_def_{—}1)(and (>=t165_val_{—}1 0.0) t165_def_{—}1)) (not t166_def_{—}1)) (not t169_def_{—}1)))
(assert (implies (and (and (and (>=t164_val_{—}1 0.0) t164_def_{—}1)(and (<t165_val_{—}1 0.0) t165_def_{—}1)) t167_def_{—}1) (and t169_def_{—}1 (=t169_val_{—}1 (*65 t165_val_{—}1 t167_val_{—}1)))))
(assert (implies (and (and (and (>=t164_val_{—}1 0.0) t164_def_{—}1)(and (<t165_val_{—}1 0.0) t165_def_{—}1)) (not t167_def_{—}1)) (not t169_def_{—}1)))
(assert (implies (and (and (>=t164_val_{—}1 0.0) t164_def_{—}1) (not t165_def_{—}1))(not t169_def_{—}1)))
(assert (implies (and (and (<t164_val_{—}1 0.0) t164_def_{—}1) t168_def_{—}1)(and t169_def_{—}1 (=t169_val_{—}1 t168_val_{—}1))))
(assert (implies (and (and (<t164_val_{—}1 0.0) t164_def_{—}1) (not t168_def_{—}1))(not t169_def_{—}1)))
(assert (implies (not t164_def_{—}1) (not t169_def_{—}1)))
(assert (implies (and (and t164_def_{—}2 (>=t164_val_{—}2 0.0)) (not t165_def_{—}2))(not t169_def_{—}2)))
(assert (implies (and (and (and (>=t164_val_{—}2 0.0) t164_def_{—}2)(and (>=t165_val_{—}2 0.0) t165_def_{—}2)) t166_def_{—}2) (and t169_def_{—}2 (=t169_val_{—}2 (*t165_val_{—}2 t166_val_{—}2)))))
(assert (implies (and (and (and (>=t164_val_{—}2 0.0) t164_def_{—}2)(and (>=t165_val_{—}2 0.0) t165_def_{—}2)) (not t166_def_{—}2)) (not t169_def_{—}2)))
(assert (implies (and (and (and (>=t164_val_{—}2 0.0) t164_def_{—}2)(and (<t165_val_{—}2 0.0) t165_def_{—}2)) t167_def_{—}2) (and t169_def_{—}2 (=t169_val_{—}2 (*t165_val_{—}2 t167_val_{—}2)))))
(assert (implies (and (and (and (>=t164_val_{—}2 0.0) t164_def_{—}2)(and (<t165_val_{—}2 0.0) t165_def_{—}2)) (not t167_def_{—}2)) (not t169_def_{—}2)))
(assert (implies (and (and (>=t164_val_{—}2 0.0) t164_def_{—}2) (not t165_def_{—}2))(not t169_def_{—}2)))
(assert (implies (and (and (<t164_val_{—}2 0.0) t164_def_{—}2) t168_def_{—}2)(and t169_def_{—}2 (=t169_val_{—}2 t168_val_{—}2))))
(assert (implies (and (and (<t164_val_{—}2 0.0) t164_def_{—}2) (not t168_def_{—}2))(not t169_def_{—}2)))
(assert (implies (not t164_def_{—}2) (not t169_def_{—}2)))
(assert (implies (and (and t164_def_{—}3 (>=t164_val_{—}3 0.0)) (not t165_def_{—}3))(not t169_def_{—}3)))
(assert (implies (and (and (and (>=t164_val_{—}3 0.0) t164_def_{—}3)(and (>=t165_val_{—}3 0.0) t165_def_{—}3)) t166_def_{—}3) (and t169_def_{—}3 (=t169_val_{—}3 (*t165_val_{—}3 t166_val_{—}3)))))
(assert (implies (and (and (and (>=t164_val_{—}3 0.0) t164_def_{—}3)(and (>=t165_val_{—}3 0.0) t165_def_{—}3)) (not t166_def_{—}3)) (not t169_def_{—}3)))
(assert (implies (and (and (and (>=t164_val_{—}3 0.0) t164_def_{—}3)(and (<t165_val_{—}3 0.0) t165_def_{—}3)) t167_def_{—}3) (and t169_def_{—}3 (=t169_val_{—}3 (*t165_val_{—}3 t167_val_{—}3)))))
(assert (implies (and (and (and (>=t164_val_{—}3 0.0) t164_def_{—}3)(and (<t165_val_{—}3 0.0) t165_def_{—}3)) (not t167_def_{—}3)) (not t169_def_{—}3)))
(assert (implies (and (and (>=t164_val_{—}3 0.0) t164_def_{—}3) (not t165_def_{—}3))(not t169_def_{—}3)))
(assert (implies (and (and (<t164_val_{—}3 0.0) t164_def_{—}3) t168_def_{—}3)(and t169_def_{—}3 (=t169_val_{—}3 t168_val_{—}3))))
(assert (implies (and (and (<t164_val_{—}3 0.0) t164_def_{—}3) (not t168_def_{—}3))(not t169_def_{—}3)))
(assert (implies (not t164_def_{—}3) (not t169_def_{—}3)))
(assert (implies (and (and t164_def_{—}4 (>=t164_val_{—}4 0.0)) (not t165_def_{—}4))(not t169_def_{—}4)))
(assert (implies (and (and (and (>=t164_val_{—}4 0.0) t164_def_{—}4)(and (>=t165_val_{—}4 0.0) t165_def_{—}4)) t166_def_{—}4) (and t169_def_{—}4 (=t169_val_{—}4 (*t165_val_{—}4 t166_val_{—}4)))))
(assert (implies (and (and (and (>=t164_val_{—}4 0.0) t164_def_{—}4)(and (>=t165_val_{—}4 0.0) t165_def_{—}4)) (not t166_def_{—}4)) (not t169_def_{—}4)))
(assert (implies (and (and (and (>=t164_val_{—}4 0.0) t164_def_{—}4)(and (<t165_val_{—}4 0.0) t165_def_{—}4)) t167_def_{—}4) (and t169_def_{—}4 (=t169_val_{—}4 (*t165_val_{—}4 t167_val_{—}4)))))
(assert (implies (and (and (and (>=t164_val_{—}4 0.0) t164_def_{—}4)(and (<t165_val_{—}4 0.0) t165_def_{—}4)) (not t167_def_{—}4)) (not t169_def_{—}4)))
(assert (implies (and (and (>=t164_val_{—}4 0.0) t164_def_{—}4) (not t165_def_{—}4))(not t169_def_{—}4)))
(assert (implies (and (and (<t164_val_{—}4 0.0) t164_def_{—}4) t168_def_{—}4)(and t169_def_{—}4 (=t169_val_{—}4 t168_val_{—}4))))
(assert (implies (and (and (<t164_val_{—}4 0.0) t164_def_{—}4) (not t168_def_{—}4))(not t169_def_{—}4)))
(assert (implies (not t164_def_{—}4) (not t169_def_{—}4)))
(assert (implies (and (and t164_def_{—}5 (>=t164_val_{—}5 0.0)) (not t165_def_{—}5))(not t169_def_{—}5)))
(assert (implies (and (and (and (>=t164_val_{—}5 0.0) t164_def_{—}5)(and (>=t165_val_{—}5 0.0) t165_def_{—}5)) t166_def_{—}5) (and t169_def_{—}5 (=t169_val_{—}5 (*t165_val_{—}5 t166_val_{—}5)))))
(assert (implies (and (and (and (>=t164_val_{—}5 0.0) t164_def_{—}5)(and (>=t165_val_{—}5 0.0) t165_def_{—}5)) (not t166_def_{—}5)) (not t169_def_{—}5)))
(assert (implies (and (and (and (>=t164_val_{—}5 0.0) t164_def_{—}5)(and (<t165_val_{—}5 0.0) t165_def_{—}5)) t167_def_{—}5) (and t169_def_{—}5 (=t169_val_{—}5 (*t165_val_{—}5 t167_val_{—}5)))))
(assert (implies (and (and (and (>=t164_val_{—}5 0.0) t164_def_{—}5)(and (<t165_val_{—}5 0.0) t165_def_{—}5)) (not t167_def_{—}5)) (not t169_def_{—}5)))
(assert (implies (and (and (>=t164_val_{—}5 0.0) t164_def_{—}5) (not t165_def_{—}5))(not t169_def_{—}5)))
(assert (implies (and (and (<t164_val_{—}5 0.0) t164_def_{—}5) t168_def_{—}5)(and t169_def_{—}5 (=t169_val_{—}5 t168_val_{—}5))))
(assert (implies (and (and (<t164_val_{—}5 0.0) t164_def_{—}5) (not t168_def_{—}5))(not t169_def_{—}5)))
(assert (implies (not t164_def_{—}5) (not t169_def_{—}5)))
(declare-fun t170_def_{—}1( ) Bool)
(declare-fun t170_val_{—}1( ) Real)
(assert t170_def_{—}1)
(assert (=t170_val_{—}1 0.0))
(declare-fun t170_def_{—}2( ) Bool)
(declare-fun t170_val_{—}2( ) Real)
(assert t170_def_{—}2)
(assert (=t170_val_{—}2 0.0))
(declare-fun t170_def_{—}3( ) Bool)
(declare-fun t170_val_{—}3( ) Real)
(assert t170_def_{—}3)
(assert (=t170_val_{—}3 0.0))
(declare-fun t170_def_{—}4( ) Bool)
(declare-fun t170_val_{—}4( ) Real)
(assert t170_def_{—}4)
(assert (=t170_val_{—}4 0.0))
(declare-fun t170_def_{—}5( ) Bool)
(declare-fun t170_val_{—}5( ) Real)
(assert t170_def_{—}5)
(assert (=t170_val_{—}5 0.0))
(declare-fun t171_def_{—}1( ) Bool)
(declare-fun t171_val_{—}1( ) Real)
(assert (implies (not t170_def_{—}1) (not t171_def_{—}1)))
(assert (implies (not t163_def_{—}1) (not t171_def_{—}1)))
(assert (implies (and t170_def_{—}1 t163_def_{—}1) t171_def_{—}1))
(assert (implies (and t171_def_{—}1 (<t170_val_{—}1 t163_val_{—}1)) (=t171_val_{—}1 1.0)))
(assert (implies (and t171_def_{—}1 (>=t170_val_{—}1 t163_val_{—}1)) (=t171_val_{—}1 (−1.0))))
(declare-fun t171_def_{—}2( ) Bool)
(declare-fun t171_val_{—}2( ) Real)
(assert (implies (not t170_def_{—}2) (not t171_def_{—}2)))
(assert (implies (not t163_def_{—}2) (not t171_def_{—}2)))
(assert (implies (and t170_def_{—}2 t163_def_{—}2) t171_def_{—}2))
(assert (implies (and t171_def_{—}2 (<t170_val_{—}2 t163_val_{—}2)) (=t171_val_{—}2 1.0)))
(assert (implies (and t171_def_{—}2 (>=t170_val_{—}2 t163_val_{—}2)) (=t171_val_{—}2 (−1.0))))
(declare-fun t171_def_{—}3( ) Bool)
(declare-fun t171_val_{—}3( ) Real)
(assert (implies (not t170_def_{—}3) (not t171_def_{—}3)))
(assert (implies (not t163_def_{—}3) (not t171_def_{—}3)))
(assert (implies (and t170_def_{—}3 t163_def_{—}3) t171_def_{—}3))
(assert (implies (and t171_def_{—}3 (<t170_val_{—}3 t163_val_{—}3)) (=t171_val_{—}3 1.0)))
(assert (implies (and t171_def_{—}3 (>=t170_val_{—}3 t163_val_{—}3)) (=t171_val_{—}3 (−1.0))))
(declare-fun t171_def_{—}4( ) Bool)
(declare-fun t171_val_{—}4( ) Real)
(assert (implies (not t170_def_{—}4) (not t171_def_{—}4)))
(assert (implies (not t163_def_{—}4) (not t171_def_{—}4)))
(assert (implies (and t170_def_{—}4 t163_def_{—}4) t171_def_{—}4))
(assert (implies (and t171_def_{—}4 (<t170_val_{—}4 t163_val_{—}4)) (=t171_val_{—}4 1.0)))
(assert (implies (and t171_def_{—}4 (>=t170_val_{—}4 t163_val_{—}4)) (=t171_val_{—}4 (−1.0))))
(declare-fun t171_def_{—}5( ) Bool)
(declare-fun t171_val_{—}5( ) Real)
(assert (implies (not t170_def_{—}5) (not t171_def_{—}5)))
(assert (implies (not t163_def_{—}5) (not t171_def_{—}5)))
(assert (implies (and t170_def_{—}5 t163_def_{—}5) t171_def_{—}5))
(assert (implies (and t171_def_{—}5 (<t170_val_{—}5 t163_val_{—}5)) (=t171_val_{—}5 1.0)))
(assert (implies (and t171_def_{—}5 (>=t170_val_{—}5 t163_val_{—}5)) (=t171_val_{—}5 (−1.0))))
(declare-fun t172_def_{—}1( ) Bool)
(declare-fun t172_val_{—}1( ) Real)
(assert t172_def_{—}1)
(assert (=t172_val_{—}1 2.0))
(declare-fun t172_def_{—}2( ) Bool)
(declare-fun t172_val_{—}2( ) Real)
(assert t172_def_{—}2)
(assert (=t172_val_{—}2 2.0))
(declare-fun t172_def_{—}3( ) Bool)
(declare-fun t172_val_{—}3( ) Real)
(assert t172_def_{—}3)
(assert (=t172_val_{—}3 2.0))
(declare-fun t172_def_{—}4( ) Bool)
(declare-fun t172_val_{—}4( ) Real)
(assert t172_def_{—}4)
(assert (=t172_val_{—}4 2.0))
(declare-fun t172_def_{—}5( ) Bool)
(declare-fun t172_val_{—}5( ) Real)
(assert t172_def_{—}5)
(assert (=t172_val_{—}5 2.0))
(declare-fun t173_def_{—}1( ) Bool)
(declare-fun t173_val_{—}1( ) Real)
(assert t173_def_{—}1)
(assert (=t173_val_{—}1 1.0))
(declare-fun t173_def_{—}2( ) Bool)
(declare-fun t173_val_{—}2( ) Real)
(assert t173_def_{—}2)
(assert (=t173_val_{—}2 1.0))
(declare-fun t173_def_{—}3( ) Bool)
(declare-fun t173_val_{—}3( ) Real)
(assert t173_def_{—}3)
(assert (=t173_val_{—}3 1.0))
(declare-fun t173_def_{—}4( ) Bool)
(declare-fun t173_val_{—}4( ) Real)
(assert t173_def_{—}4)
(assert (=t173_val_{—}4 1.0))
(declare-fun t173_def_{—}5( ) Bool)
(declare-fun t173_val_{—}5( ) Real)
(assert t173_def_{—}5)
(assert (=t173_val_{—}5 1.0))
(declare-fun t174_def_{—}1( ) Bool)
(declare-fun t174_val_{—}1( ) Real)
(assert t174_def_{—}1)
(assert (=t174_val_{—}1 1.0))
(declare-fun t174_def_{—}2( ) Bool)
(declare-fun t174_val_{—}2( ) Real)
(assert t174_def_{—}2)
(assert (=t174_val_{—}2 1.0))
(declare-fun t174_def_{—}3( ) Bool)
(declare-fun t174_val_{—}3( ) Real)
(assert t174_def_{—}3)
(assert (=t174_val_{—}3 1.0))
(declare-fun t174_def_{—}4( ) Bool)
(declare-fun t174_val_{—}4( ) Real)
(assert t174_def_{—}4)
(assert (=t174_val_{—}4 1.0))
(declare-fun t174_def_{—}5( ) Bool)
(declare-fun t174_val_{—}5( ) Real)
(assert t174_def_{—}5)
(assert (=t174_val_{—}5 1.0))
(declare-fun t175_def_{—}1( ) Bool)
(declare-fun t175_val_{—}1( ) Real)
(assert (not t175_def_{—}1))
(declare-fun t175_def_{—}2( ) Bool)
(declare-fun t175_val_{—}2( ) Real)
(assert (not t175_def_{—}2))
(declare-fun t175_def_{—}3( ) Bool)
(declare-fun t175_val_{—}3( ) Real)
(assert (not t175_def_{—}3))
(declare-fun t175_def_{—}4( ) Bool)
(declare-fun t175_val_{—}4( ) Real)
(assert (not t175_def_{—}4))
(declare-fun t175_def_{—}5( ) Bool)
(declare-fun t175_val_{—}5( ) Real)
(assert (not t175_def_{—}5))
(declare-fun t176_def_{—}1( ) Bool)
(declare-fun t176_val_{—}1( ) Real)
(declare-fun var14_{—}1( ) Real)
(assert (=var14_{—}1 t176_val_{—}1))
(declare-fun t176_def_{—}2( ) Bool)
(declare-fun t176_val_{—}2( ) Real)
(declare-fun var14_{—}2( ) Real)
(assert (=var14_{—}2 t176_val_{—}2))
(declare-fun t176_def_{—}3( ) Bool)
(declare-fun t176_val_{—}3( ) Real)
(declare-fun var14_{—}3( ) Real)
(assert (=var14_{—}3 t176_val_{—}3))
(declare-fun t176_def_{—}4( ) Bool)
(declare-fun t176_val_{—}4( ) Real)
(declare-fun var14_{—}4( ) Real)
(assert (=var14_{—}4 t176_val_{—}4))
(declare-fun t176_def_{—}5( ) Bool)
(declare-fun t176_val_{—}5( ) Real)
(declare-fun var14_{—}5( ) Real)
(assert (=var14_{—}5 t176_val_{—}5))
(assert (implies (and (and t171_def_{—}1 (>=t171_val_{—}1 0.0)) (not t172_def_{—}1))(not t176_def_{—}1)))
(assert (implies (and (and (and (>=t171_val_{—}1 0.0) t171_def_{—}1)(and (>=t172_val_{—}1 0.0) t172_def_{—}1)) t173_def_{—}1) (and t176_def_{—}1 (=t176_val_{—}1 (*t172_val_{—}1 t173_val_{—}1)))))
(assert (implies (and (and (and (>=t171_val_{—}1 0.0) t171_def_{—}1)(and (>=t172_val_{—}1 0.0) t172_def_{—}1)) (not t173_def_{—}1)) (not t176_def_{—}1)))
(assert (implies (and (and (and (>=t171_val_{—}1 0.0) t171_def_{—}1)(and (<t172_val_{—}1 0.0) t172_def_{—}1)) t174_def_{—}1) (and t176_def_{—}1 (=t176_val_{—}1 (*t172_val_{—}1 t174_val_{—}1)))))
(assert (implies (and (and (and (>=t171_val_{—}1 0.0) t171_def_{—}1)(and (<t172_val_{—}1 0.0) t172_def_{—}1)) (not t174_def_{—}1)) (not t176_def_{—}1)))
(assert (implies (and (and (>=t171_val_{—}1 0.0) t171_def_{—}1) (not t172_def_{—}1))(not t176_def_{—}1)))
(assert (implies (and (and (<t171_val_{—}1 0.0) t171_def_{—}1) t175_def_{—}1)(and t176_def_{—}1 (=t176_val_{—}1 t175_val_{—}1))))
(assert (implies (and (and (<t171_val_{—}1 0.0) t171_def_{—}1) (not t175_def_{—}1))(not t176_def_{—}1)))
(assert (implies (not t171_def_{—}1) (not t176_def_{—}1)))
(assert (implies (and (and t171_def_{—}2 (>=t171_val_{—}2 0.0)) (not t172_def_{—}2))(not t176_def_{—}2)))
(assert (implies (and (and (and (>=t171_val_{—}2 0.0) t171_def_{—}2)(and (>=t172_val_{—}2 0.0) t172_def_{—}2)) t173_def_{—}2) (and t176_def_{—}2 (=t176_val_{—}2 (*t172_val_{—}2 t173_val_{—}2)))))
(assert (implies (and (and (and (>=t171_val_{—}2 0.0) t171_def_{—}2)(and (>=t172_val_{—}2 0.0) t172_def_{—}2)) (not t173_def_{—}2)) (not t176_def_{—}2)))
(assert (implies (and (and (and (>=t171_val_{—}2 0.0) t171_def_{—}2)(and (<t172_val_{—}2 0.0) t172_def_{—}2)) t174_def_{—}2) (and t176_def_{—}2 (=t176_val_{—}2 (*t172_val_{—}2 t174_val_{—}2)))))
(assert (implies (and (and (and (>=t171_val_{—}2 0.0) t171_def_{—}2)(and (<t172_val_{—}2 0.0) t172_def_{—}2)) (not t174_def_{—}2)) (not t176_def_{—}2)))
(assert (implies (and (and (>=t171_val_{—}2 0.0) t171_def_{—}2) (not t172_def_{—}2))(not t176_def_{—}2)))
(assert (implies (and (and (<t171_val_{—}2 0.0) t171_def_{—}2) t175_def_{—}2)(and t176_def_{—}2 (=t176_val_{—}2 t175_val_{—}2))))
(assert (implies (and (and (<t171_val_{—}2 0.0) t171_def_{—}2) (not t175_def_{—}2))(not t176_def_{—}2)))
(assert (implies (not t171_def_{—}2) (not t176_def_{—}2)))
(assert (implies (and (and t171_def_{—}3 (>=t171_val_{—}3 0.0)) (not t172_def_{—}3))(not t176_def_{—}3)))
(assert (implies (and (and (and (>=t171_val_{—}3 0.0) t171_def_{—}3)(and (>=t172_val_{—}3 0.0) t172_def_{—}3)) t173_def_{—}3) (and t176_def_{—}3 (=t176_val_{—}3 (*t172_val_{—}3 t173_val_{—}3)))))
(assert (implies (and (and (and (>=t171_val_{—}3 0.0) t171_def_{—}3)(and (>=t172_val_{—}3 0.0) t172_def_{—}3)) (not t173_def_{—}3)) (not t176_def_{—}3)))
(assert (implies (and (and (and (>=t171_val_{—}3 0.0) t171_def_{—}3)(and (<t172_val_{—}3 0.0) t172_def_{—}3)) t174_def_{—}3) (and t176_def_{—}3 (=t176_val_{—}3 (*t172_val_{—}3 t174_val_{—}3)))))
(assert (implies (and (and (and (>=t171_val_{—}3 0.0) t171_def_{—}3)(and (<t172_val_{—}3 0.0) t172_def_{—}3)) (not t174_def_{—}3)) (not t176_def_{—}3)))
(assert (implies (and (and (>=t171_val_{—}3 0.0) t171_def_{—}3) (not t172_def_{—}3))(not t176_def_{—}3)))
(assert (implies (and (and (<t171_val_{—}3 0.0) t171_def_{—}3) t175_def_{—}3)(and t176_def_{—}3 (=t176_val_{—}3 t175_val_{—}3))))
(assert (implies (and (and (<t171_val_{—}3 0.0) t171_def_{—}3) (not t175_def_{—}3))(not t176_def_{—}3)))
(assert (implies (not t171_def_{—}3) (not t176_def_{—}3)))
(assert (implies (and (and t171_def_{—}4 (>=t171_val_{—}4 0.0)) (not t172_def_{—}4))(not t176_def_{—}4)))
(assert (implies (and (and (and (>=t171_val_{—}4 0.0) t171_def_{—}4)(and (>=t172_val_{—}4 0.0) t172_def_{—}4)) t173_def_{—}4) (and t176_def_{—}4 (=t176_val_{—}4 (*t172_val_{—}4 t173_val_{—}4)))))
(assert (implies (and (and (and (>=t171_val_{—}4 0.0) t171_def_{—}4)(and (>=t172_val_{—}4 0.0) t172_def_{—}4)) (not t173_def_{—}4)) (not t176_def_{—}4)))
(assert (implies (and (and (and (>=t171_val_{—}4 0.0) t171_def_{—}4)(and (<t172_val_{—}4 0.0) t172_def_{—}4)) t174_def_{—}4) (and t176_def_{—}4 (=t176_val_{—}4 (*t172_val_{—}4 t174_val_{—}4)))))
(assert (implies (and (and (and (>=t171_val_{—}4 0.0) t171_def_{—}4)(and (<t172_val_{—}4 0.0) t172_def_{—}4)) (not t174_def_{—}4)) (not t176_def_{—}4)))
(assert (implies (and (and (>=t171_val_{—}4 0.0) t171_def_{—}4) (not t172_def_{—}4))(not t176_def_{—}4)))
(assert (implies (and (and (<t171_val_{—}4 0.0) t171_def_{—}4) t175_def_{—}4)(and t176_def_{—}4 (=t176_val_{—}4 t175_val_{—}4))))
(assert (implies (and (and (<t171_val_{—}4 0.0) t171_def_{—}4) (not t175_def_{—}4))(not t176_def_{—}4)))
(assert (implies (not t171_def_{—}4) (not t176_def_{—}4)))
(assert (implies (and (and t171_def_{—}5 (>=t171_val_{—}5 0.0)) (not t172_def_{—}5))(not t176_def_{—}5)))
(assert (implies (and (and (and (>=t171_val_{—}5 0.0) t171_def_{—}5)(and (>=t172_val_{—}5 0.0) t172_def_{—}5)) t173_def_{—}5) (and t176_def_{—}5 (=t176_val_{—}5 (*t172_val_{—}5 t173_val_{—}5)))))
(assert (implies (and (and (and (>=t171_val_{—}5 0.0) t171_def_{—}5)(and (>=t172_val_{—}5 0.0) t172_def_{—}5)) (not t173_def_{—}5)) (not t176_def_{—}5)))
(assert (implies (and (and (and (>=t171_val_{—}5 0.0) t171_def_{—}5)(and (<t172_val_{—}5 0.0) t172_def_{—}5)) t174_def_{—}5) (and t176_def_{—}5 (=t176_val_{—}5 (*t172_val_{—}5 t174_val_{—}5)))))
(assert (implies (and (and (and (>=t171_val_{—}5 0.0) t171_def_{—}5)(and (<t172_val_{—}5 0.0) t172_def_{—}5)) (not t174_def_{—}5)) (not t176_def_{—}5)))
(assert (implies (and (and (>=t171_val_{—}5 0.0) t171_def_{—}5) (not t172_def_{—}5))(not t176_def_{—}5)))
(assert (implies (and (and (<t171_val_{—}5 0.0) t171_def_{—}5) t175_def_{—}5)(and t176_def_{—}5 (=t176_val_{—}5 t175_val_{—}5))))
(assert (implies (and (and (<t171_val_{—}5 0.0) t171_def_{—}5) (not t175_def_{—}5))(not t176_def_{—}5)))
(assert (implies (not t171_def_{—}5) (not t176_def_{—}5)))
(declare-fun t177_def_{—}1( ) Bool)
(declare-fun t177_val_{—}1( ) Real)
(assert t177_def_{—}1)
(assert (=t177_val_{—}1 0.0))
(declare-fun t177_def_{—}2( ) Bool)
(declare-fun t177_val_{—}2( ) Real)
(assert t177_def_{—}2)
(assert (=t177_val_{—}2 0.0))
(declare-fun t177_def_{—}3( ) Bool)
(declare-fun t177_val_{—}3( ) Real)
(assert t177_def_{—}3)
(assert (=t177_val_{—}3 0.0))
(declare-fun t177_def_{—}4( ) Bool)
(declare-fun t177_val_{—}4( ) Real)
(assert t177_def_{—}4)
(assert (=t177_val_{—}4 0.0))
(declare-fun t177_def_{—}5( ) Bool)
(declare-fun t177_val_{—}5( ) Real)
(assert t177_def_{—}5)
(assert (=t177_val_{—}5 0.0))
(declare-fun t178_def_{—}1( ) Bool)
(declare-fun t178_val_{—}1( ) Real)
(assert (implies (not t177_def_{—}1) (not t178_def_{—}1)))
(assert (implies (not t169_def_{—}1) (not t178_def_{—}1)))
(assert (implies (and t177_def_{—}1 t169_def_{—}1) t178_def_{—}1))
(assert (implies (and t178_def_{—}1 (<t177_val_{—}1 t169_val_{—}1)) (=t178_val_{—}1 1.0)))
(assert (implies (and t178_def_{—}1 (>=t177_val_{—}1 t169_val_{—}1)) (=t178_val_{—}1 (−1.0))))
(declare-fun t178_def_{—}2( ) Bool)
(declare-fun t178_val_{—}2( ) Real)
(assert (implies (not t177_def_{—}2) (not t178_def_{—}2)))
(assert (implies (not t169_def_{—}2) (not t178_def_{—}2)))
(assert (implies (and t177_def_{—}2 t169_def_{—}2) t178_def_{—}2))
(assert (implies (and t178_def_{—}2 (<t177_val_{—}2 t169_val_{—}2)) (=t178_val_{—}2 1.0)))
(assert (implies (and t178_def_{—}2 (>=t177_val_{—}2 t169_val_{—}2)) (=t178_val_{—}2 (−1.0))))
(declare-fun t178_def_{—}3( ) Bool)
(declare-fun t178_val_{—}3( ) Real)
(assert (implies (not t177_def_{—}3) (not t178_def_{—}3)))
(assert (implies (not t169_def_{—}3) (not t178_def_{—}3)))
(assert (implies (and t177_def_{—}3 t169_def_{—}3) t178_def_{—}3))
(assert (implies (and t178_def_{—}3 (<t177_val_{—}3 t169_val_{—}3)) (=t178_val_{—}3 1.0)))
(assert (implies (and t178_def_{—}3 (>=t177_val_{—}3 t169_val_{—}3)) (=t178_val_{—}3 (−1.0))))
(declare-fun t178_def_{—}4( ) Bool)
(declare-fun t178_val_{—}4( ) Real)
(assert (implies (not t177_def_{—}4) (not t178_def_{—}4)))
(assert (implies (not t169_def_{—}4) (not t178_def_{—}4)))
(assert (implies (and t177_def_{—}4 t169_def_{—}4) t178_def_{—}4))
(assert (implies (and t178_def_{—}4 (<t177_val_{—}4 t169_val_{—}4)) (=t178_val_{—}4 1.0)))
(assert (implies (and t178_def_{—}4 (>=t177_val_{—}4 t169_val_{—}4)) (=t178_val_{—}4 (−1.0))))
(declare-fun t178_def_{—}5( ) Bool)
(declare-fun t178_val_{—}5( ) Real)
(assert (implies (not t177_def_{—}5) (not t178_def_{—}5)))
(assert (implies (not t169_def_{—}5) (not t178_def_{—}5)))
(assert (implies (and t177_def_{—}5 t169_def_{—}5) t178_def_{—}5))
(assert (implies (and t178_def_{—}5 (<t177_val_{—}5 t169_val_{—}5)) (=t178_val_{—}5 1.0)))
(assert (implies (and t178_def_{—}5 (>=t177_val_{—}5 t169_val_{—}5)) (=t178_val_{—}5 (−1.0))))
(declare-fun t179_def_{—}1( ) Bool)
(declare-fun t179_val_{—}1( ) Real)
(assert t179_def_{—}1)
(assert (=t179_val_{—}1 2.0))
(declare-fun t179_def_{—}2( ) Bool)
(declare-fun t179_val_{—}2( ) Real)
(assert t179_def_{—}2)
(assert (=t179_val_{—}2 2.0))
(declare-fun t179_def_{—}3( ) Bool)
(declare-fun t179_val_{—}3( ) Real)
(assert t179_def_{—}3)
(assert (=t179_val_{—}3 2.0))
(declare-fun t179_def_{—}4( ) Bool)
(declare-fun t179_val_{—}4( ) Real)
(assert t179_def_{—}4)
(assert (=t179_val_{—}4 2.0))
(declare-fun t179_def_{—}5( ) Bool)
(declare-fun t179_val_{—}5( ) Real)
(assert t179_def_{—}5)
(assert (=t179_val_{—}5 2.0))
(declare-fun t180_def_{—}1( ) Bool)
(declare-fun t180_val_{—}1( ) Real)
(assert t180_def_{—}1)
(assert (=t180_val_{—}1 1.0))
(declare-fun t180_def_{—}2( ) Bool)
(declare-fun t180_val_{—}2( ) Real)
(assert t180_def_{—}2)
(assert (=t180_val_{—}2 1.0))
(declare-fun t180_def_{—}3( ) Bool)
(declare-fun t180_val_{—}3( ) Real)
(assert t180_def_{—}3)
(assert (=t180_val_{—}3 1.0))
(declare-fun t180_def_{—}4( ) Bool)
(declare-fun t180_val_{—}4( ) Real)
(assert t180_def_{—}4)
(assert (=t180_val_{—}4 1.0))
(declare-fun t180_def_{—}5( ) Bool)
(declare-fun t180_val_{—}5( ) Real)
(assert t180_def_{—}5)
(assert (=t180_val_{—}5 1.0))
(declare-fun t181_def_{—}1( ) Bool)
(declare-fun t181_val_{—}1( ) Real)
(assert t181_def_{—}1)
(assert (=t181_val_{—}1 1.0))
(declare-fun t181_def_{—}2( ) Bool)
(declare-fun t181_val_{—}2( ) Real)
(assert t181_def_{—}2)
(assert (=t181_val_{—}2 1.0))
(declare-fun t181_def_{—}3( ) Bool)
(declare-fun t181_val_{—}3( ) Real)
(assert t181_def_{—}3)
(assert (=t181_val_{—}3 1.0))
(declare-fun t181_def_{—}4( ) Bool)
(declare-fun t181_val_{—}4( ) Real)
(assert t181_def_{—}4)
(assert (=t181_val_{—}4 1.0))
(declare-fun t181_def_{—}5( ) Bool)
(declare-fun t181_val_{—}5( ) Real)
(assert t181_def_{—}5)
(assert (=t181_val_{—}5 1.0))
(declare-fun t182_def_{—}1( ) Bool)
(declare-fun t182_val_{—}1( ) Real)
(assert (not t182_def_{—}1))
(declare-fun t182_def_{—}2( ) Bool)
(declare-fun t182_val_{—}2( ) Real)
(assert (not t182_def_{—}2))
(declare-fun t182_def_{—}3( ) Bool)
(declare-fun t182_val_{—}3( ) Real)
(assert (not t182_def_{—}3))
(declare-fun t182_def_{—}4( ) Bool)
(declare-fun t182_val_{—}4( ) Real)
(assert (not t182_def_{—}4))
(declare-fun t182_def_{—}5( ) Bool)
(declare-fun t182_val_{—}5( ) Real)
(assert (not t182_def_{—}5))
(declare-fun t183_def_{—}1( ) Bool)
(declare-fun t183_val_{—}1( ) Real)
(declare-fun var15_{—}1( ) Real)
(assert (=var15_{—}1 t183_val_{—}1))
(declare-fun t183_def_{—}2( ) Bool)
(declare-fun t183_val_{—}2( ) Real)
(declare-fun var15_{—}2( ) Real)
(assert (=var15_{—}2 t183_val_{—}2))
(declare-fun t183_def_{—}3( ) Bool)
(declare-fun t183_val_{—}3( ) Real)
(declare-fun var15_{—}3( ) Real)
(assert (=var15_{—}3 t183_val_{—}3))
(declare-fun t183_def_{—}4( ) Bool)
(declare-fun t183_val_{—}4( ) Real)
(declare-fun var15_{—}4( ) Real)
(assert (=var15_{—}4 t183_val_{—}4))
(declare-fun t183_def_{—}5( ) Bool)
(declare-fun t183_val_{—}5( ) Real)
(declare-fun var15_{—}5( ) Real)
(assert (=var15_{—}5 t183_val_{—}5))
(assert (implies (and (and t178_def_{—}1 (>=t178_val_{—}1 0.0)) (not t179_def_{—}1))(not t183_def_{—}1)))
(assert (implies (and (and (and (>=t178_val_{—}1 0.0) t178_def_{—}1)(and (>=t179_val_{—}1 0.0) t179_def_{—}1)) t180_def_{—}1) (and t183_def_{—}1 (=t183_val_{—}1 (*t179_val_{—}1 t180_val_{—}1)))))
(assert (implies (and (and (and (>=t178_val_{—}1 0.0) t178_def_{—}1)(and (>=t179_val_{—}1 0.0) t179_def_{—}1)) (not t180_def_{—}1)) (not t183_def_{—}1)))
(assert (implies (and (and (and (>=t178_val_{—}1 0.0) t178_def_{—}1)(and (<t179_val_{—}1 0.0) t179_def_{—}1)) t181_def_{—}1) (and t183_def_{—}1 (=t183_val_{—}1 (*t179_val_{—}1 t181_val_{—}1)))))
(assert (implies (and (and (and (>=t178_val_{—}1 0.0) t178_def_{—}1)(and (<t179_val_{—}1 0.0) t179_def_{—}1)) (not t181_def_{—}1)) (not t183_def_{—}1)))
(assert (implies (and (and (>=t178_val_{—}1 0.0) t178_def_{—}1) (not t179_def_{—}1))(not t183_def_{—}1)))
(assert (implies (and (and (<t178_val_{—}1 0.0) t178_def_{—}1) t182_def_{—}1)(and t183_def_{—}1 (=t183_val_{—}1 t182_val_{—}1))))
(assert (implies (and (and (<t178_val_{—}1 0.0) t178_def_{—}1) (not t182_def_{—}1))(not t183_def_{—}1)))
(assert (implies (not t178_def_{—}1) (not t183_def_{—}1)))
(assert (implies (and (and t178_def_{—}2 (>=t178_val_{—}2 0.0)) (not t179_def_{—}2))(not t183_def_{—}2)))
(assert (implies (and (and (and (>=t178_val_{—}2 0.0) t178_def_{—}2)(and (>=t179_val_{—}2 0.0) t179_def_{—}2)) t180_def_{—}2) (and t183_def_{—}2 (=t183_val_{—}2 (*t179_val_{—}2 t180_val_{—}2)))))
(assert (implies (and (and (and (>=t178_val_{—}2 0.0) t178_def_{—}2)(and (>=t179_val_{—}2 0.0) t179_def_{—}2)) (not t180_def_{—}2)) (not t183_def_{—}2)))
(assert (implies (and (and (and (>=t178_val_{—}2 0.0) t178_def_{—}2)(and (<t179_val_{—}2 0.0) t179_def_{—}2)) t181_def_{—}2) (and t183_def_{—}2 (=t183_val_{—}2 (*t179_val_{—}2 t181_val_{—}2)))))
(assert (implies (and (and (and (>=t178_val_{—}2 0.0) t178_def_{—}2)(and (<t179_val_{—}2 0.0) t179_def_{—}2)) (not t181_def_{—}2)) (not t183_def_{—}2)))
(assert (implies (and (and (>=t178_val_{—}2 0.0) t178_def_{—}2) (not t179_def_{—}2))(not t183_def_{—}2)))
(assert (implies (and (and (<t178_val_{—}2 0.0) t178_def_{—}2) t182_def_{—}2)(and t183_def_{—}2 (=t183_val_{—}2 t182_val_{—}2))))
(assert (implies (and (and (<t178_val_{—}2 0.0) t178_def_{—}2) (not t182_def_{—}2))(not t183_def_{—}2)))
(assert (implies (not t178_def_{—}2) (not t183_def_{—}2)))
(assert (implies (and (and t178_def_{—}3 (>=t178_val_{—}3 0.0)) (not t179_def_{—}3))(not t183_def_{—}3)))
(assert (implies (and (and (and (>=t178_val_{—}3 0.0) t178_def_{—}3)(and (>=t179_val_{—}3 0.0) t179_def_{—}3)) t180_def_{—}3) (and t183_def_{—}3 (=t183_val_{—}3 (*t179_val_{—}3 t180_val_{—}3)))))
(assert (implies (and (and (and (>=t178_val_{—}3 0.0) t178_def_{—}3)(and (>=t179_val_{—}3 0.0) t179_def_{—}3)) (not t180_def_{—}3)) (not t183_def_{—}3)))
(assert (implies (and (and (and (>=t178_val_{—}3 0.0) t178_def_{—}3)(and (<t179_val_{—}3 0.0) t179_def_{—}3)) t181_def_{—}3) (and t183_def_{—}3 (=t183_val_{—}3 (*t179_val_{—}3 t181_val_{—}3)))))
(assert (implies (and (and (and (>=t178_val_{—}3 0.0) t178_def_{—}3)(and (<t179_val_{—}3 0.0) t179_def_{—}3)) (not t181_def_{—}3)) (not t183_def_{—}3)))
(assert (implies (and (and (>=t178_val_{—}3 0.0) t178_def_{—}3) (not t179_def_{—}3))(not t183_def_{—}3)))
(assert (implies (and (and (<t178_val_{—}3 0.0) t178_def_{—}3) t182_def_{—}3)(and t183_def_{—}3 (=t183_val_{—}3 t182_val_{—}3))))
(assert (implies (and (and (<t178_val_{—}3 0.0) t178_def_{—}3) (not t182_def_{—}3))(not t183_def_{—}3)))
(assert (implies (not t178_def_{—}3) (not t183_def_{—}3)))
(assert (implies (and (and t178_def_{—}4 (>=t178_val_{—}4 0.0)) (not t179_def_{—}4))(not t183_def_{—}4)))
(assert (implies (and (and (and (>=t178_val_{—}4 0.0) t178_def_{—}4)(and (>=t179_val_{—}4 0.0) t179_def_{—}4)) t180_def_{—}4) (and t183_def_{—}4 (=t183_val_{—}4 (*t179_val_{—}4 t180_val_{—}4)))))
(assert (implies (and (and (and (>=t178_val_{—}4 0.0) t178_def_{—}4)(and (>=t179_val_{—}4 0.0) t179_def_{—}4)) (not t180_def_{—}4)) (not t183_def_{—}4)))
(assert (implies (and (and (and (>=t178_val_{—}4 0.0) t178_def_{—}4)(and (<t179_val_{—}4 0.0) t179_def_{—}4)) t181_def_{—}4) (and t183_def_{—}4 (=t183_val_{—}4 (*t179_val_{—}4 t181_val_{—}4)))))
(assert (implies (and (and (and (>=t178_val_{—}4 0.0) t178_def_{—}4)(and (<t179_val_{—}4 0.0) t179_def_{—}4)) (not t181_def_{—}4)) (not t183_def_{—}4)))
(assert (implies (and (and (>=t178_val_{—}4 0.0) t178_def_{—}4) (not t179_def_{—}4))(not t183_def_{—}4)))
(assert (implies (and (and (<t178_val_{—}4 0.0) t178_def_{—}4) t182_def_{—}4)(and t183_def_{—}4 (=t183_val_{—}4 t182_val_{—}4))))
(assert (implies (and (and (<t178_val_{—}4 0.0) t178_def_{—}4) (not t182_def_{—}4))(not t183_def_{—}4)))
(assert (implies (not t178_def_{—}4) (not t183_def_{—}4)))
(assert (implies (and (and t178_def_{—}5 (>=t178_val_{—}5 0.0)) (not t179_def_{—}5))(not t183_def_{—}5)))
(assert (implies (and (and (and (>=t178_val_{—}5 0.0) t178_def_{—}5)(and (>=t179_val_{—}5 0.0) t179_def_{—}5)) t180_def_{—}5) (and t183_def_{—}5 (=t183_val_{—}5 (*t179_val_{—}5 t180_val_{—}5)))))
(assert (implies (and (and (and (>=t178_val_{—}5 0.0) t178_def_{—}5)(and (>=t179_val_{—}5 0.0) t179_def_{—}5)) (not t180_def_{—}5)) (not t183_def_{—}5)))
(assert (implies (and (and (and (>=t178_val_{—}5 0.0) t178_def_{—}5)(and (<t179_val_{—}5 0.0) t179_def_{—}5)) t181_def_{—}5) (and t183_def_{—}5 (=t183_val_{—}5 (*t179_val_{—}5 t181_val_{—}5)))))
(assert (implies (and (and (and (>=t178_val_{—}5 0.0) t178_def_{—}5)(and (<t179_val_{—}5 0.0) t179_def_{—}5)) (not t181_def_{—}5)) (not t183_def_{—}5)))
(assert (implies (and (and (>=t178_val_{—}5 0.0) t178_def_{—}5) (not t179_def_{—}5))(not t183_def_{—}5)))
(assert (implies (and (and (<t178_val_{—}5 0.0) t178_def_{—}5) t182_def_{—}5)(and t183_def_{—}5 (=t183_val_{—}5 t182_val_{—}5))))
(assert (implies (and (and (<t178_val_{—}5 0.0) t178_def_{—}5) (not t182_def_{—}5))(not t183_def_{—}5)))
(assert (implies (not t178_def_{—}5) (not t183_def_{—}5)))

The problem whether var1 subsumes var2 is encoded into SMT-LIB as:
(assert (or (and t183_def_{—}5 (not t176_def_{—}5)) (and (and t183_def_{—}5 t176_def_{—}5) (not (=t183_val_{—}5 t176_val 5)))))

Further details of the inventive method are described in following part of the specification.

1. A method of reviewing a set of rules used for automated monitoring of a technical system for the presence of a problem, comprising the steps of:
receiving by an encoder a certain problem in view of which the set of rules is to be reviewed;
translating by the encoder the rules to be reviewed to a knowledge base of formal logical statements and generating by the encoder first encoded signals;
translating by the encoder the problem to a formal logical problem statement and generating by the encoder second encoded signals;
receiving the first encoded signals and the second encoded signals by a computer that is configured to check, and to generate an output variable that indicates, whether the knowledge base of logical statements together with the logical problem statement is satisfiable;
labeling, based on the output variable, the problem as not being present if the knowledge base of logical statements together with the logical problem statement is satisfiable; and
sending an output to an output device to indicate whether the knowledge base of logical statements together with the logical problem statement is satisfiable.

2. The method as claimed in claim 1, wherein the problem represents existence of an inconsistency between two or more rules in the set of rules.

3. The method as claimed in claim 1, wherein the problem represents existence of at least two equivalent rules in the set of rules.

4. The method as claimed in claim 1, the problem represents existence of at least one specific rule which solves a purpose that is already solved by a more general rule.

5. The method as claimed in claim 1, wherein the method is implemented with a description logic.

6. The method as claimed in claim 5, wherein ALC(D) is used as the description logic.

7. The method as claimed in claim 1, wherein the formal logical statements of the knowledge base and the formal logical problem statement are in a Satisfiability Modulo Theory format.

8. The method as claimed in claim 7, wherein an extension Boolean logic with concrete domains is used as formal logic.

9. A debugging method comprising applying the method as claimed in claim 1 to debug the set of rules.

10. A device for reviewing a set of rules used for automated monitoring of a technical system for the presence of a problem, comprising:
an input section for inputting the set of rules to be reviewed and a certain problem in view of which the set of rules is to be reviewed, the input section being configured to generate input signals representing the set of rules to be reviewed and the certain problem;
an encoder connected to the input section, configured to receive the input signals and generate, from the input signals, encoded signals which represent a translation of the rules to be reviewed to a knowledge base of formal logical statements and a translation of the problem to a formal logical problem statement;
a computing device connected to the encoder to receive the encoded signals, and configured to run an algorithm to check whether the knowledge base of logical statements together with the logical problem statement is satisfiable and configured to generate an output variable, the value of which indicates whether or not the knowledge base of logical statements together with the logical problem statement is satisfiable;
a signal generator connected to the computing device to receive the output variable, and configured to generate, based on the value of the output variable, an output signal describing the problem as not being present if the value of the output variable indicates that the knowledge base of logical statements together with the logical problem statement is satisfiable; and
an output section connected to the signal generator, and configured to output the output signal to an output device.
